(19) United States
(12) Patent Application Publication
(10) Pub. No.: US 2024/0181980 A1
(43) Pub. Date: Jun. 6, 2024

(54) SYSTEM AND METHOD FOR USE OF A SENSOR MATRIX IN A VEHICLE INTERIOR

(71) Applicant: Shanghai Yanfeng Jinqiao Automotive Trim Systems Co. Ltd., Novi, MI (US)

(72) Inventors: Christopher Kring, Zeeland, MI (US); Frances A. Elenbaas, Grand Rapids, MI (US); Michael John Thomas, Ann Arbor, MI (US); Ching Fong, Ann Arbor, MI (US)

(21) Appl. No.: 18/438,592

(22) Filed: Feb. 12, 2024

Related U.S. Application Data
(63) Continuation-in-part of application No. PCT/US22/74851, filed on Aug. 11, 2022.
(60) Provisional application No. 63/232,489, filed on Aug. 12, 2021.

(51) Int. Cl. B60R 16/023

(52) U.S. Cl. CPC B60R 16/0231

(57) ABSTRACT

A system/method using a sensor arrangement in a vehicle interior with an occupant and vehicle systems may comprise a user interface and computing system to process input/signal and data from data sources to facilitate operation and to provide output/signal with connectivity with occupants, vehicle systems, networks, etc. relating to operation, events, conditions, etc. Output may comprise information/interaction at a user interface, to vehicle systems, network communications, etc. The system may use data to provide output comprising enhancement and/or augmentation of input; output may comprise a signal based on data analytics/processing including application of artificial intelligence models and/or augmented reality models. The system may comprise a distributed sensor matrix to obtain data/input from a sensor field within the vehicle; data sources may comprise the sensor matrix, vehicle systems, data storage and/or networks. The sensor/matrix may be for use with an interior component in personal vehicles, commercial/industrial vehicles, autonomous vehicles, etc.

### CROSS-REFERENCE TO RELATED APPLICATIONS

The present application is a continuation in part of PCT/International Patent Application No. PCT/US2022/74851 titled “SYSTEM AND METHOD FOR USE OF A SENSOR MATRIX IN A VEHICLE INTERIOR” filed Aug. 11, 2022, which claims the benefit of U.S. Provisional Patent Application No. 63/232,489 titled “SYSTEM AND METHOD FOR USE OF A SENSOR MATRIX IN A VEHICLE INTERIOR (WITH USE CASES)” filed Aug. 12, 2021.

The present application claims priority to and incorporates by reference in full the following patent applications: (a) U.S. Provisional Patent Application No. 63/232,489 titled “SYSTEM AND METHOD FOR USE OF A SENSOR MATRIX IN A VEHICLE INTERIOR (WITH USE CASES)” filed Aug. 12, 2021; (b) PCT/International Patent Application No. PCT/US2022/74851 titled “SYSTEM AND METHOD FOR USE OF A SENSOR MATRIX IN A VEHICLE INTERIOR” filed Aug. 11, 2022.

### FIELD

The present invention relates to a system and method for use of a sensor matrix in a vehicle interior with use cases for application.

The present invention relates to a system and method for use of a sensor matrix in a vehicle interior in which data is used to provide an output signal comprising an enhancement of the input signal and/or an augmentation of the input signal.

### BACKGROUND

It is known to provide a system and method for use of sensor/detectors in a vehicle interior.

It would be advantageous to provide an improved system and method for use of a sensor matrix in a vehicle interior.

It would be advantageous to provide an improved system and method for use of a sensor matrix in a vehicle interior with interaction with at least one vehicle occupant.

It would be advantageous to provide an improved system and method for use of a sensor matrix in a vehicle interior to create a “smart cabin” environment with interactive connectivity to vehicle systems and/or networks for a vehicle occupant.

It would be advantageous to provide an improved system and method for use of a sensor matrix in a vehicle interior to provide for interactive connectivity to vehicle systems and/or networks in a wide variety of situations and/or use cases.

It would be advantageous to provide an improved system and method for use of a sensor matrix in a vehicle interior to provide for interactive connectivity to vehicle systems and/or networks in a wide variety of situations and/or use cases to provide for needs of vehicle owners and/or occupants and/or passengers/riders.

It would be advantageous to provide an improved system and method for use of a sensor matrix in a vehicle interior to provide for interactive connectivity to vehicle systems and/or networks in a wide variety of situations and/or use cases for vehicles such as personal vehicles or commercial vehicles or autonomous vehicles.

It would be advantageous to provide an improved system and method for use of a sensor matrix in a vehicle interior to provide for interactive connectivity to vehicle systems and/or networks in a wide variety of situations and/or use cases for vehicles such as personal vehicles or commercial vehicles or autonomous vehicles using data to provide an output signal comprising an enhancement of the input signal and/or an augmentation of the input signal.

It would be advantageous to provide an improved system and method for use of a sensor matrix in a vehicle interior to use data to provide an output signal comprising an enhancement of the input signal and/or an augmentation of the input signal in which the output signal may comprise a signal based on application of artificial intelligence and/or the output signal may comprise a signal based on application of augmented reality.

It would be advantageous to provide an improved system and method for use of a distributed sensor matrix configured to obtain data from within the vehicle; at least one data source may comprise the sensor matrix and/or a vehicle system and/or data storage and/or a network.

### SUMMARY

The present invention relates to a system for an interior of a vehicle comprising a vehicle system configured to use data from at least one data source and to provide a user interface configured for interaction with an occupant comprising a sensor arrangement comprising at least one sensor configured to obtain an input signal; and a computing system configured to process the input signal from the sensor to facilitate an operation and to provide an output signal. The output signal may be sent to at least one of (a) the vehicle system and/or (b) the user interface. The computing system may be configured to use data to provide an output signal comprising an enhancement of the input signal and/or an augmentation of the input signal. The output signal may comprise a signal based on application of artificial intelligence. The output signal may comprise a signal based on application of augmented reality. The sensor arrangement may comprise a distributed sensor matrix configured to obtain data from within the vehicle; data may comprise the input signal. The at least one data source may comprise the sensor matrix and/or a vehicle system and/or data storage and/or a network. The system may comprise a component configured to present the user interface; the component may comprise a user interface system configured to present the user interface; the user interface system may comprise an input device and/or an output device; the user interface system may comprise an input device and an output device; the user interface system may comprise an input device configured to obtain an input signal and an output device configured to present an output signal. The user interface system may comprise at least one sensor; the user interface system may comprise an input device; the input device may comprise at least one sensor. The user interface system may comprise an output device; the output device may comprise an information display. The sensor arrangement may comprise a set of sensors; the set of sensors may be configured to provide a sensor matrix; the sensor matrix may comprise a sensor field. The sensor matrix may comprise a distributed sensor matrix within the interior of the vehicle. The computing system may comprise a computing device with a processor. The processor may be configured to use data to provide an output signal comprising an enhancement of the input signal. The processor may be configured to operate with a data enhancement module configured with artificial intelligence to use data to provide an output signal comprising an enhancement of the input signal; the output signal may comprise information provided at a display. The processor may be configured to use data to operate with a data augmentation module configured for augmented reality to provide an output signal comprising an augmentation of the input signal; augmentation may comprise at least one of augmented audio and/or augmented video. The data source may comprise at least one of data storage and/or a network; the network may comprise the internet; the data source may comprise a language model for data enhancement comprising machine learning for artificial intelligence. The data source may comprise an augmented reality model for data augmentation; the input device may be configured to obtain data based on reality and the output device may be configured to present data based on augmented reality; the output signal may comprise a signal based on augmented reality. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. The operation may comprise at least one of (a) application of artificial intelligence and/or (b) application of augmented reality; (c) operation of vehicle system; (d) network communication; (e) instruction for vehicle system; (f) operation of vehicle systems; (g) interaction with external systems; (h) data storage; (i) data analytics/analysis; (j) comparison of data to threshold values; (k) monitoring; (l) providing a report based on the input signal; (m) vehicle interior control; (n) smart cabin control; (o) smart cabin activity. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. The at least one sensor may comprise at least one of (a) a transducer; (b) a capacitive sensor; (c) an odor detector; (d) an accelerometer; (c) a microphone; (f) a camera; (g) a light detector; (h) an ultraviolet light detector; (i) a thermal detector; (j) RFID detector; (k) tag detector; (l) a sensor array; (m) a sensor matrix; (n) a multi-function sensor; (o) a composite sensor; (p) an audio-visual sensor; (q) a video recorder; (r) an audio recorder; (s) a thermal sensor; (t) a bio-metric sensor. The sensor/sensor arrangement may comprise a sensor matrix; the sensor matrix may comprise at least one of (a) a field; (b) multiple sensors; (c) multiple fields; (d) a field and at least one sensor; the input signal from the sensor may comprise a signal detected (a) by a sensor and/or (b) from within a field; the field may be provided in the interior of the vehicle. The user interface may comprise at least one of (a) a control for the occupant; (b) a display; (c) an audio system; (d) an audio-visual system; (c) an infotainment system; (f) a haptic interface; the vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system.

The present invention relates to a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal at a processor; and performing an operation relating to the input signal. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. The operation may comprise at least one of (a) application of artificial intelligence and/or (b) application of augmented reality; (c) operation of vehicle system; (d) network communication; (c) instruction for vehicle system; (f) operation of vehicle systems; (g) interaction with external systems; (h) data storage; (i) data analytics/analysis; (j) comparison of data to threshold values; (k) monitoring; (l) providing a report based on the input signal; (m) vehicle interior control; (n) smart cabin control; (o) smart cabin activity. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. The processor may be operated by at least one of (a) a control program; (b) a software program. The at least one data source may comprise the sensor matrix and/or a vehicle system and/or data storage and/or a network.

The present invention relates to a system for an interior of a vehicle comprising a vehicle system configured to use data from at least one data source and to provide a user interface configured for interaction with an occupant comprising a sensor arrangement comprising at least one sensor configured to obtain an input signal; and a computing system configured to process the input signal from the sensor to facilitate an operation and to provide an output signal. The output signal may be sent to at least one of (a) the vehicle system and/or (b) the user interface. The computing system may be configured to use data to provide an output signal comprising an enhancement of the input signal and/or an augmentation of the input signal. The output signal may comprise a signal based on application of artificial intelligence. The output signal may comprise a signal based on application of augmented reality. The sensor arrangement may comprise a distributed sensor matrix configured to obtain data from within the vehicle. Data may comprise the input signal. At least one data source may comprise the sensor matrix and/or a vehicle system and/or data storage and/or a network. The system may comprise a component configured to present the user interface. The component may comprise a user interface system configured to present the user interface. The user interface system may comprise an input device and/or an output device. The user interface system may comprise an input device and an output device. The user interface system may comprise an input device configured to obtain an input signal and an output device configured to present an output signal. The user interface system may comprise at least one sensor; the user interface system may comprise an input device; the input device may comprise at least one sensor. The user interface system may comprise an output device; the output device may comprise an information display. The sensor arrangement may comprise a set of sensors; the set of sensors may be configured to provide a sensor field. The sensor arrangement may comprise a sensor matrix; the sensor matrix may comprise a sensor field. The sensor matrix may comprise a distributed sensor matrix within the interior of the vehicle. The computing system may comprise a computing device with a processor. The processor may be configured to use data to provide an output signal comprising an enhancement of the input signal. The processor may be configured to operate with a data enhancement module configured for machine learning to use data to provide an output signal comprising an enhancement of the input signal. The processor may be configured to operate with a data enhancement module configured with artificial intelligence to use data to provide an output signal comprising an enhancement of the input signal. The processor may be configured to operate with a data enhancement module configured to with generative artificial intelligence to use data to provide an output signal comprising an enhancement of the input signal; the input signal may comprise a prompt and the output signal comprise information generated by the data enhancement module from the prompt. The output signal may comprise information provided at a display. The processor may be configured to use data to provide an output signal comprising an augmentation of the input signal. The processor may be configured to use data to operate with a data augmentation module configured for augmented reality to provide an output signal comprising an augmentation of the input signal. The processor may be configured to use data to operate with a data augmentation module configured for augmented reality to provide an output signal comprising an augmentation of the input signal; augmentation may comprise application of data from a data source. The processor may be configured to use data to operate with a data augmentation module configured for augmented reality to provide an output signal comprising an augmentation of the input signal; augmentation may comprise at least one of augmented audio and/or augmented video. The output signal may comprise information provided at a display. The data source may comprise at least one of data storage and/or a network; the network may comprise the internet. The data source may comprise a language model for data enhancement comprising machine learning for artificial intelligence. The data source may comprise an augmented reality model for data augmentation. The input device may be configured to obtain data based on reality and the output device may be configured to present data based on augmented reality. The output signal may comprise a signal based on augmented reality. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. The operation may comprise at least one of (a) operation of vehicle system; (b) network communication; (c) instruction for vehicle system; (d) operation of vehicle systems; (e) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. The operation may comprise at least one of (a) application of artificial intelligence and/or (b) application of augmented reality. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. The at least one sensor may comprise at least one of (a) a transducer; (b) a capacitive sensor; (c) an odor detector; (d) an accelerometer; (c) a microphone; (f) a camera; (g) a light detector; (h) an ultraviolet light detector; (i) a thermal detector; (j) RFID detector; (k) tag detector. The at least one sensor may comprise at least one of (a) a sensor array; (b) a sensor matrix; (c) a multi-function sensor; (d) a composite sensor; (c) an audio-visual sensor; (f) a video recorder; (g) an audio recorder; (h) a thermal sensor; (i) a bio-metric sensor. The sensor may comprise a sensor matrix; the sensor matrix may comprise at least one of (a) a field; (b) multiple sensors; (c) multiple fields; (d) a field and at least one sensor; the input signal from the sensor may comprise a signal detected (a) by a sensor and/or (b) from within a field; the field may be provided in the interior of the vehicle. The input device may comprise a control for the occupant. The user interface may comprise at least one of (a) a display; (b) an audio system; (c) an audio-visual system; (d) an infotainment system; (c) a haptic interface. The processor may be operated by at least one of (a) a control program; (b) a software program. The vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The operation may comprise operation of the vehicle and the output signal may comprise at least one of (a) an alert signal; (b) an emergency communication; (c) vital signs of the occupant.

The present invention relates to a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. Processing the input signal into an output signal may comprise using data to provide the output signal comprising an enhancement of the input signal and/or an augmentation of the input signal. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. The operation may comprise at least one of (a) operation of vehicle system; (b) network communication; (c) instruction for vehicle system; (d) operation of vehicle systems; (e) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. At least one data source may comprise the sensor matrix and/or a vehicle system and/or data storage and/or a network.

The present invention relates to a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. The operation may comprise at least one of (a) operation of vehicle system; (b) network communication; (c) instruction for vehicle system; (d) operation of vehicle systems; (e) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. The step of processing the input signal into an output signal may comprise use of data to provide the output signal comprising an enhancement of the input signal and/or an augmentation of the input signal. At least one data source may comprise the sensor matrix and/or a vehicle system and/or data storage and/or a network.

The present invention relates to a system for using a sensor configured to obtain an input signal in an interior of a vehicle comprising a vehicle system and providing a user interface configured for interaction with an occupant comprising a processor configured to process an input signal from the sensor to facilitate an operation and to provide an output signal. The output signal may be sent to at least one of (a) the vehicle system and/or (b) the user interface. The input signal may comprise at least one of (a) proximity, (b) action, (c) motion, (d) sound; (e) condition, (f) characteristic, (g) presence/absence of occupant, (h) position of occupant, (i) interaction with occupant, (j) detected input from occupant, (k) directed input from occupant, (l) detected event; (m) detected condition; (n) vehicle interior control/activity, (o) smart cabin control/activity. The operation may comprise at least one of (a) operation of vehicle system, (b) network communication, (c) instruction for vehicle system, (d) operation of vehicle systems, (e) interaction with external systems, (f) data storage, (g) data analytics/analysis, (h) comparison of data to threshold values; (i) monitoring; (j) providing a report based on the input signal; (k) vehicle interior control (l) smart cabin control, (m) smart cabin activity. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system; (j) data transmission, (k) data storage; (l) vehicle location; (m) vehicle status; (n) occupant status; (o) communication over a network; (p) report over a network. The sensor may comprise a sensor array. The sensor may comprise a sensor matrix. The sensor may comprise at least one sensor. The at least one sensor may comprise at least one of (a) a transducer; (b) a capacitive sensor; (c) an odor detector; (d) an accelerometer; (c) a microphone; (f) a camera; (g) a light detector; (h) an ultraviolet light detector; (i) a thermal detector; (j) RFID detector; (k) tag detector. The at least one sensor may comprise at least one of (a) a sensor array; (b) a sensor matrix; (c) a multi-function sensor; (d) a composite sensor; (c) an audio-visual sensor; (f) a video recorder; (g) an audio recorder; (h) a thermal sensor; (i) a bio-metric sensor. The sensor may comprise a sensor matrix. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. The field may be provided in the interior of the vehicle. The sensor matrix may be installed and/or operated with a vehicle interior component. The user interface may comprise an input device and an output device. The input device may comprise a control for the occupant. The input device may comprise a virtual switch; the virtual switch may be configured to be operated by at least one of (a) gesture detection and/or (b) movement by the occupant. The output device may comprise a display. The user interface may be configured to obtain the input signal. The user interface may be configured to present the output signal. The user interface may comprise at least one of (a) a display; (b) an audio system; (c) an audio-visual system; (d) an infotainment system. The user interface may comprise a haptic interface. The vehicle interior component may comprise at least one of (a) a trim panel; (b) an instrument panel; (c) a door panel; (d) a console; (c) a floor console; (f) an overhead console: (g) an overhead system; (h) a seat; (i) a steering wheel; (j) a door pillar. The processor may be operated by a control program. The control program may comprise a software program. The vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The vehicle may comprise an autonomous vehicle. The sensor may comprise a sensor matrix configured to obtain an input signal from within the vehicle interior. The input signal may comprise vital signs of the occupant. The operation may comprise operation of a vehicle system. The output signal may comprise a report. The operation may comprise operation of the vehicle and the output signal may comprise an alert signal. The alert signal may comprise an emergency communication. The operation may comprise taking autonomous control of the vehicle. The operation may comprise parking the vehicle. The emergency communication may comprise vital signs of the occupant. The report may comprise vehicle location. The input signal may comprise detection of an event in the vehicle. The operation may comprise determination of the event and the output signal may comprise a report. The event may comprise a potential medical concern for the occupant. The potential medical concern may be an illness of the occupant. The operation may comprise taking autonomous control of the vehicle. The operation may comprise taking autonomous control of the vehicle. The operation may comprise remediation of the event for the vehicle. Remediation of the event for the vehicle may comprise sanitizing the vehicle. The report may comprise a communication of vehicle location. The input signal may comprise incapacitation of the occupant. The operation may comprise determination of the condition and the output signal may comprise a report relating to the condition. The incapacitation may be of the operator of the vehicle; and the operation may comprise taking control of the vehicle. The report may comprise an emergency communication. The output signal may comprise activating an emergency signal for the vehicle. The report may comprise the location of the vehicle. The input signal may be based on a physical parameter of the occupant. The operation may comprise comparison of the physical parameter of the occupant based on a threshold value for the physical parameter. The input signal may comprise detection relating to a status of an item. The operation may comprise determination of the status of the item and the output signal may comprise a report based on the status of the item. The input signal may comprise the status of the item; the status of the item may comprise either (a) detected or (b) not detected. If the status of the item is not detected the operation may comprise monitoring for the item and the report may comprise an alert that the item is not detected. If the status of the item is detected the report may comprise a communication to a contact point; the contact point may be in communication over a network. The report may comprise an electronic message. The input signal may be based on a tag associated with the item. The tag may comprise an RFID tag. The input signal may comprise detection of an incident and the operation may comprise determination of the incident and the output signal may comprise a report on the incident. The incident may comprise a vehicle collision. The operation may comprise monitoring of the status of the vehicle occupant. The report may comprise a communication with emergency responders. The input signal may comprise data relating to the incident. The operation may comprise analysis of the incident. The report may comprise data relating to the incident. The report may comprise analysis of the incident. The input signal may comprise detection of tampering with the vehicle. The operation may comprise verification of tampering with the vehicle and the output signal may comprise a report relating to tampering with the vehicle. The report may be a communication to law enforcement agency. The input signal may comprise a video recording of the tampering. The report may comprise the video recording of the tampering. The operation may comprise determination of damage to the vehicle. The report may comprise determination of damage to the vehicle. The input signal may comprise detection of attention of an operator of the vehicle. The operation may comprise assessment of attention of the operator and the output signal may comprise a report based on attention of the operator. If the attention of the operator is below a threshold value the report may comprise an alert. The threshold value may comprise an awaken state. The threshold value may comprise a distracted state. The report may comprise a signal at the user interface as an alert to the operator. The operation may comprise haptic feedback for the operator. The output signal may comprise a sound at the user interface. The input signal may comprise detection of a potential hazard. The operation may comprise determination of the potential hazard and the output signal may comprise a report relating to the potential hazard. The operation may comprise determination of status of the occupant; the report may comprise status of the occupant. Determination of the potential hazard may comprise classification of the potential hazard. Determination of the potential hazard may comprise a traffic-related hazard and the report may comprise a warning. The input signal may comprise detection of a vehicle condition. The operation may comprise determination of the vehicle condition and the output signal may comprise a report relating to the vehicle condition. The vehicle condition may be reported to the occupant of the vehicle. The user interface may comprise a gesture-operated interface for the occupant. The vehicle condition may relate to status of a safety system of the vehicle reported to the occupant. The input signal may comprise detection of a vehicle condition. The operation may comprise determination of the vehicle condition and the output signal may comprise a report relating to the vehicle condition. The vehicle condition may comprise autonomous operation of the vehicle. The input signal may comprise detection of readiness of an occupant to operate the vehicle. Readiness may comprise status of the occupant. Status may comprise position of the occupant. The report may comprise an alert to the occupant. The alert may comprise a communication to take control of the vehicle.

The present invention relates to a method for using a sensor matrix in an interior of a vehicle comprising a vehicle system and providing a user interface configured for interaction with an occupant comprising the steps of obtaining an input signal from the sensor matrix, processing the input signal into an output signal, and performing an operation relating to the input signal. The input signal may comprise at least one of (a) proximity, (b) action, (c) motion, (d) sound; (c) condition, (f) characteristic, (g) presence/absence of occupant, (h) position of occupant, (i) interaction with occupant, (j) detected input from occupant, (k) directed input from occupant, (l) detected event; (m) detected condition; (n) vehicle interior control/activity, (o) smart cabin control/activity. The operation may comprise at least one of (a) operation of vehicle system, (b) network communication, (c) instruction for vehicle system, (d) operation of vehicle systems, (c) interaction with external systems, (f) data storage, (g) data analytics/analysis, (h) comparison of data to threshold values; (i) monitoring; (j) providing a report based on the input signal; (k) vehicle interior control (l) smart cabin control, (m) smart cabin activity. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system; (j) data transmission, (k) data storage; (l) vehicle location; (m) vehicle status; (n) occupant status; (o) communication over a network; (p) report over a network. The method may comprise the step of performing an operation based on the output signal. The step of performing an operation relating to the input signal may comprise performing an operation based on the output signal. The step of processing the input signal into an output signal may comprise use of a database. The step of performing an operation may comprise providing a communication. The communication may comprise a report based on the input signal. The output signal may comprise the report. A system comprising the sensor matrix may be provided in the interior of the vehicle. The method may comprise the step of activating a field for the sensor matrix. The method may comprise the step of actuating a field for the sensor matrix. The step of obtaining an input signal may comprise detecting the input signal. The input signal may comprise a signal representative of at least one of (a) motion by the occupant; (b) action by the occupant; (c) a condition in the interior; (d) a condition of the occupant; (c) a characteristic of the occupant. The method may comprise the step of conditioning the input signal. The step of conditioning the input signal may comprise filtering the input signal. Filtering the input signal may comprise at least one of (a) separating noise and/or (b) calibration. The step of processing the input signal may comprise calibration. The step of performing an operation may comprise performing an operation at the vehicle system. The method may comprise the step of providing an output at the user interface based on the output signal. The method may comprise the step of interaction at the user interface. The sensor matrix may comprise a sensor. The sensor matrix may comprise at least one sensor. The at least one sensor may comprise at least one of (a) a transducer; (b) a capacitive sensor; (c) an odor detector; (d) an accelerometer; (e) a microphone; (f) a camera; (g) a light detector; (h) an ultraviolet light detector; (i) a thermal detector; (j) RFID detector; (k) tag detector. The at least one sensor may comprise at least one of (a) a sensor array; (b) a sensor matrix; (c) a multi-function sensor; (d) a composite sensor; (e) an audio-visual sensor; (f) a video recorder; (g) an audio recorder; (h) a thermal sensor; (i) a bio-metric sensor. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. Obtaining the input signal from the sensor matrix may comprise detecting (a) by a sensor and/or (b) from within a field. The method may comprise the step of providing a field in the interior of the vehicle. The step of providing the field may be performed by the sensor matrix. The user interface may comprise at least one of (a) a display; (b) an audio system; (c) an audio-visual system; (d) an infotainment system. The step of processing the input signal may be performed on a processor. The processor may be operated by a control program. The step of processing the input signal may be performed by a control program. The step of processing the input signal may be performed on a controller. The vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The method may comprise the step of communication of an output based on the output signal to a network. The network may comprise a telecommunication network. The network may comprise access through a mobile device. The output may comprise a telecommunication signal. The telecommunication signal may comprise an emergency signal. The output may comprise a network communication. The input signal may comprise incapacitation of the occupant. The operation may comprise determination of the condition and the output signal may comprise a report relating to the condition. The incapacitation may be of the operator of the vehicle and the operation may comprise taking control of the vehicle. The input signal may comprise detection relating to a status of an item. The operation may comprise determination of the status of the item and the output signal may comprise a report based on the status of the item. The input signal may comprise the status of the item; the status of the item may comprise either (a) detected or (b) not detected. If the status of the item is not detected the operation may comprise monitoring for the item and the report may comprise an alert that the item is not detected. The input signal may comprise detection of an incident. The operation may comprise determination of the incident and the output signal may comprise a report on the incident. The incident may comprise a vehicle collision. The input signal may comprise detection of tampering with the vehicle. The operation may comprise verification of tampering with the vehicle and the output signal may comprise a report relating to tampering with the vehicle. The operation may comprise determination of damage to the vehicle. The report may comprise determination of damage to the vehicle. The input signal may comprise detection of attention of an operator of the vehicle. The operation may comprise assessment of attention of the operator and the output signal may comprise a report based on attention of the operator. If the attention of the operator is below a threshold value the report may comprise an alert. The threshold value may comprise an awaken state. The threshold value may comprise a distracted state. The output signal may comprise a sound at the user interface. The input signal may comprise detection of a potential hazard. The operation may comprise determination of the potential hazard and the output signal may comprise a report relating to the potential hazard. The operation may comprise determination of status of the occupant; the report may comprise status of the occupant. The input signal may comprise detection of a vehicle condition. The operation may comprise determination of the vehicle condition and the output signal may comprise a report relating to the vehicle condition.

The present invention relates to a system for using a sensor matrix in an interior of a vehicle comprising a vehicle system and providing a user interface configured for interaction with an occupant comprising (a) the sensor matrix configured to obtain an input signal from within the vehicle interior and (b) a processor configured to process the input signal and to provide an output signal. The output signal may be sent to at least one of (a) the vehicle system and/or (b) the user interface. The input signal may comprise at least one of (a) proximity, (b) action, (c) motion, (d) condition, (e) characteristic, (f) presence/absence of occupant, (g) position, (h) interaction with occupant, (i) detected input from occupant, (j) directed input from occupant, (k) vehicle interior control/activity, (l) smart cabin control/activity. The operation may comprise at least one of (a) operation of vehicle system, (b) network communication, (c) instruction for vehicle system, (d) operation of vehicle systems, (e) interaction with external systems, (f) data storage, (g) data analytics/analysis, (h) smart cabin control. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system; (j) data transmission, (k) data storage. The sensor matrix may comprise at least one sensor. The sensor may comprise at least one of (a) a transducer; (b) a capacitive sensor; (c) an odor detector; (d) an accelerometer; (e) a microphone; (f) a camera; (g) a light detector; (h) an ultraviolet light detector. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. The field may be provided in the interior of the vehicle. The sensor matrix may be installed and/or operated with a vehicle interior component. The vehicle interior component may comprise at least one of (a) a trim panel; (b) an instrument panel; (c) a door panel; (d) a console; (c) a floor console; (f) an overhead console: (g) an overhead system; (h) a seat; (i) a steering wheel. The user interface may comprise at least one of (a) a display; (b) an audio system; (c) an audio-visual system; (d) an infotainment system. The user interface may comprise a haptic interface. The processor may be operated by a control program. The control program may comprise a software program. The vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system; (w) location/navigation system; (x) system for mobile device interactivity/connectivity.

The present invention relates to a method for using a sensor matrix in an interior of a vehicle comprising a vehicle system and providing a user interface configured for interaction with an occupant comprising the steps of obtaining an input signal from the sensor matrix, processing the input signal into an output signal and performing an operation based on the output signal. The input signal may comprise at least one of (a) proximity, (b) action, (c) motion, (d) condition, (e) characteristic, (f) presence/absence of occupant, (g) position, (h) interaction with occupant, (i) detected input from occupant, (j) directed input from occupant, (k) vehicle interior control/activity, (l) smart cabin control/activity. The operation may comprise at least one of (a) operation of vehicle system, (b) network communication, (c) instruction for vehicle system, (d) operation of vehicle systems, (c) interaction with external systems, (f) data storage, (g) data analytics/analysis, (h) smart cabin control. The output signal may comprise at least one of (a) audio-visual signal, (b) visual signal, (c) visual display, (d) audible signal, (e) haptic signal, (f) notice/alert, (g) communication to network, (h) communication to device, (i) communication to vehicle system; (j) data transmission, (k) data storage. A system comprising the sensor matrix may be provided in the interior of the vehicle. The method may comprise the step of actuating a field for the sensor matrix. The step of obtaining an input signal may comprise detecting the input signal. The input signal may comprise a signal representative of at least one of (a) motion by the occupant; (b) action by the occupant; (c) a condition in the interior; (d) a condition of the occupant; (c) a characteristic of the occupant. The method may comprise the step of conditioning the input signal. The step of conditioning the input signal may comprise filtering the input signal; filtering the input signal may comprise at least one of (a) separating noise and/or (b) calibration. The step of processing the input signal may comprise calibration. The step of performing an operation may comprise performing an operation at the vehicle system. The system and method may further comprise the step of providing an output at the user interface based on the output signal. The system and method may further comprise the step of interaction at the user interface. The sensor matrix may comprise at least one sensor. The sensor may comprise at least one of (a) a transducer; (b) a capacitive sensor; (c) an odor detector; (d) an accelerometer; (c) a microphone; (f) a camera; (g) a light detector; (h) an ultraviolet light detector. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. Obtaining the input signal from the sensor matrix may comprise detecting (a) by a sensor and/or (b) from within a field. The method may comprise the step of providing a field in the interior of the vehicle. The step of providing the field may be performed by the sensor matrix. The user interface may comprise at least one of (a) a display; (b) an audio system; (c) an audio-visual system; (d) an infotainment system. The step of processing the input signal may be performed on a processor. The processor may be operated by a control program. The step of processing the input signal may be performed by a control program. The step of processing the input signal may be performed on a controller. The vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The method may comprise the step of communication of an output based on the output signal to a network. The network may comprise a telecommunication network. The network may comprise access through a mobile device. The output may comprise a telecommunication signal. The telecommunication signal may comprise an emergency signal.

The present invention relates to a system for using a sensor matrix in an interior of a vehicle comprising a vehicle system configured for interaction with an occupant and/or device/object comprising (a) the sensor matrix configured to obtain an input signal from within the vehicle interior and (b) a processor configured to process the input signal and to provide an output signal. The output signal may be sent to at least one of (a) the vehicle system and/or (b) the user interface. The system and method may provide for an improved interaction with at least one vehicle occupant and/or with vehicle systems and/or with networks/communications and/or with a user interface/device.

### FIGURES

FIG. 1 is a schematic perspective view of a vehicle according to an exemplary embodiment.

FIGS. 2A through 2D are schematic perspective cut-away views of a vehicle showing a vehicle interior according to an exemplary embodiment.

FIGS. 3A through 3T are schematic perspective cut-away views of a vehicle showing a vehicle interior according to an exemplary embodiment.

FIGS. 4A and 4B are schematic block diagrams of a system for use of a sensor matrix in a vehicle interior according to an exemplary embodiment.

FIGS. 5A and 5B are schematic block diagrams of a system for use of a sensor matrix in a vehicle interior according to an exemplary embodiment.

FIGS. 6A and 6B are schematic block diagrams of a system for use of a sensor matrix in a vehicle interior according to an exemplary embodiment.

FIGS. 7A and 7B are schematic block diagrams of a system for use of a sensor matrix in a vehicle interior according to an exemplary embodiment.

FIGS. 8A and 8B are schematic block diagrams of a system for use of a sensor matrix in a vehicle interior according to an exemplary embodiment.

FIGS. 9A and 9B are schematic block diagrams of a system for use of a sensor matrix in a vehicle interior according to an exemplary embodiment.

FIGS. 10A through 10F are schematic flow diagrams of a method for use of a sensor matrix in a vehicle interior according to an exemplary embodiment.

FIGS. 11A through 11O are schematic flow diagrams of a method for use of a sensor matrix in a vehicle interior according to an exemplary embodiment.

FIG. 12 is a schematic block diagram of vehicle/network systems according to an exemplary embodiment.

FIGS. 13A through 13H are schematic block diagrams of vehicle/network systems according to an exemplary embodiment.

FIG. 14 is a schematic block diagram of vehicle/network systems according to an exemplary embodiment.

FIG. 15A is a schematic perspective cut-away view of a vehicle showing a vehicle interior according to an exemplary embodiment.

FIG. 15B is a schematic perspective cut-away view of a vehicle showing a vehicle interior according to an exemplary embodiment.

FIG. 15C is a schematic perspective cut-away view of a vehicle showing a vehicle interior according to an exemplary embodiment.

FIGS. 15D and 15E are schematic perspective cut-away views of a vehicle showing a vehicle interior according to an exemplary embodiment.

FIGS. 16A through 16H are schematic block diagrams of a system for use of a sensor matrix in a vehicle interior according to an exemplary embodiment.

FIGS. 17A and 17B are schematic block diagrams of a system for use of a sensor matrix in a vehicle interior according to an exemplary embodiment.

FIGS. 18A and 18B are schematic block diagrams of a system for use of a sensor matrix in a vehicle interior according to an exemplary embodiment.

FIGS. 19A and 19B are schematic block diagrams of a system for use of a sensor matrix in a vehicle interior according to an exemplary embodiment.

FIGS. 20A through 20B are schematic flow diagrams of a method for use of a sensor matrix in a vehicle interior according to an exemplary embodiment.

FIGS. 21A through 21B are schematic flow diagrams of a method for use of a sensor matrix in a vehicle interior according to an exemplary embodiment.

FIG. 22A is a schematic block diagram of vehicle/network systems according to an exemplary embodiment.

FIG. 22B is a schematic block diagram of vehicle/network systems according to an exemplary embodiment.

FIG. 22C is a schematic block diagram of vehicle/network systems according to an exemplary embodiment.

FIGS. 23A through 23B are schematic block diagrams of vehicle/network systems according to an exemplary embodiment.

FIG. 24 is a schematic block diagram of vehicle/network systems according to an exemplary embodiment.

### DESCRIPTION

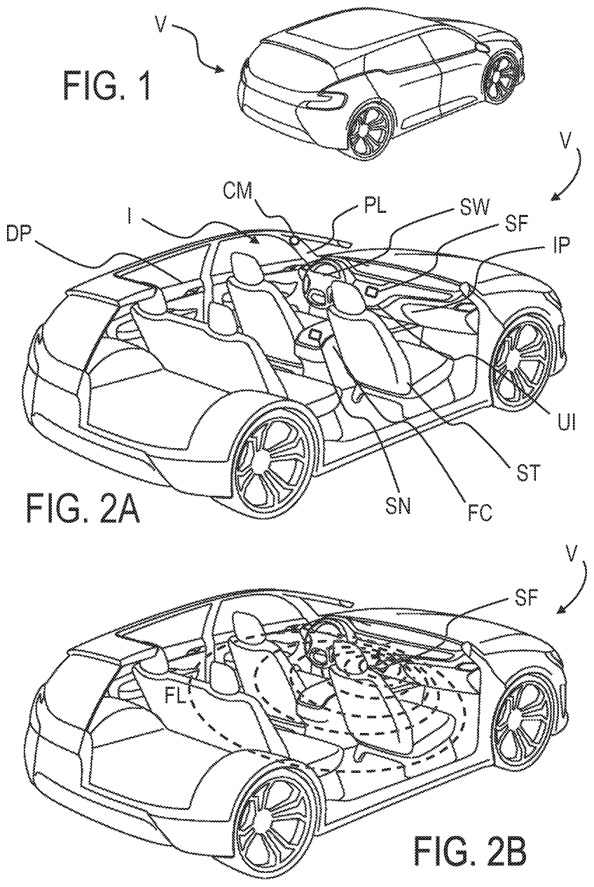

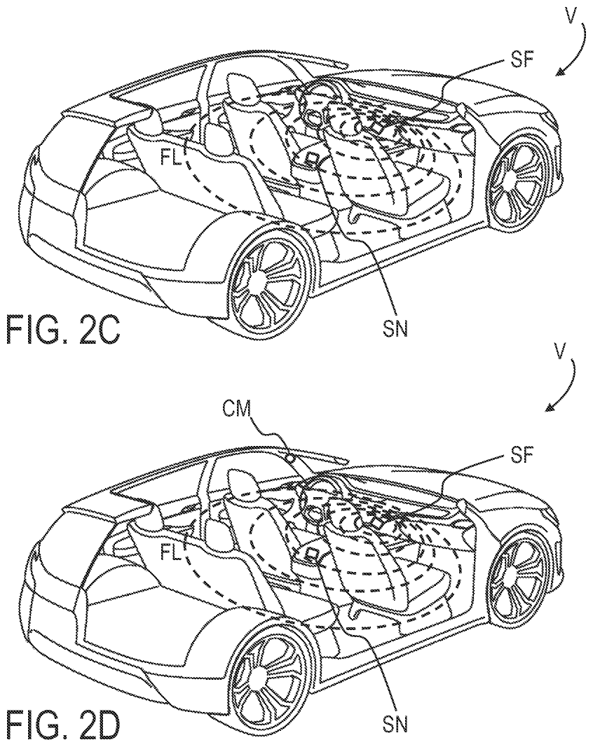

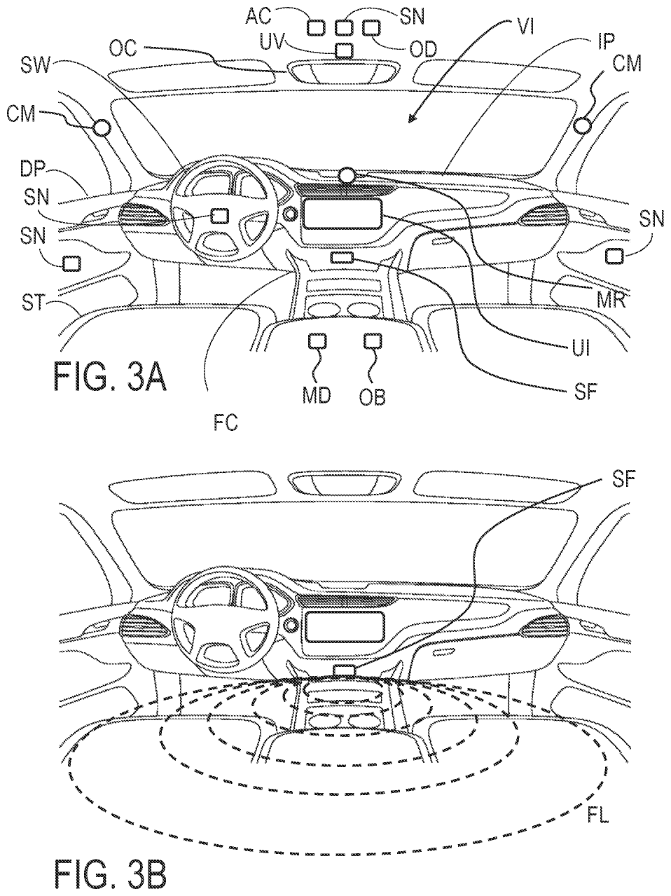

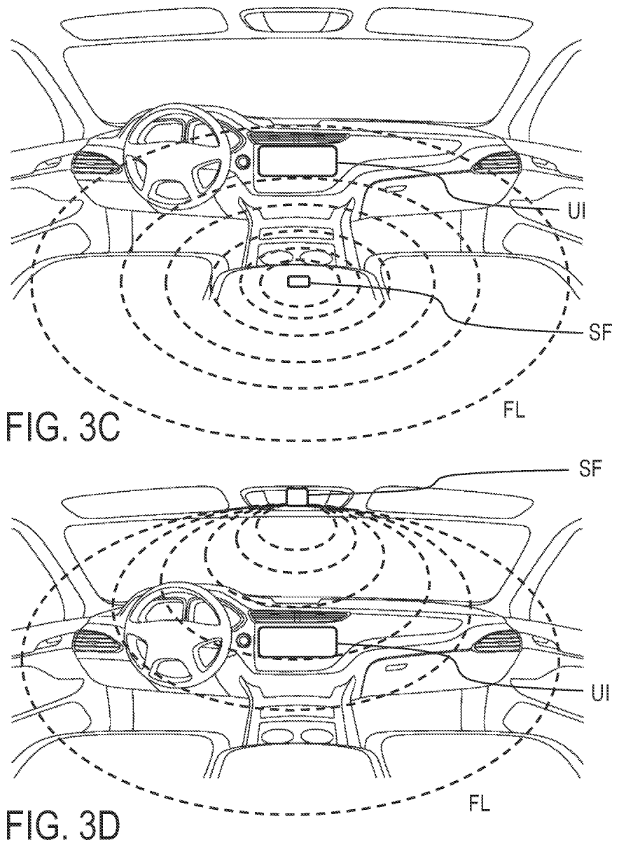

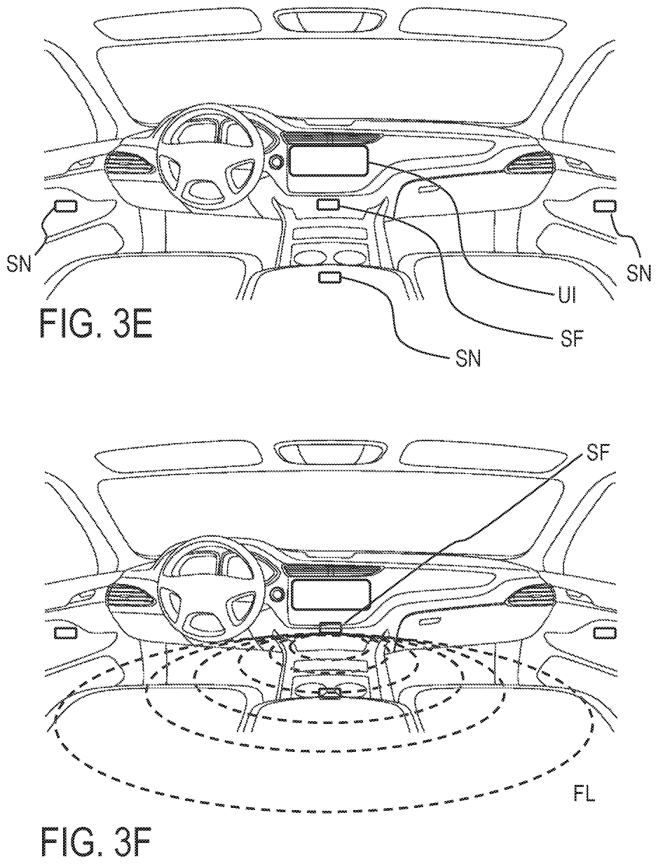

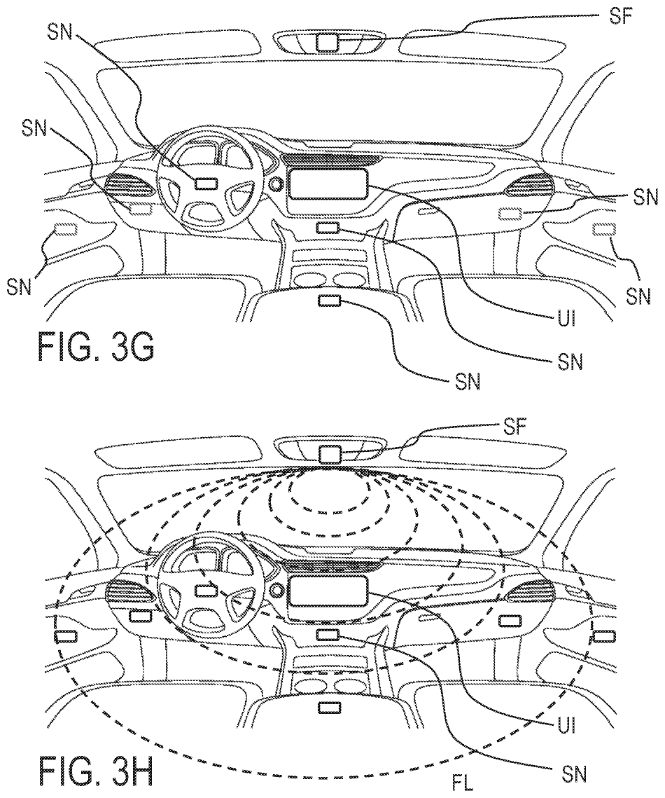

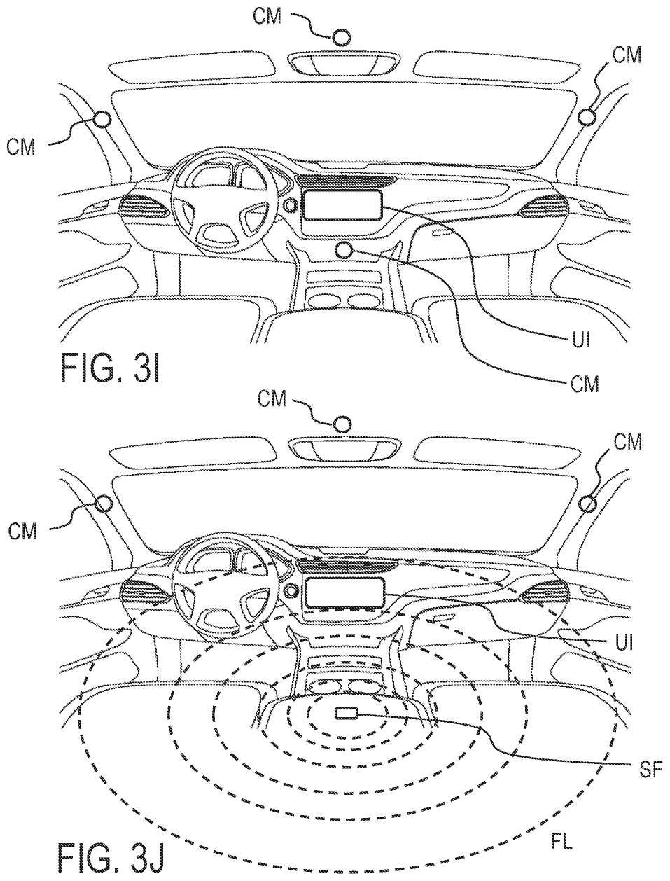

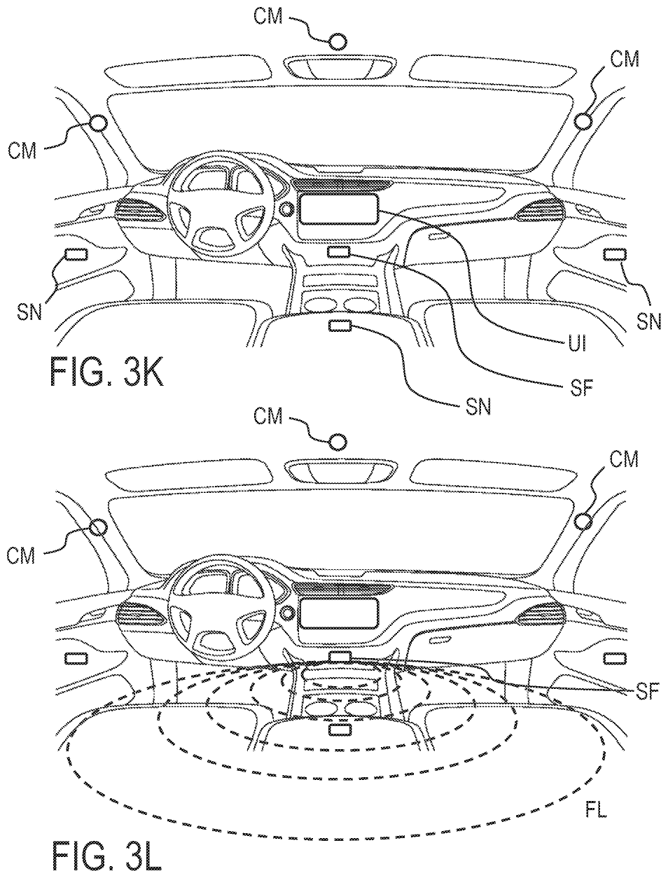

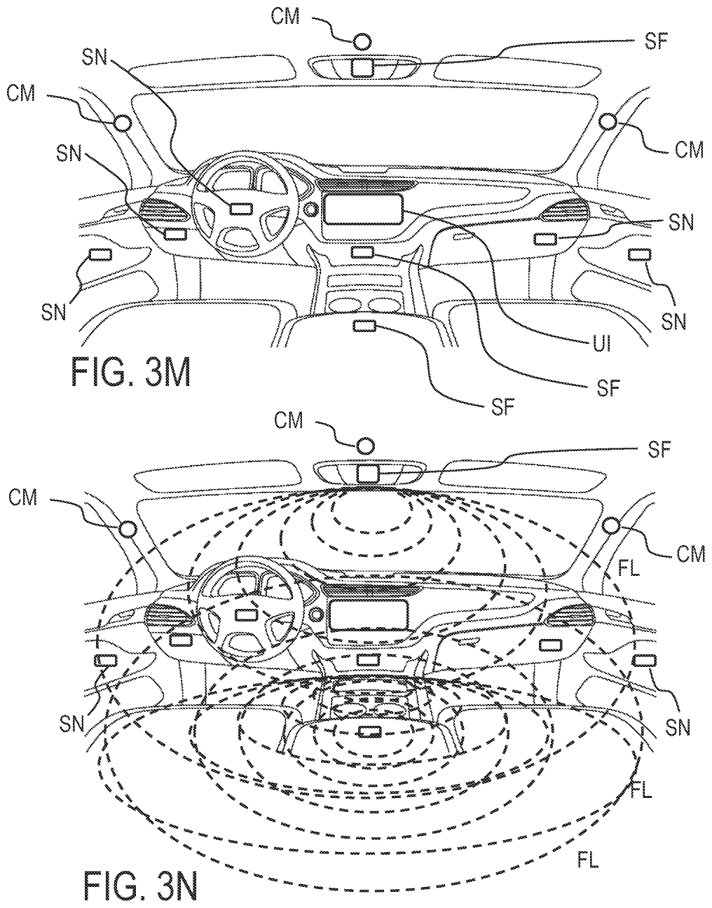

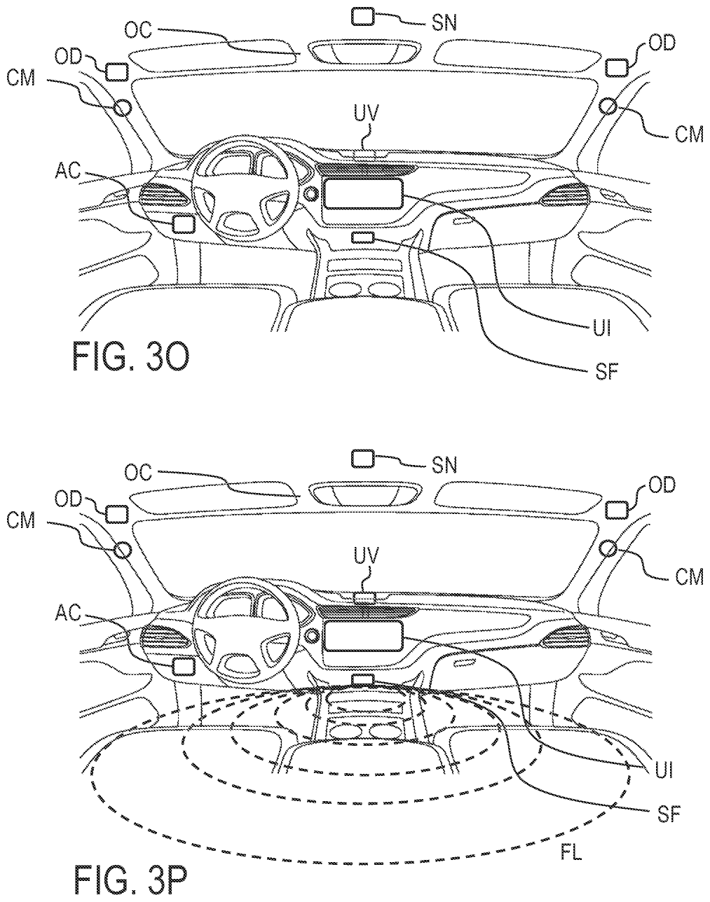

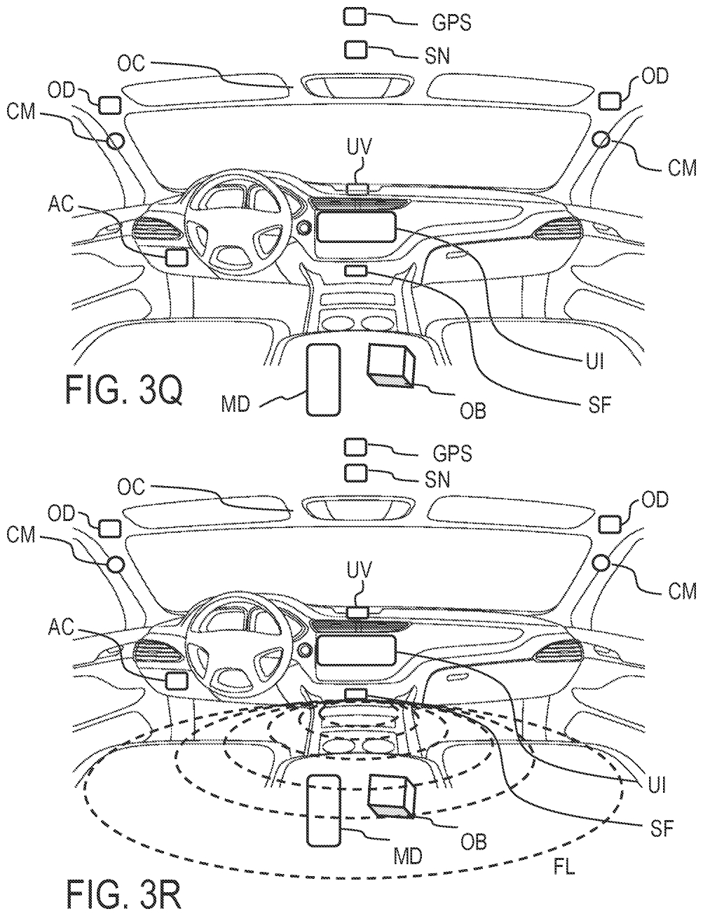

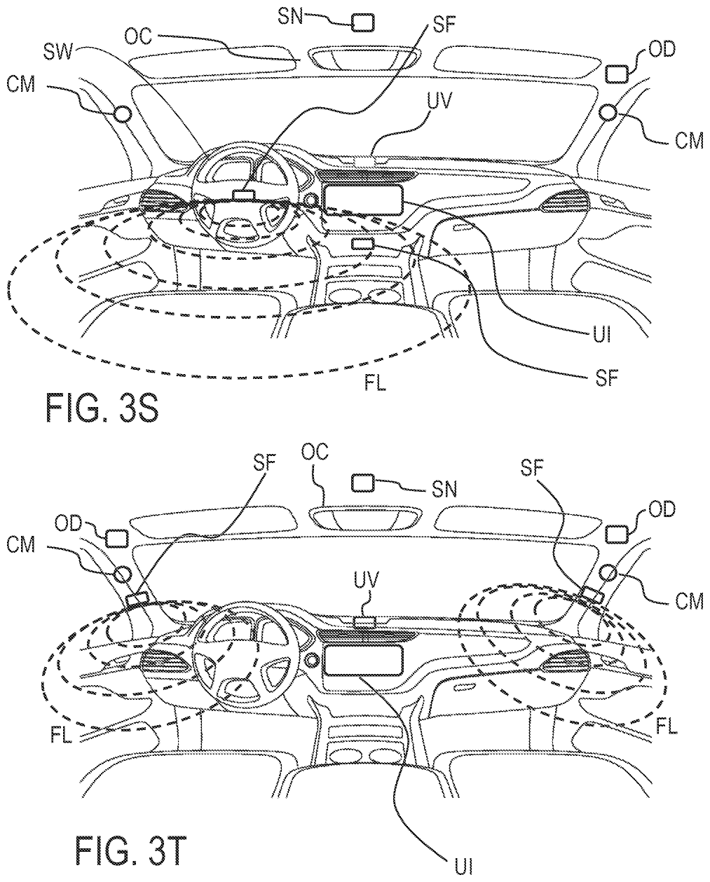

Referring to FIGS. 1 and 2A-2D, a vehicle V with an interior I is shown according to an exemplary embodiment with a system for use of a sensor/sensor matrix SN/SF configured to obtain input/input signals and to provide output/output signals relating to interaction with an occupant and/or vehicle systems and/or a network. See also FIGS. 3A-3T, 4A-4B and 12.

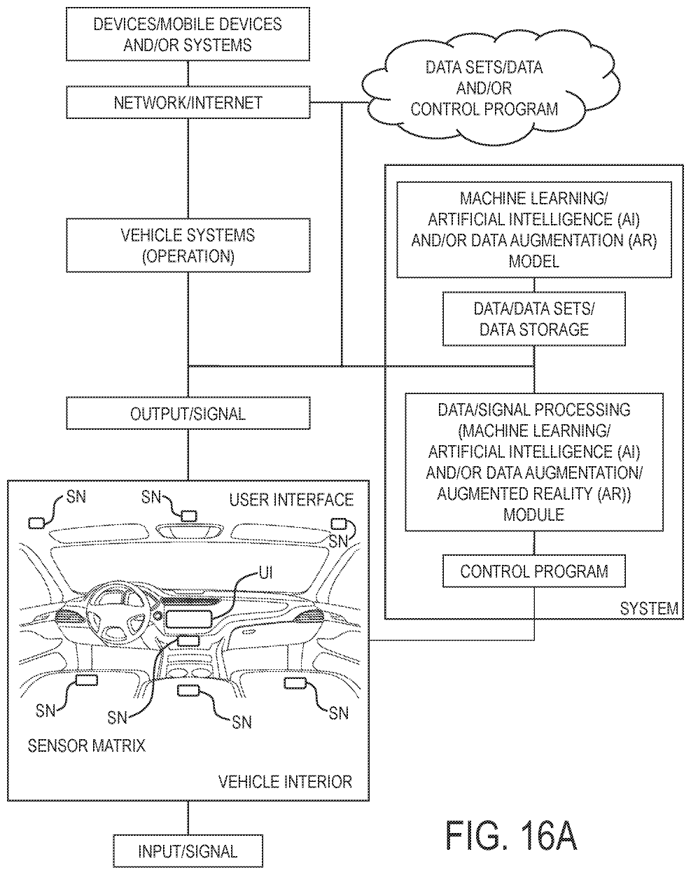

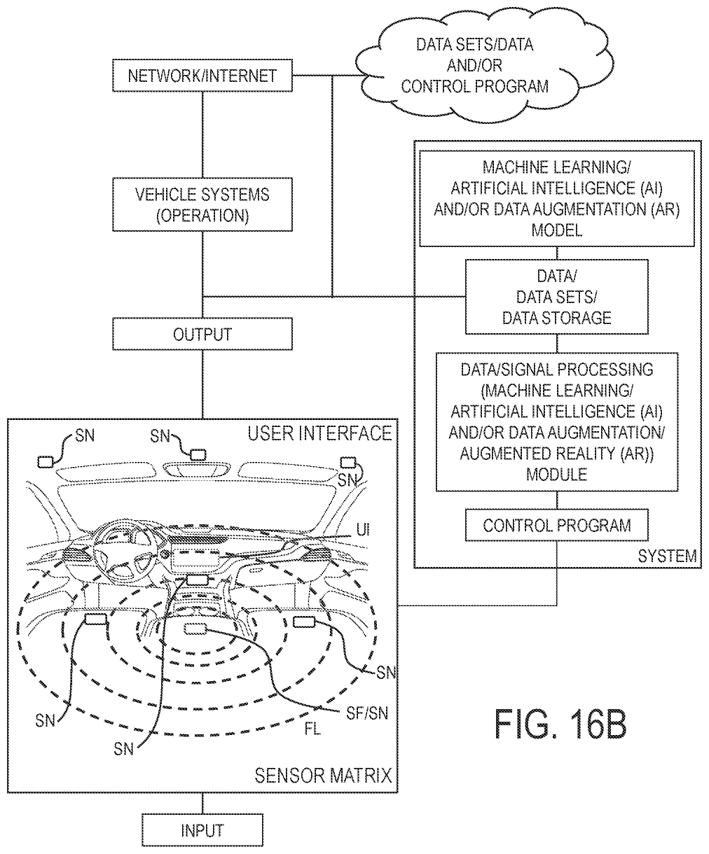

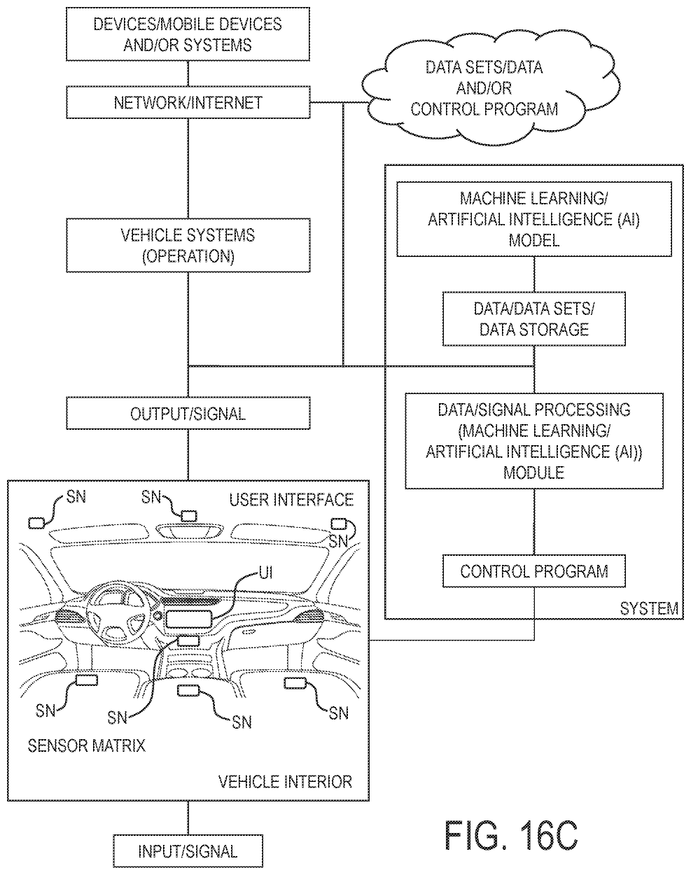

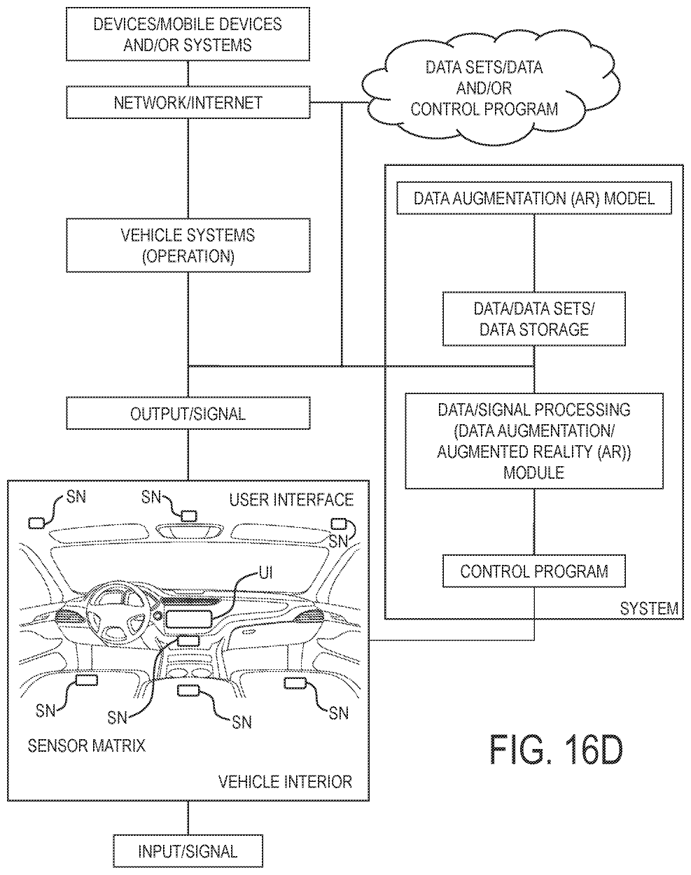

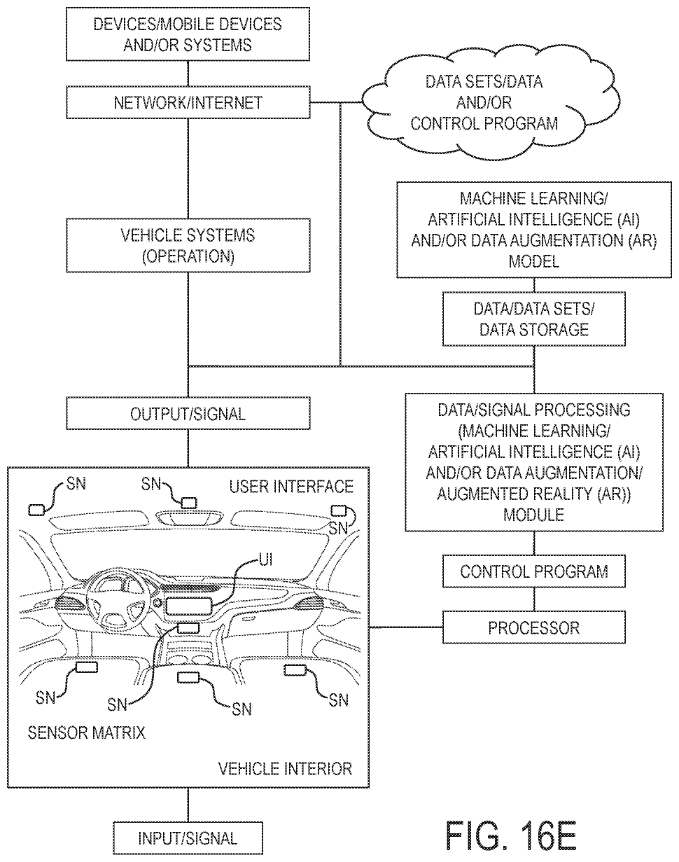

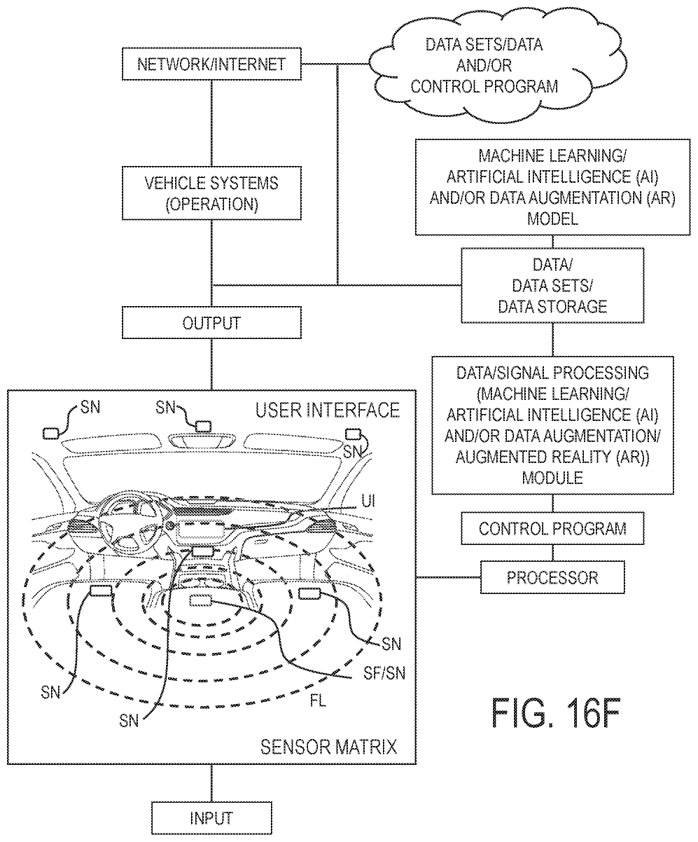

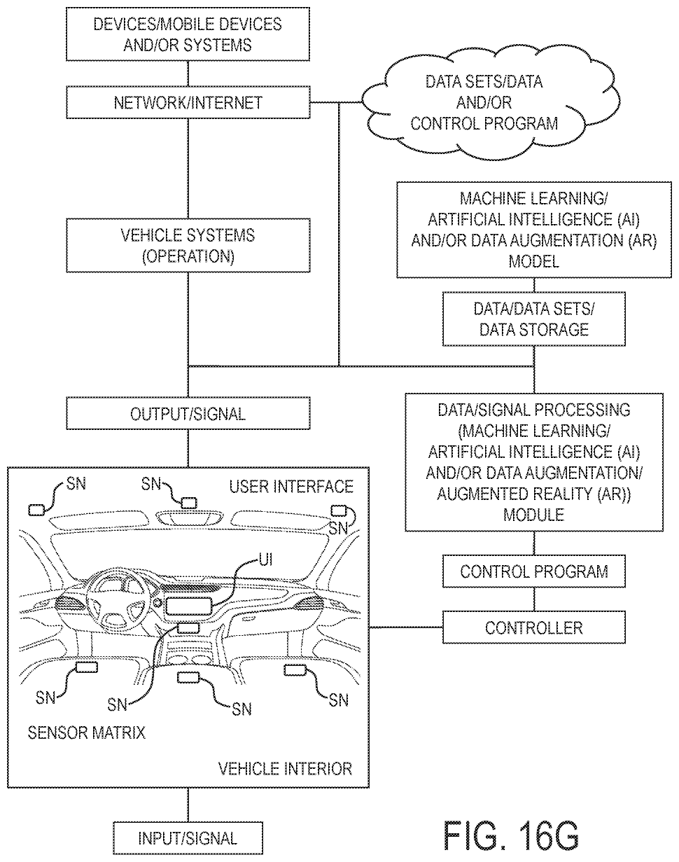

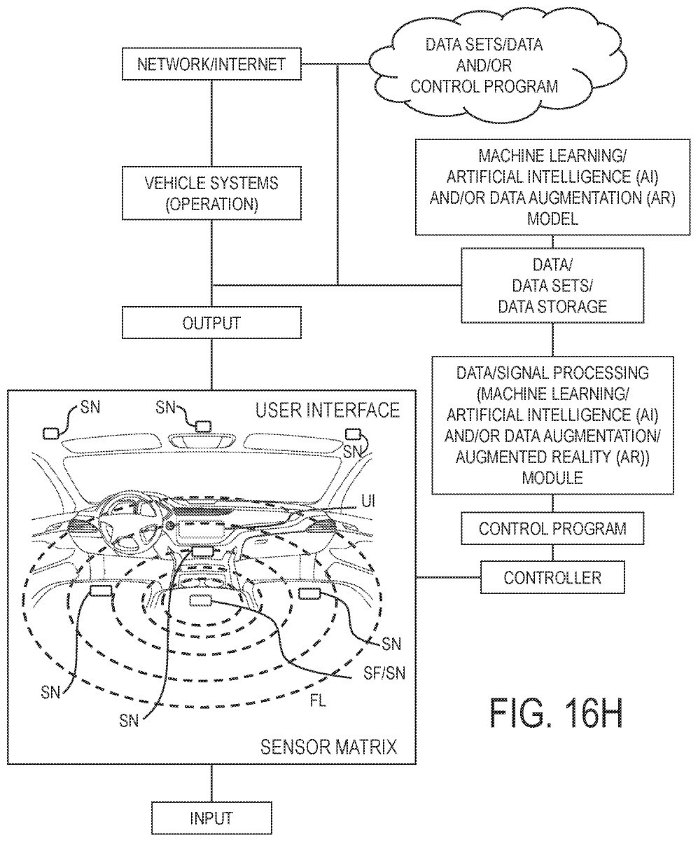

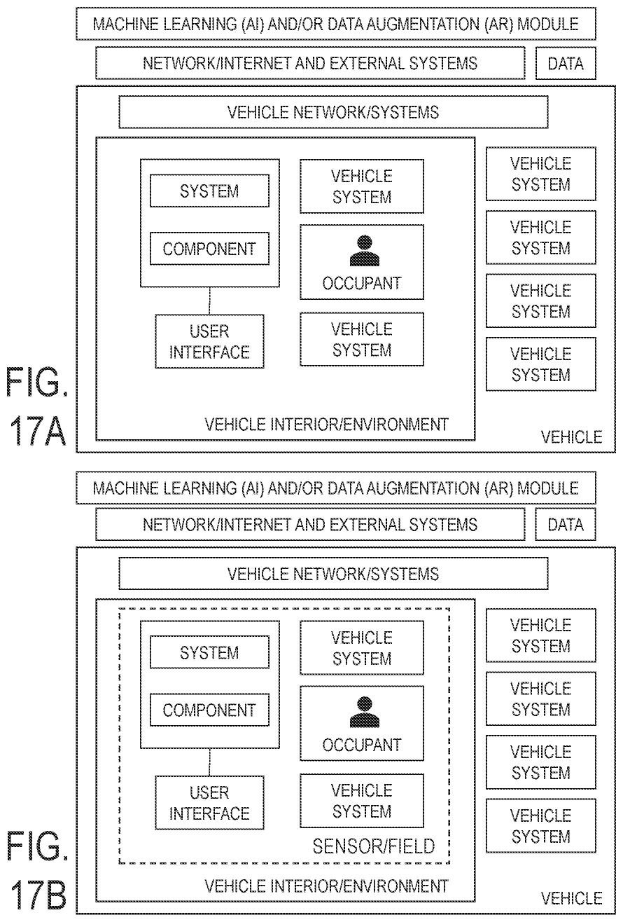

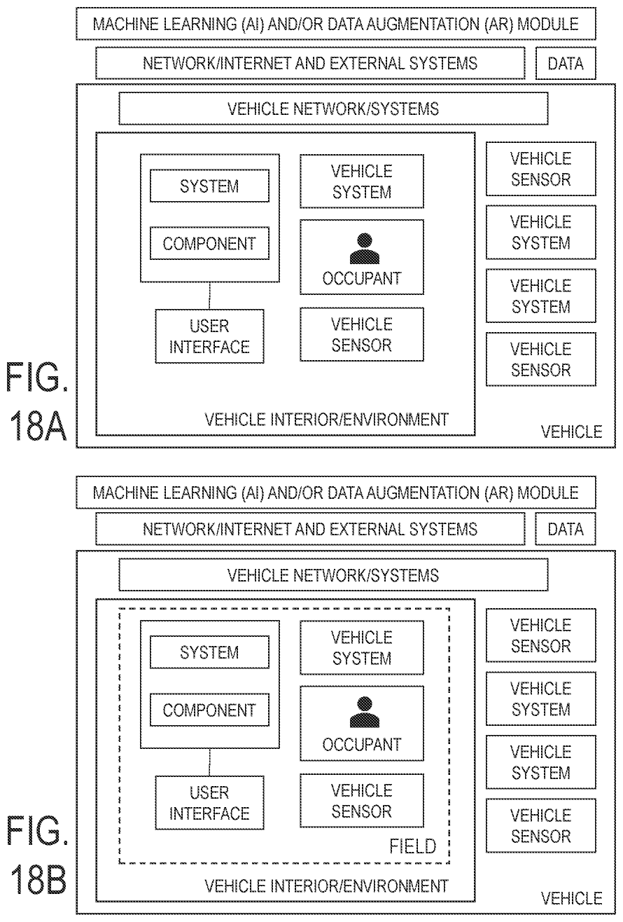

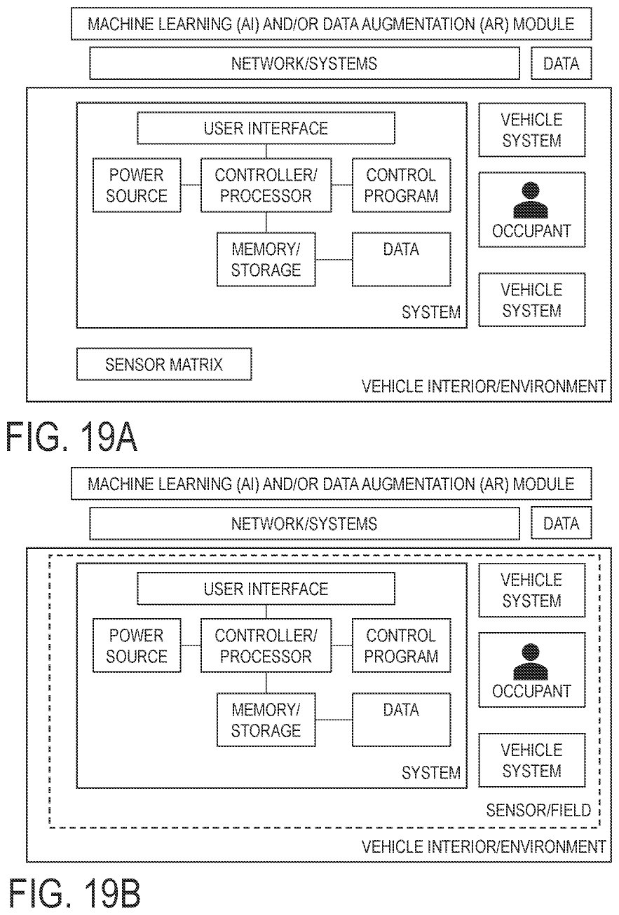

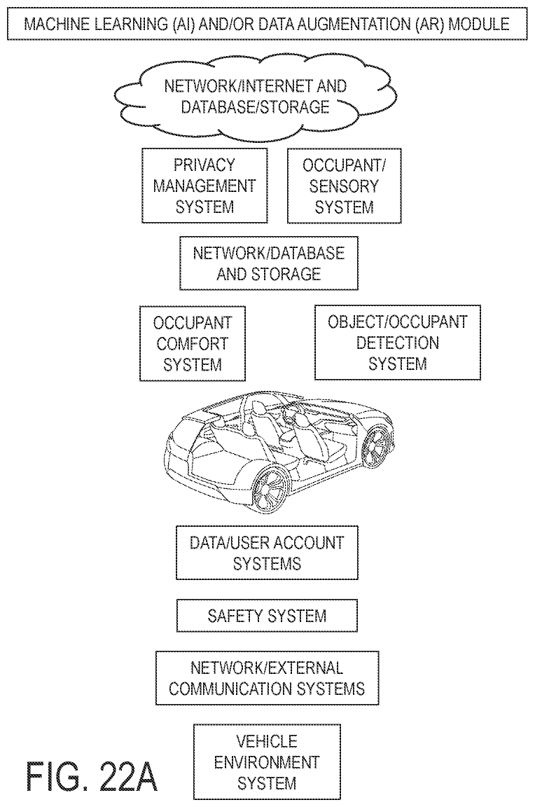

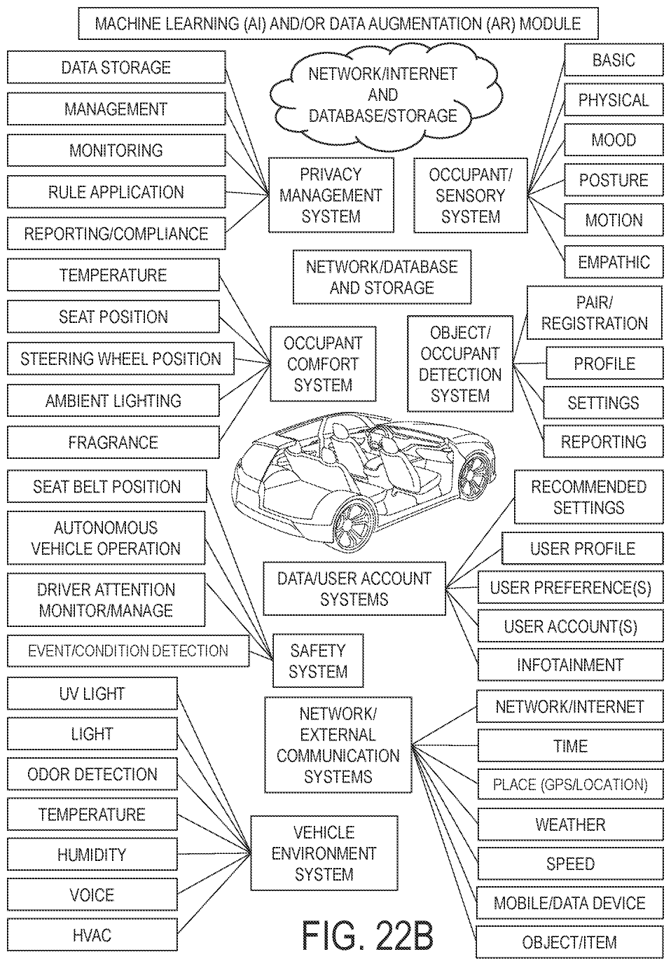

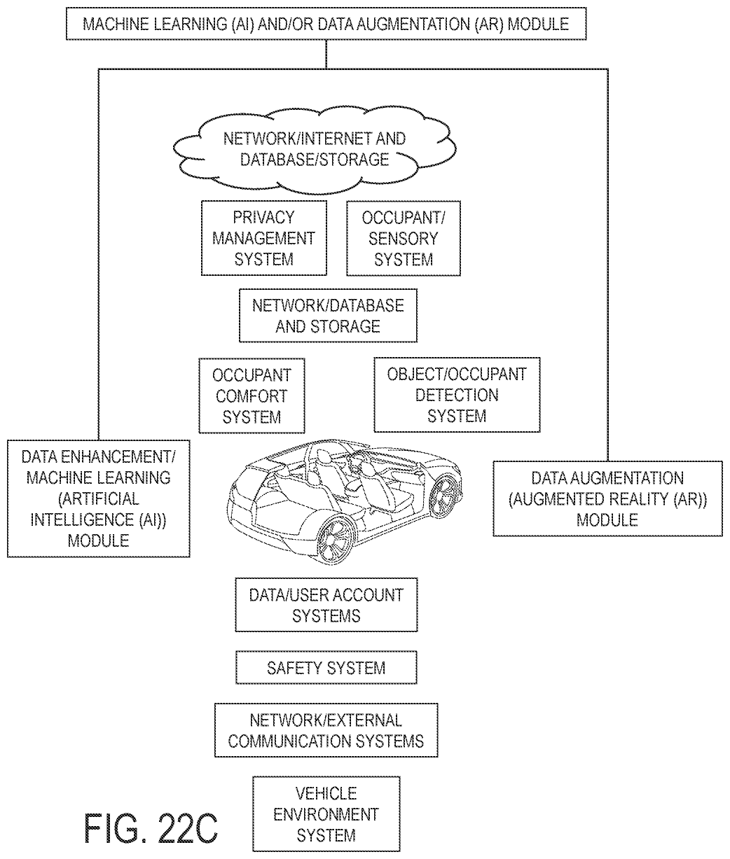

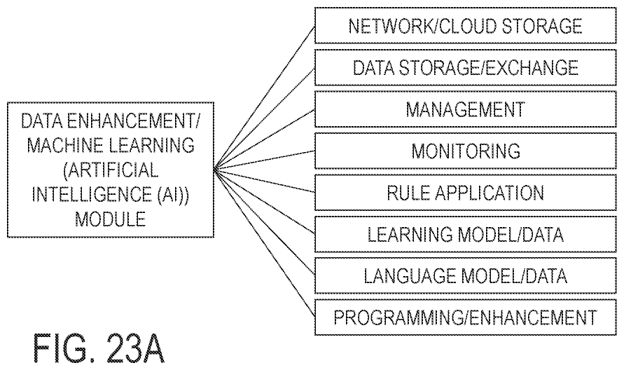

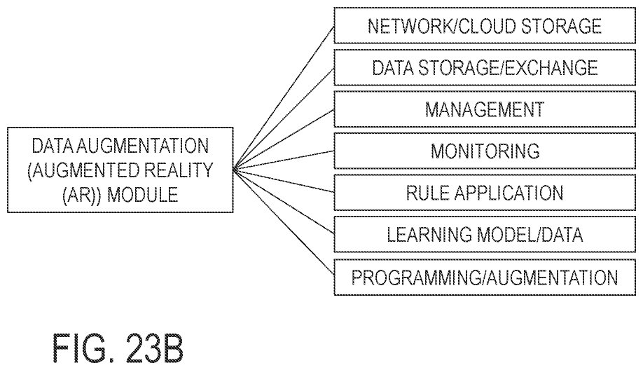

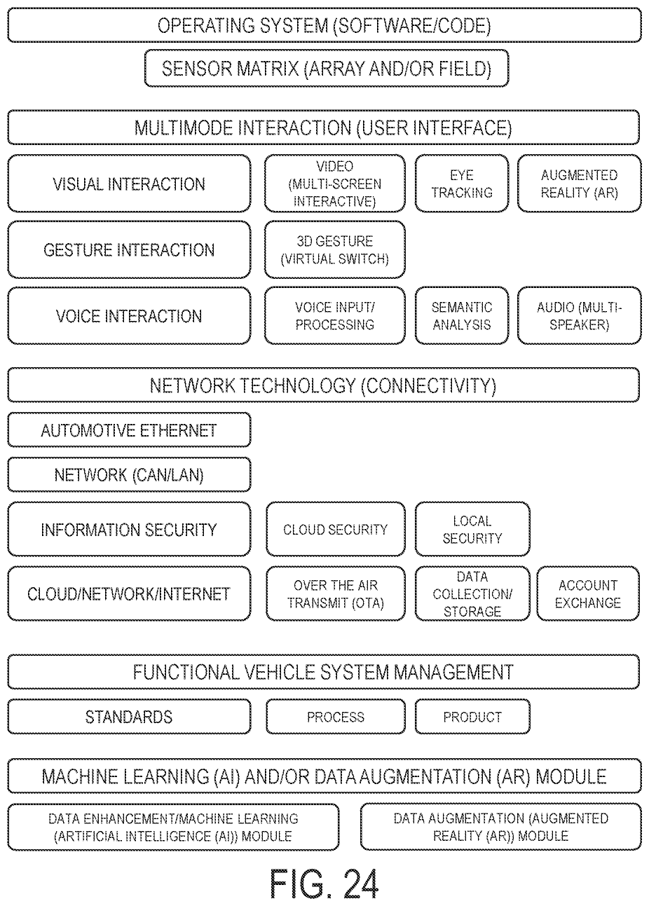

Referring to FIGS. 12A-2D, and 15A-15E, a vehicle V with an interior I is shown according to an exemplary embodiment with a system for use of a sensor/sensor matrix SN/SF configured to obtain input/input signals and to provide output/output signals relating to interaction with an occupant and/or vehicle systems and/or a network. See also FIGS. 16A-16H, 17A-17B, 18A-18B, 19A-19B, 22A-22C, 23A-23B and 24.

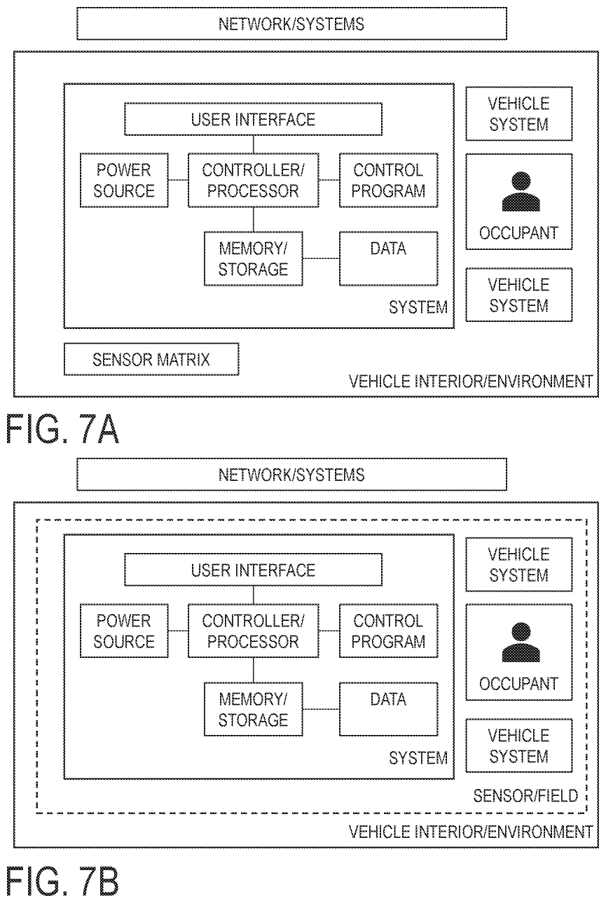

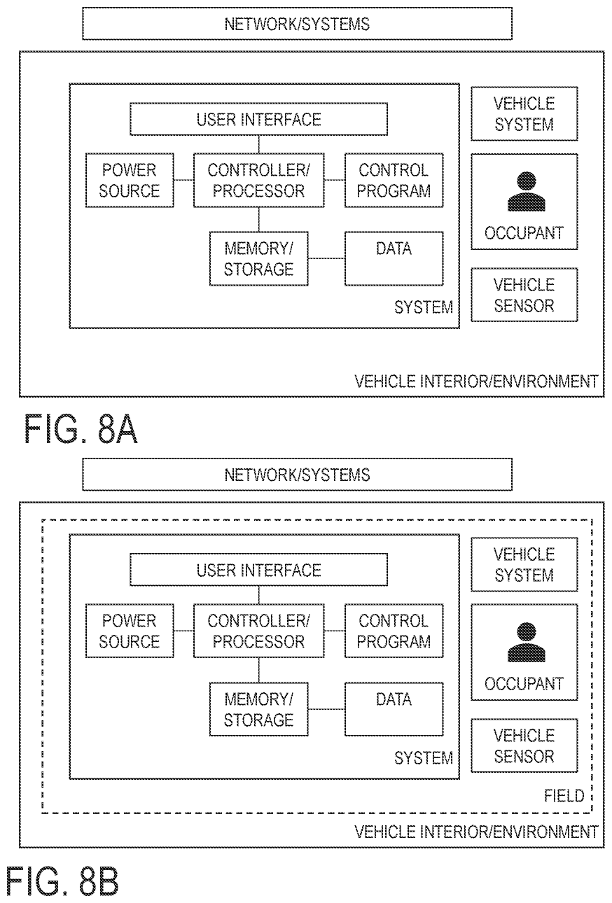

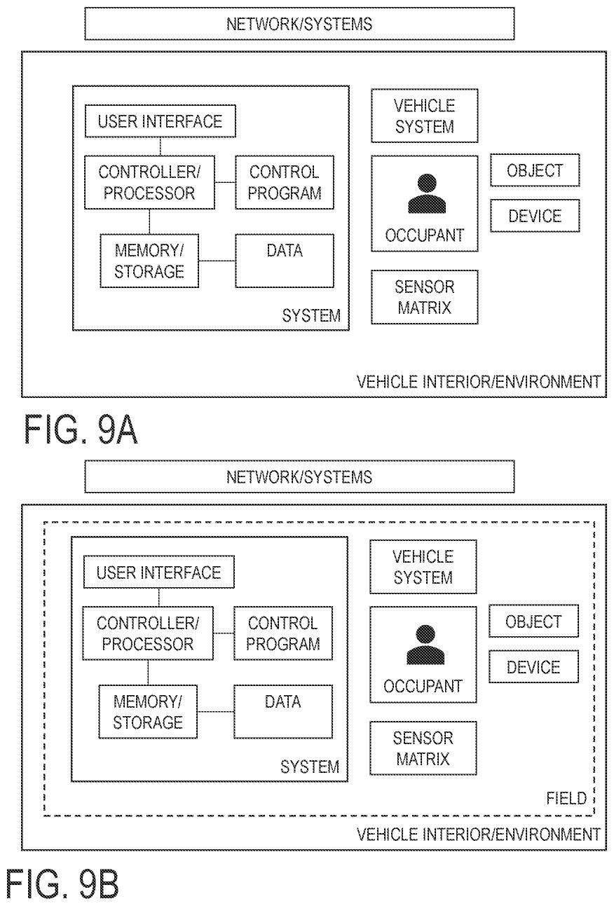

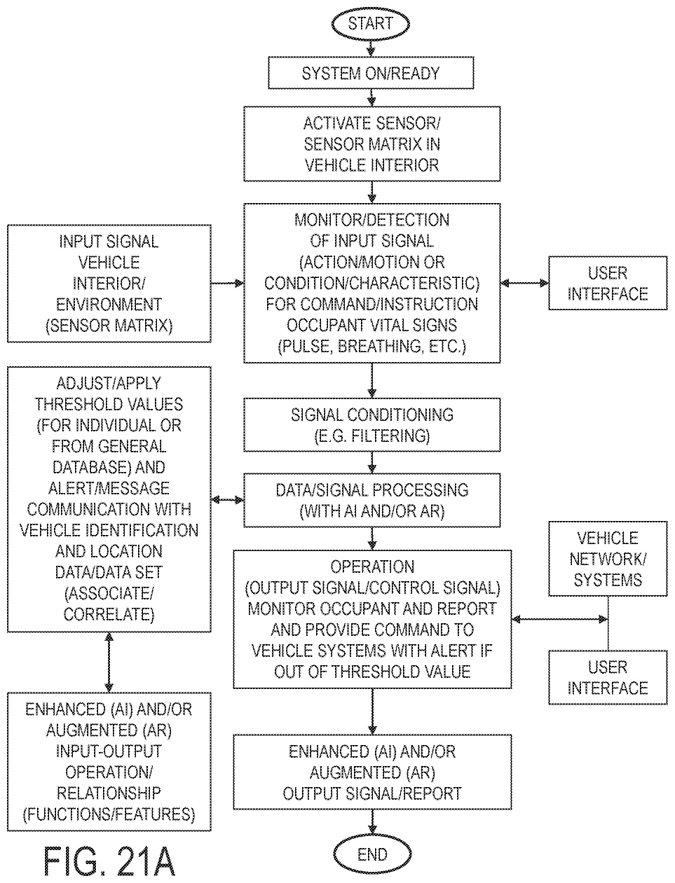

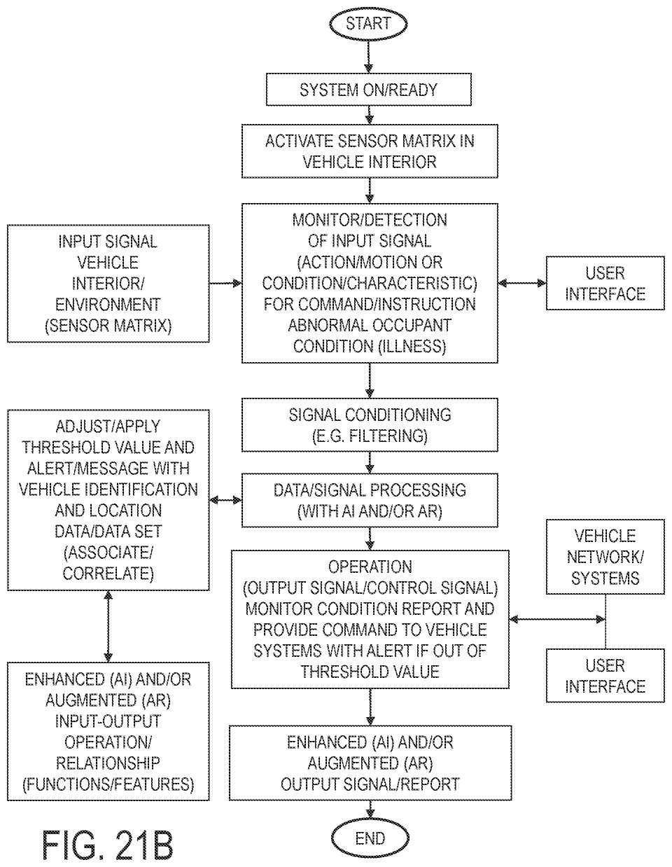

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, an improved system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant and to use data to provide an output signal comprising an enhancement of the input signal and/or an augmentation of the input signal. The output signal may comprise a signal based on application of artificial intelligence; the output signal may comprise a signal based on application of augmented reality. The sensor arrangement may comprise a distributed sensor matrix configured to obtain data from within the vehicle; at least one data source may comprise the sensor matrix and/or a vehicle system and/or data storage and/or a network. See also TABLES A-1 and A-2 and TABLE B.

### Exemplary Embodiments—A

According to an exemplary embodiment as shown schematically in FIGS. 2A-2D, 3A, 4A-4B and 12, the system is configured for integration of a sensor matrix comprising sensors SN/SF within the vehicle interior with components such as a panel such as an instrument panel IP and/or door panel DP, a console such as overhead console OC and/or floor console FC, a structure such as pillar PL, a seat ST, a steering wheel SW; as indicated schematically the system may be configured with a user interface UI (e.g. comprising an input device such as a control/microphone and/or an output device such as a display/speaker) for interaction with an occupant of the vehicle and/or with vehicle systems and/or with a network (such as a vehicle network, communications network, telecommunications network, internet, etc.). See also FIGS. 3B-3T, 5A-5B, 6A-6B, 7A-7B, 8A-8B, 9A-9B, 13A-13H and 14.

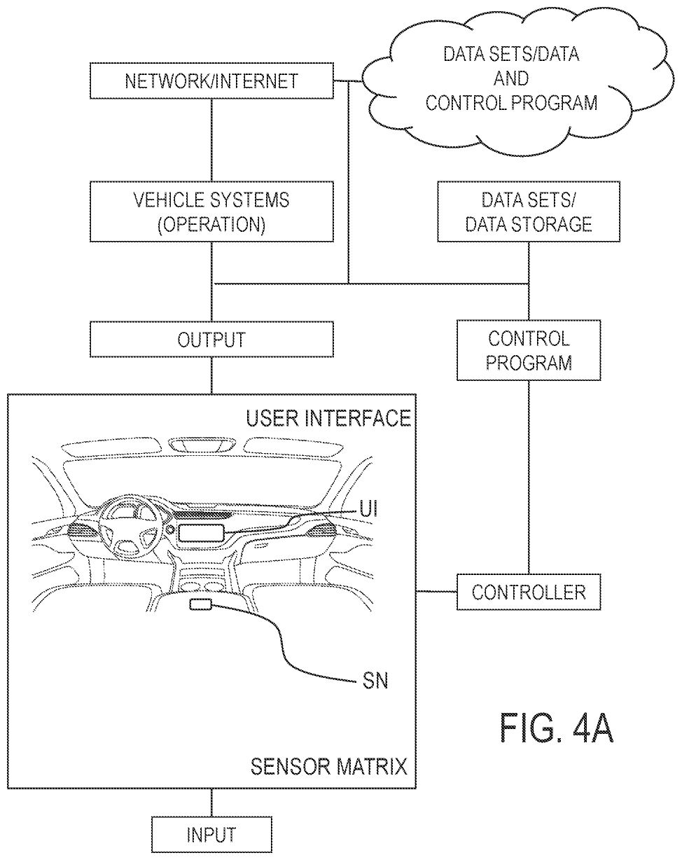

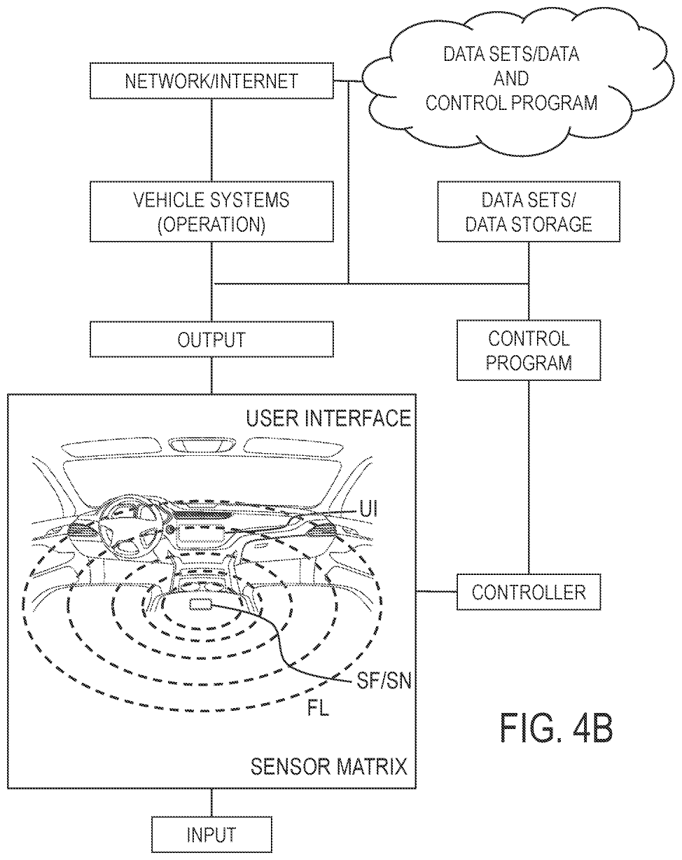

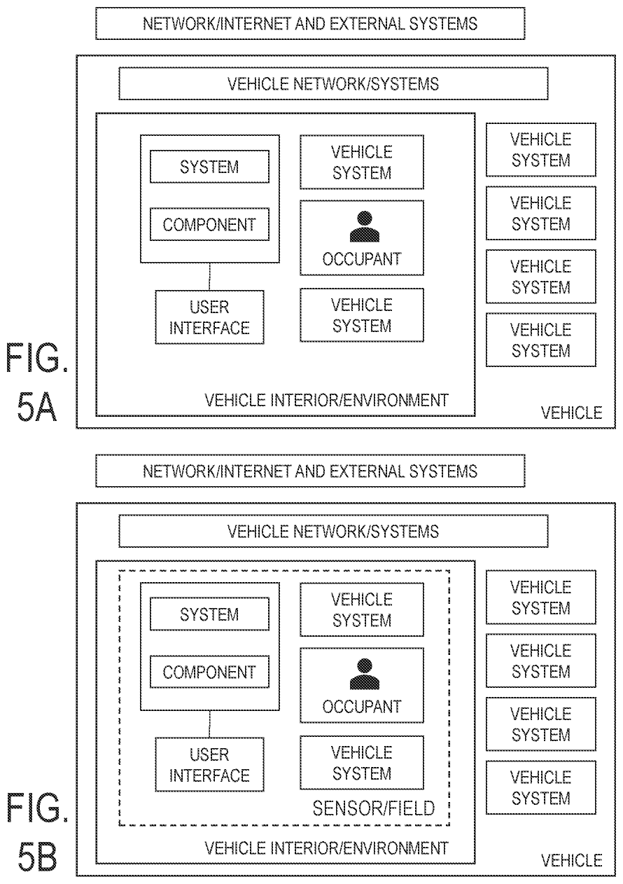

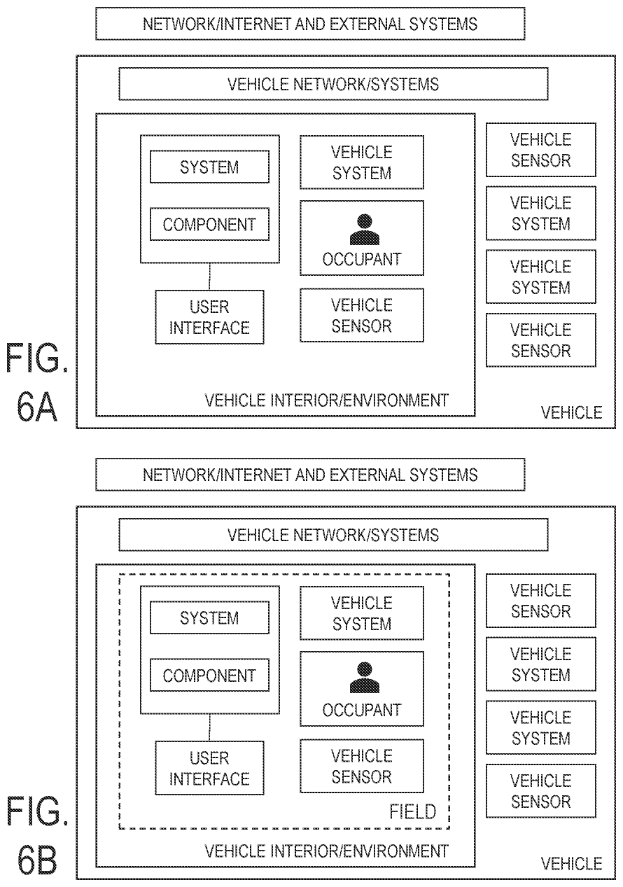

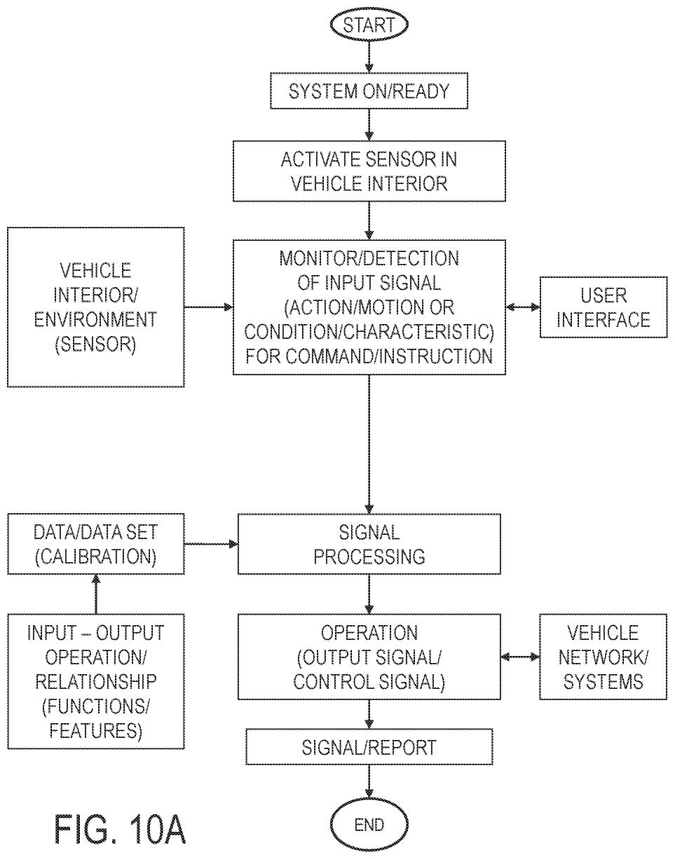

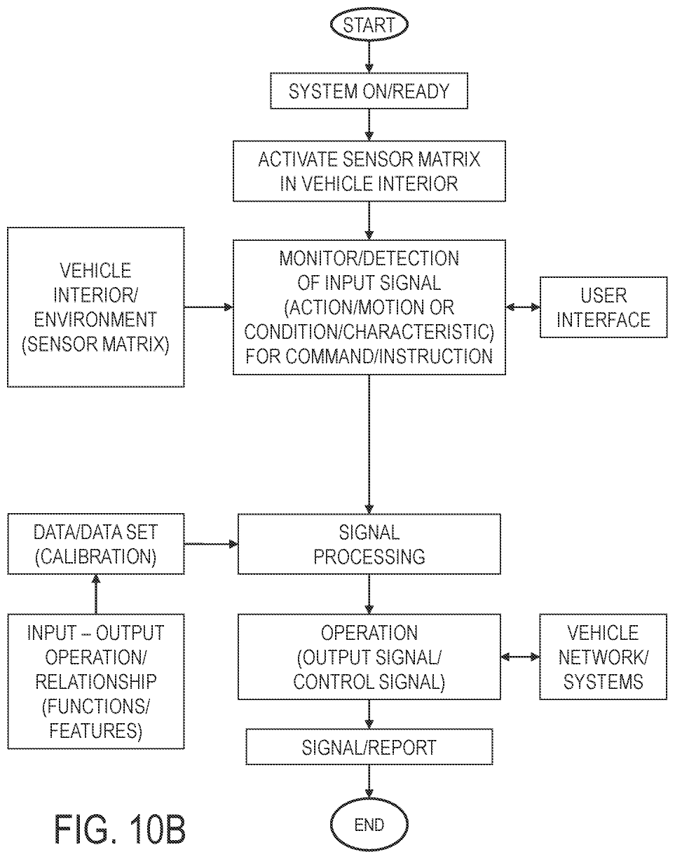

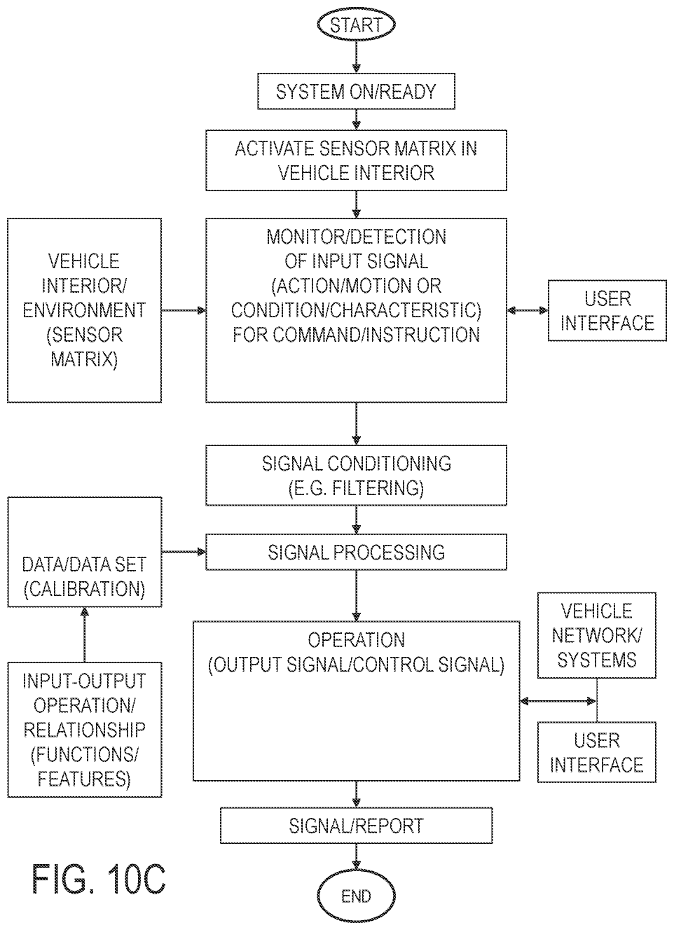

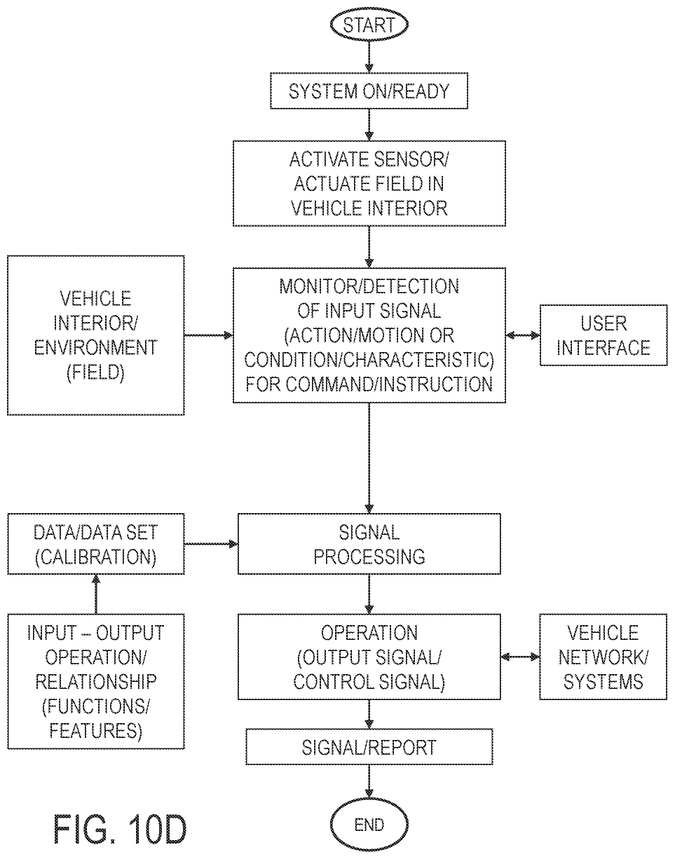

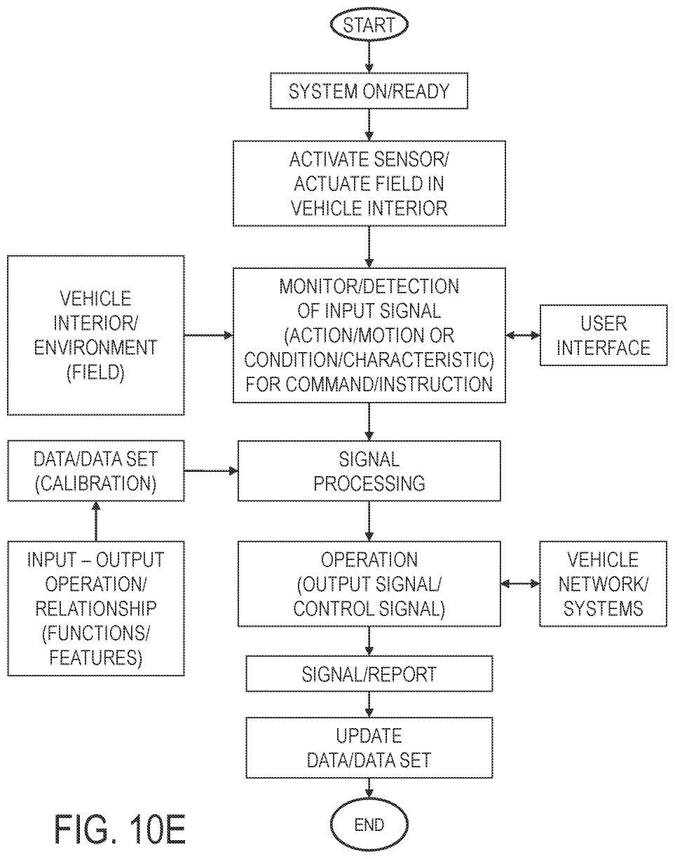

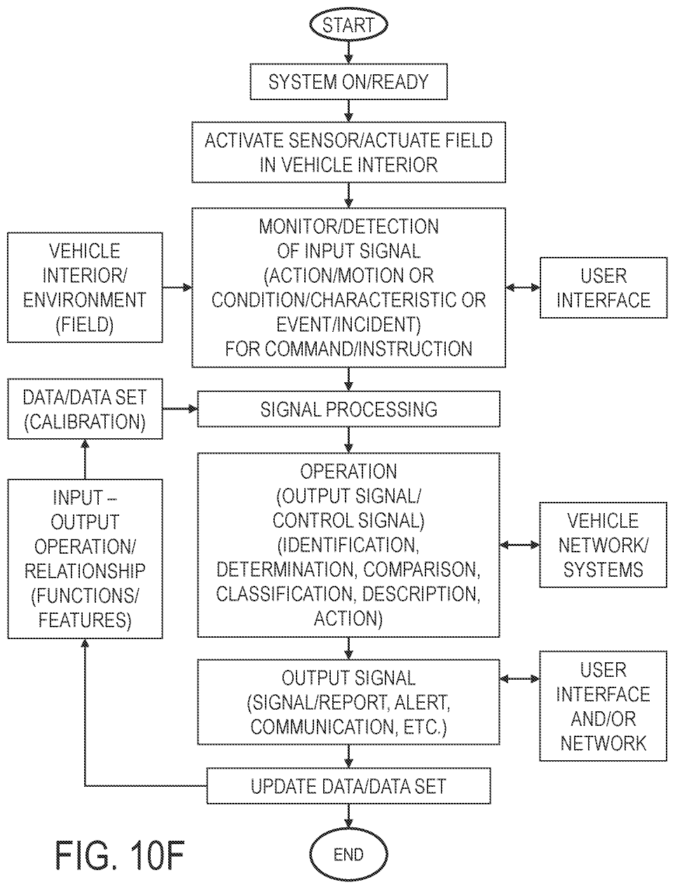

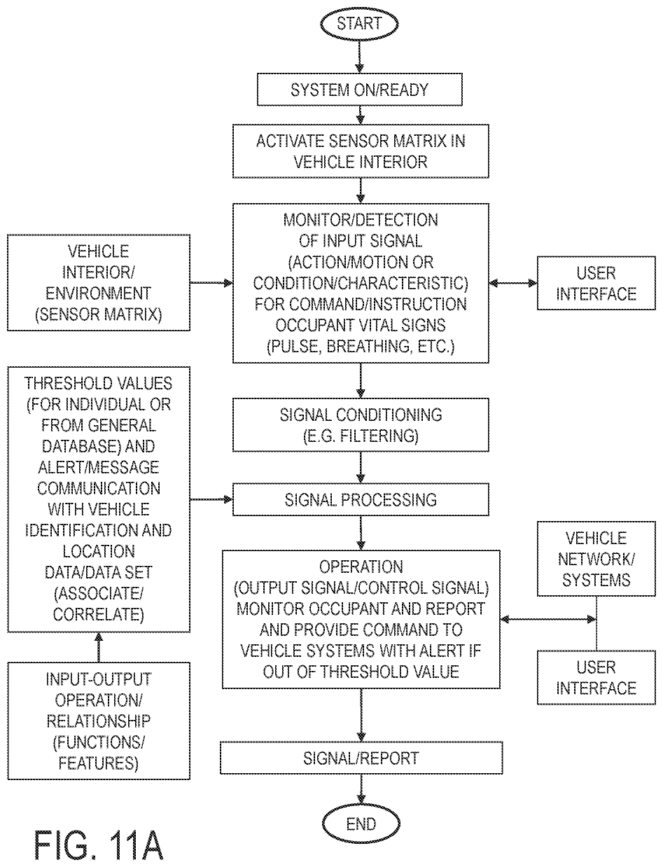

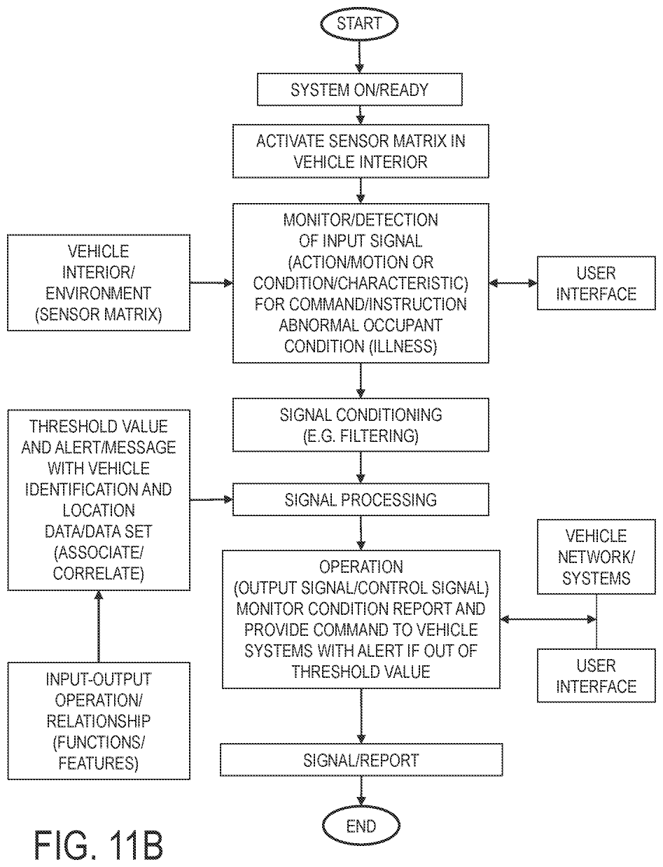

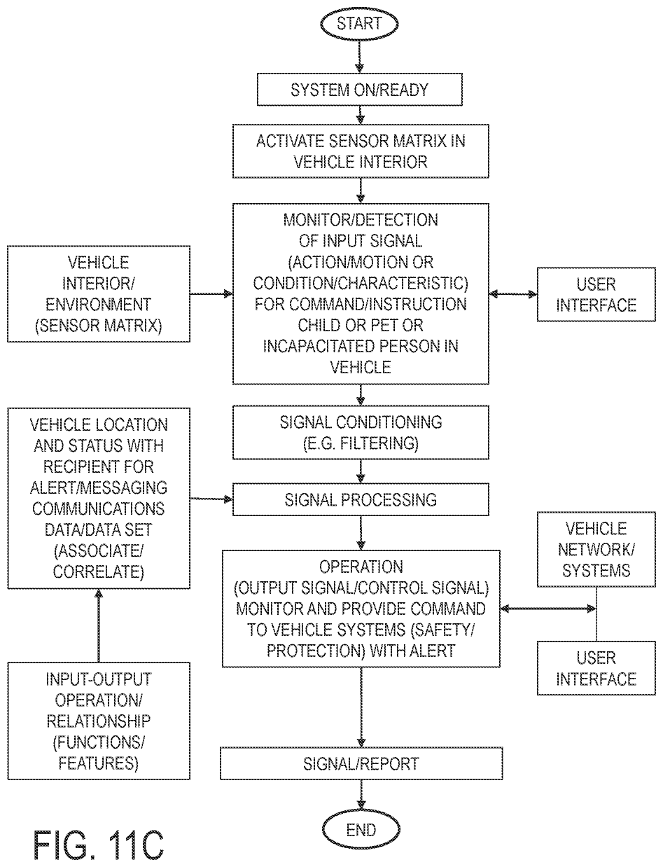

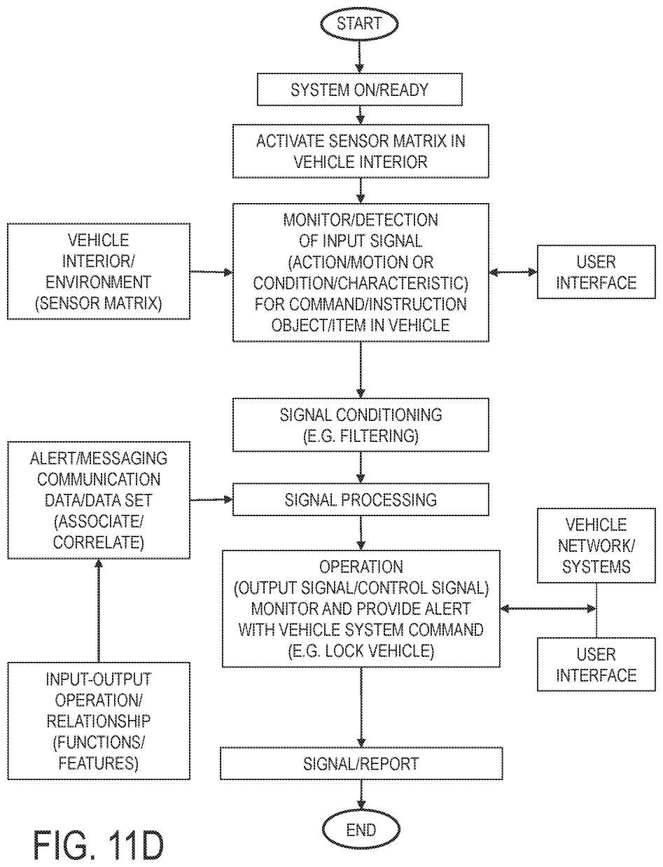

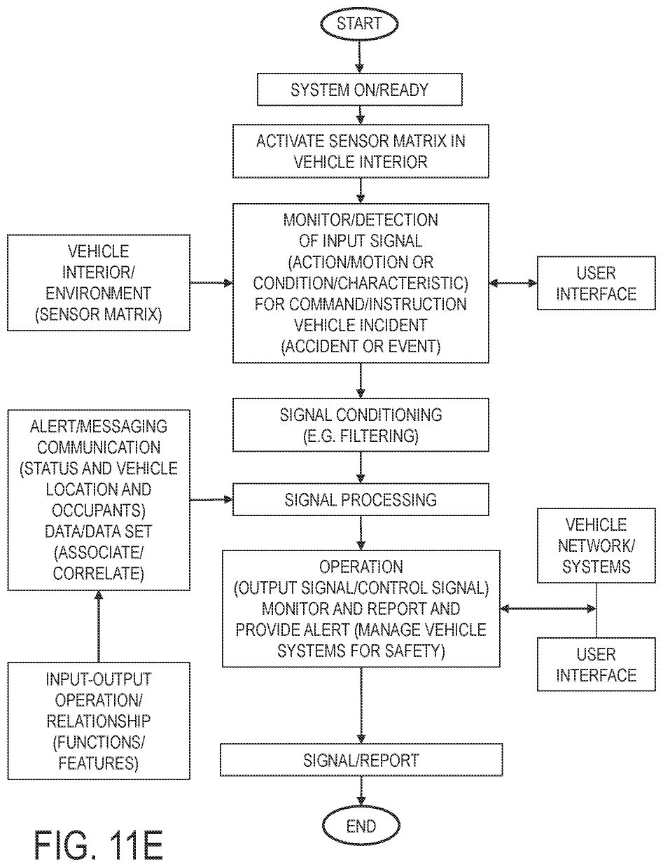

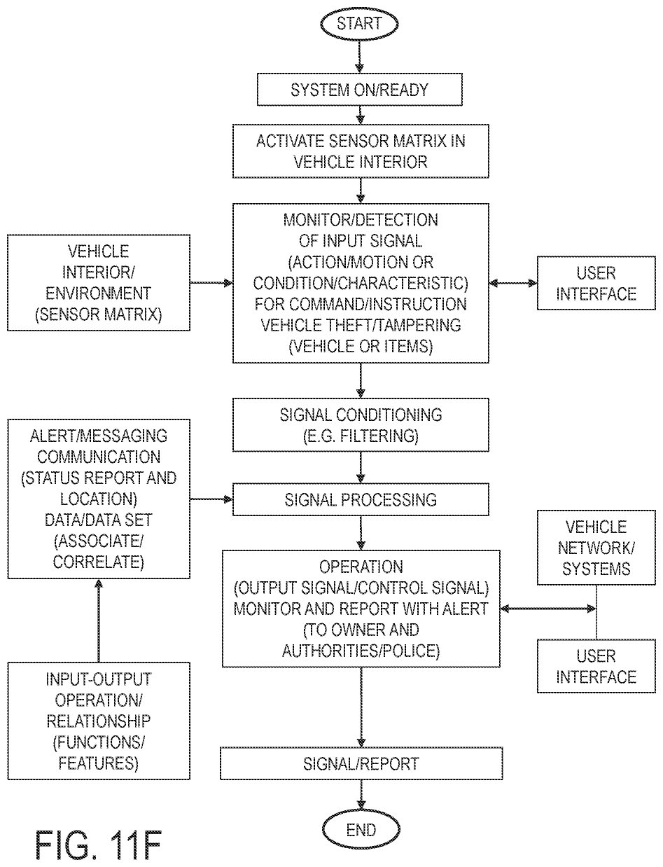

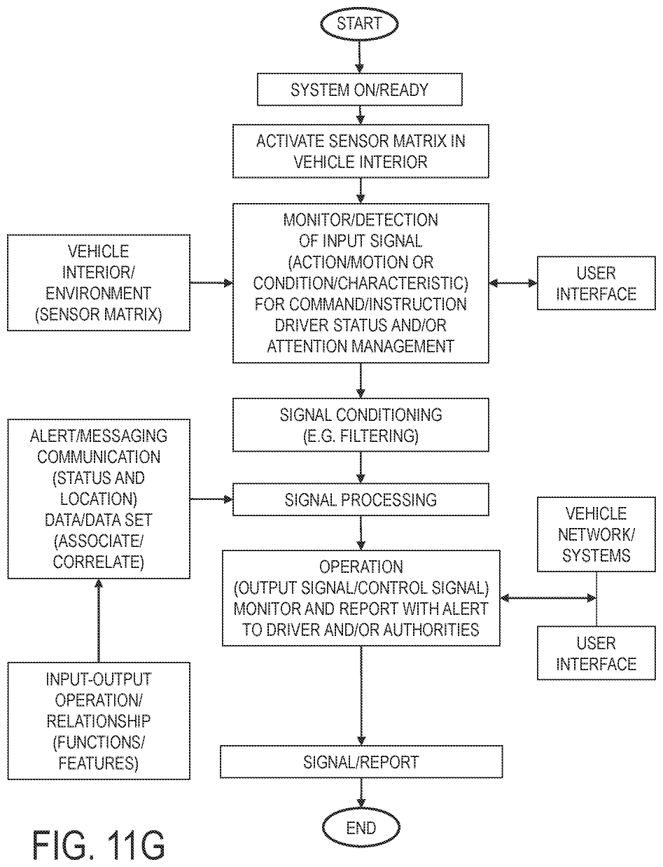

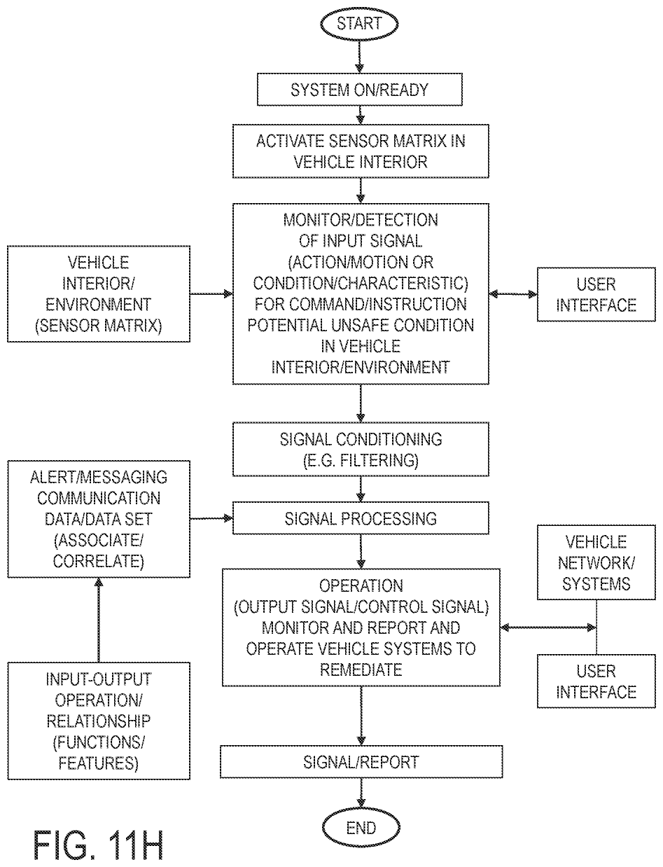

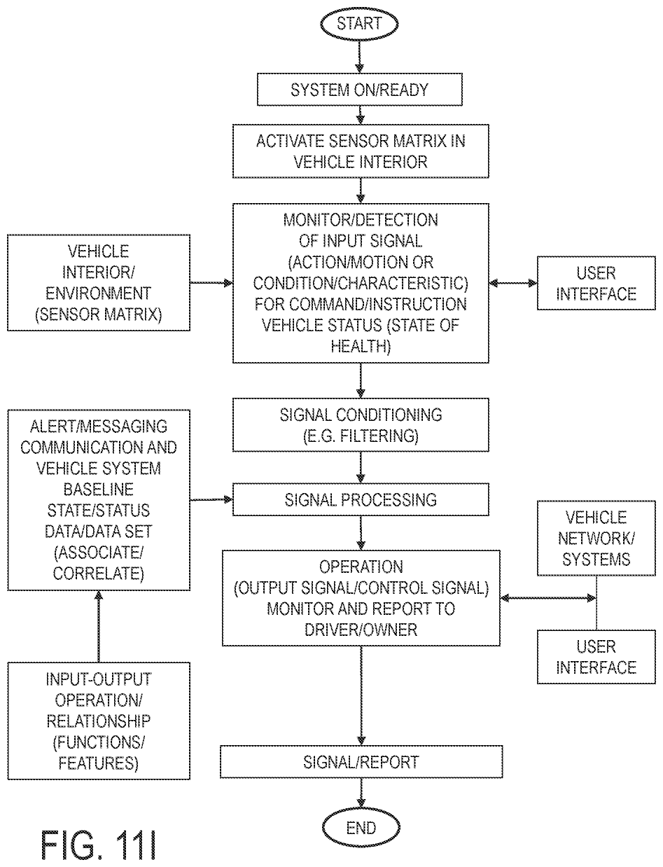

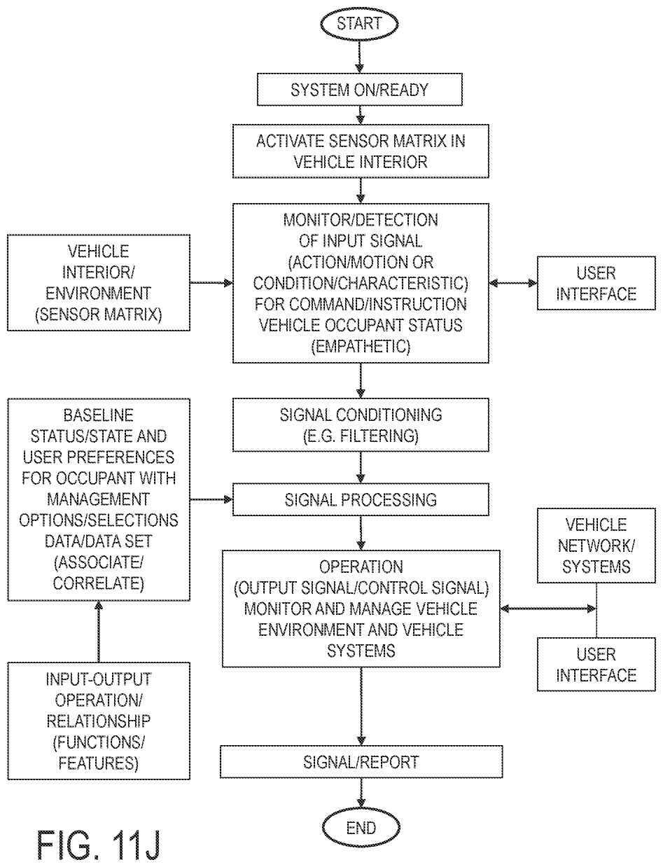

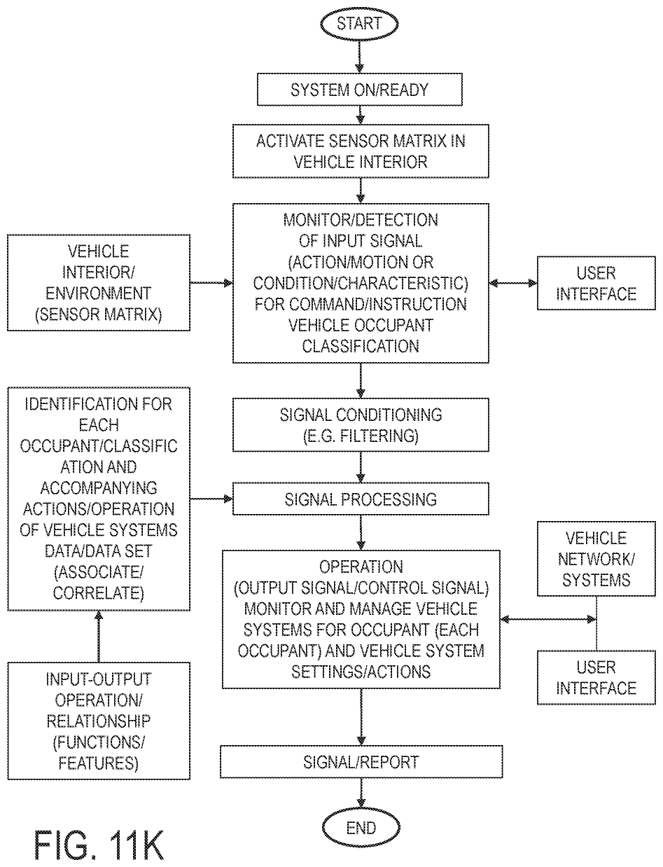

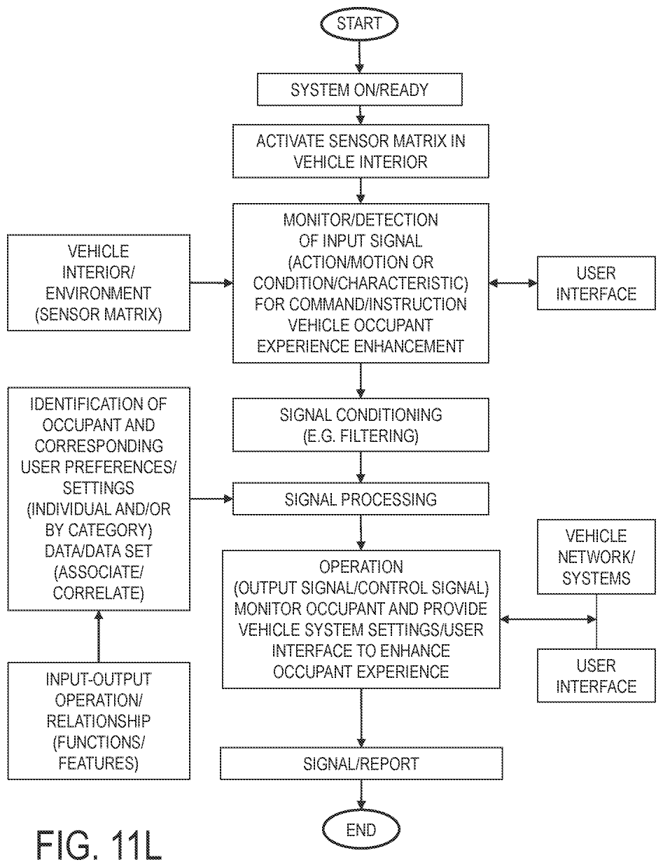

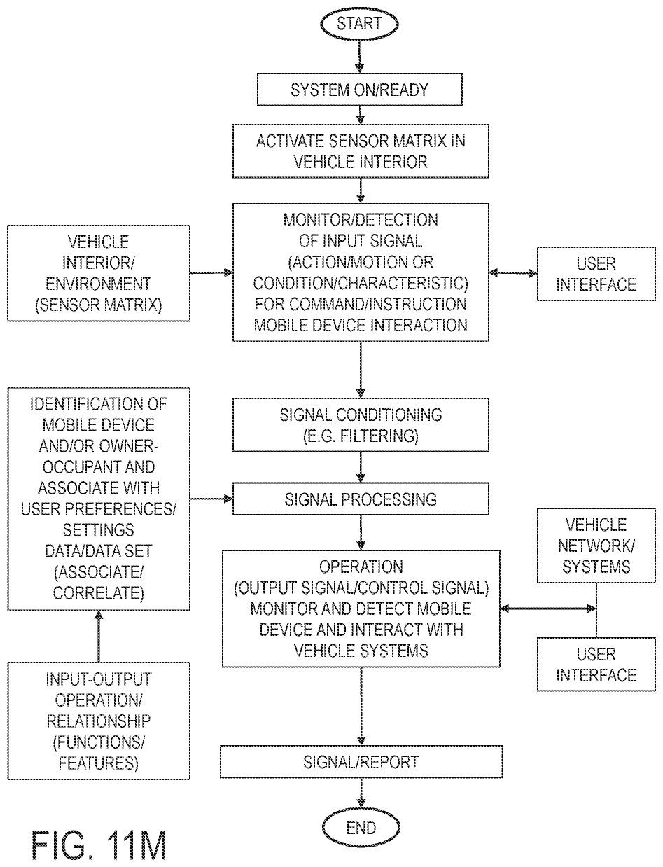

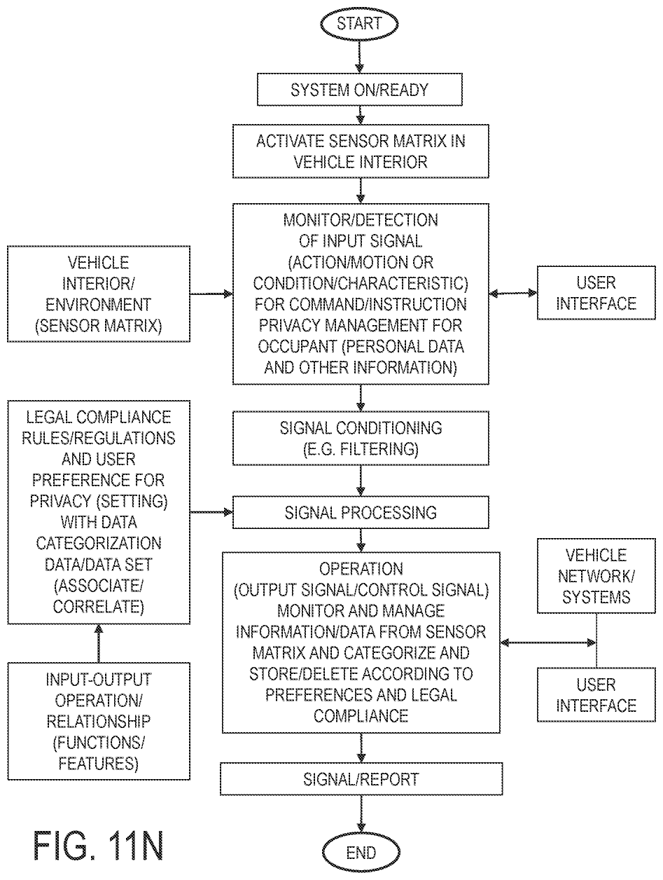

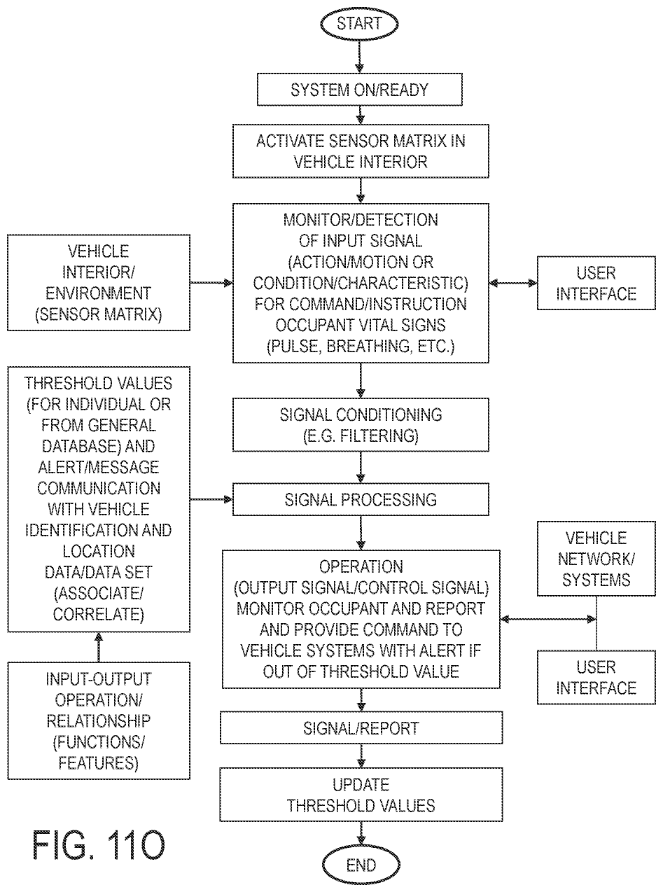

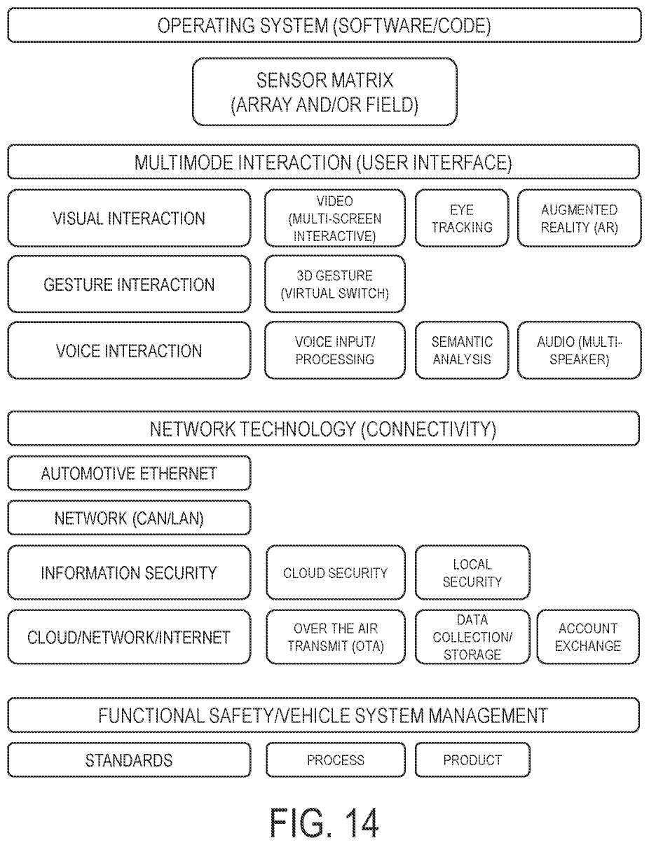

As indicated schematically in FIGS. 2A-2D, 3A-3T, 12, 13A-13H, the system may be configured to provide a sensor matrix comprising connectivity and an array of sensors such as sensors SN/SF, camera CM (e.g. for video/audio recording), accelerometer AC, odor/scent detector OD, microphone MR, ultraviolet sensor UV, location monitoring system/GPS, detection for objects/items OB, detection/connection with devices such as mobile device MD, connection with vehicle systems/instrumentation and data/sensors (e.g. with seating, HVAC, occupant monitoring, etc.), etc.; as indicated, the system may be configured for use with any of a wide range of sensors configured to provide input/input signals (such as data, etc.) from detection and monitoring of a wide range of parameters as indicated, including events/incidents and conditions (e.g. including ambient conditions temperature, date/time, location/GPS data, occupant data, etc.). See also FIGS. 4A-4B and 14. According to an exemplary embodiment as shown schematically in FIGS. 2A-2D, 3A-3T, 4A-4B, 5A-5B, 6A-6B, 7A-7B, 8A-8B, 9A-9B and 12, the sensor matrix may comprise sensors SN and a sensor/system SF configured to generate a field FL that can be used to obtain an input/input signal that can be used/calibrated to detect conditions within the interior of the vehicle (e.g. by variations in field/input signal calibrated to variations in conditions). See also FIGS. 10A-10F, 11A-11O, 12, 13A-13H and 14. As shown schematically in FIGS. 2A-2D, 3A-3T, 4A-4B, 12, 13A-13H and 14, the system may be configured to use a sensor matrix comprising sensors and/or sensor/field to obtain input/input signals relating to the use and operation of the vehicle, vehicle systems, occupants of the vehicle, objects and devices in the vehicle, etc.; the system may be configured to use input/input signals from the sensor matrix for interaction through instructions/operations and output/output signals with the vehicle/vehicle systems and/or vehicle occupants and/or objects and devices and/or over a network. See also FIGS. 10A-10F and 11A-11O.

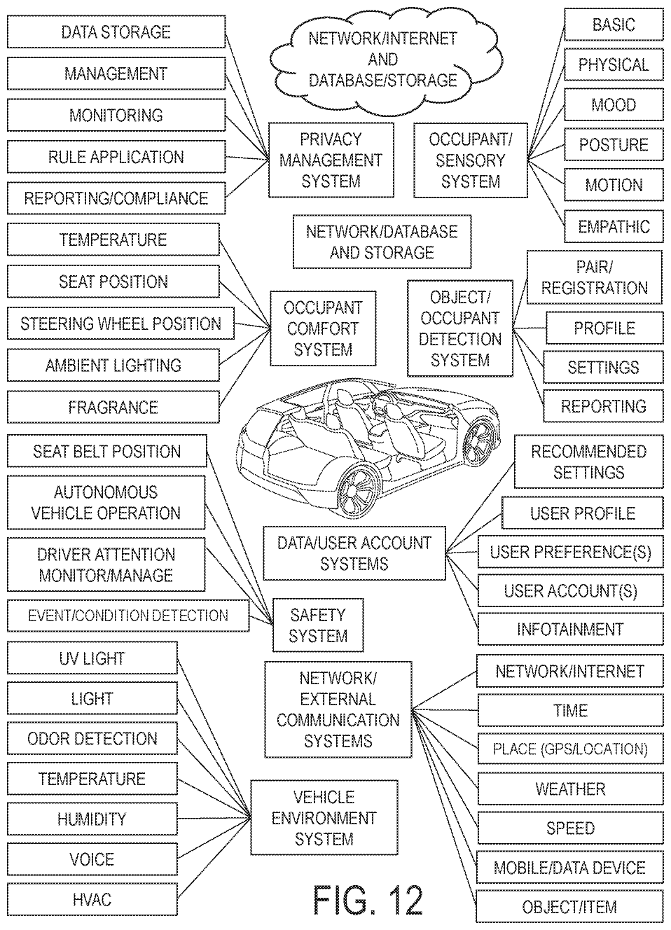

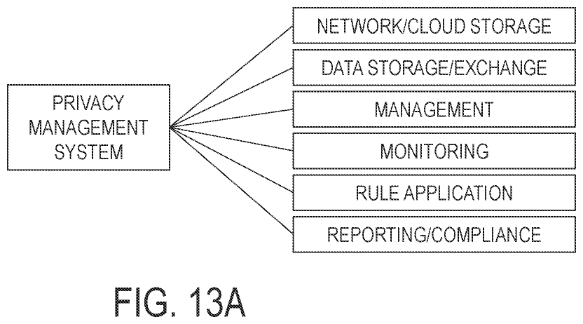

As indicated schematically in FIGS. 3A-3T, 4A-4B, 5A-5B, 6A-6B, 7A-7B, 8A-8B, 9A-9B, 10A-10F, 11A-11O, 12, 13 and 14, the system and method can be configured to use input/input signals (e.g. data, information, etc.) from the sensor matrix with processing with data/information (e.g. data sets, threshold values, etc.) to perform any of a wide variety of operations and to produce any of a wide variety of output/output signals for interaction with the vehicle occupant and/or vehicle and/or vehicle systems and/or network communications. Sec also TABLES A-1 and A-2. As indicated schematically in FIGS. 10A-10F, 11A-11O, 12 and 13A-13H, the system and method may process input/input signals from the sensor matrix (e.g. data from parameters, conditions, events, incidents, occupants, etc.) into instructions/commands for operations (e.g. operation of vehicle, interactions with occupants/systems, etc.) and for output/output signals (e.g. reports, alerts, communications, etc.) for occupants through a user interface and/or with networks and systems (including vehicle systems) and devices (including mobile devices); as indicated schematically in FIGS. 12, 13A-13H and 14, the system and method may comprise subsystems configured to provide functionality/perform operations on input/input signals from the sensor matrix relating to vehicle environment, network/external communications, safety systems, data/user accounts (for occupants, vehicle management, etc.), occupant detection, object detection, occupant comfort, occupant status/sensation, database/network storage, privacy/security and data management (as well as any other systems, including any other vehicle systems, etc.). See also TABLES A-1 and A-2 and FIGS. 4A-4B, 10A-10F and 11A-11O.

As indicated schematically in FIGS. 3A-3T, 4A-4B, 10A-10F, 11A-11O, 12, 13A-13H and 14, the system and method with sensor matrix may be configured to detect and interchange input/data of a variety of forms and types with the vehicle, vehicle systems, environment, interior of vehicle, vehicle components, vehicle occupants/others, network connectivity, etc. to perform any of a wide variety of operations relating to the experience (including comfort, safety, security, etc.) of the occupant/operator of the vehicle under any of a wide variety of conditions, events, incidents, etc. (e.g. in situations, circumstances, use cases, etc.) See also TABLES A-1 and A-2. As indicated schematically according to an exemplary embodiment in FIGS. 2A-2D, 3A-3T, 4A-4B, 5A-5B, 6A-6B, 7A-7B, 8A-8B, 9A-9B, 12, 13A-13H and 14, the user interface UI may be configured with an input device (e.g. switch, control, touch panel, touch control, gesture detections, microphone, audio receiver, etc.) and/or an output device (e.g. display, multi-display, speaker, multi-speaker, etc.) and/or haptic feedback and/or audio-visual input/output (e.g. display, projected display, multi-mode audio-visual, device connectivity, network communications, etc.). Sec also TABLES A-1 and A-2 and FIGS. 10A-10F and 11A-11O.

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H and 14, a system and method for use of a sensor matrix in a vehicle interior with use cases/applications may provide for an improved interaction with at least one vehicle occupant and/or with vehicle systems and/or with networks/communications. The system and method may provide a “smart cabin” environment with interactive connectivity to vehicle systems and/or networks for a vehicle occupant. The system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant. The system and method for use of a sensor matrix in a vehicle interior may be configured to provide for interactive connectivity to vehicle systems and/or networks in a wide variety of situations and/or use cases; the system and method for use of a sensor matrix in a vehicle interior may be configured to provide for interactive connectivity to vehicle systems and/or networks in a wide variety of situations and/or use cases to provide for needs of vehicle owners and/or occupants and/or passengers/riders. The system and method for use of a sensor matrix in a vehicle interior may be configured to provide for interactive connectivity to vehicle systems and/or networks in a wide variety of situations and/or use cases/applications for vehicles such as personal vehicles or commercial vehicles or autonomous vehicles. The system and method for use of a sensor matrix in a vehicle interior may be configured to provide for interactive connectivity to vehicle systems and/or a user interface (e.g. in-vehicle interface, mobile device, remote, other device, etc.) and/or networks/systems (e.g. communications, data, internet, databases/storage, cloud/remote storage, etc.); the system and method for use of a sensor matrix in a vehicle interior may be configured to provide for interactive connectivity to vehicle systems and/or a user interface/device and/or networks/systems in a wide variety of situations and/or use cases/applications for vehicles such as personal vehicles or commercial vehicles or autonomous vehicles.

### Exemplary Embodiments—B

As indicated schematically according to an exemplary embodiment in FIGS. 2A-2D, 3A-3T, 4A-4B, 5A-5B, 6A-6B, 7A-7B, 8A-8B, 9A-9B, 12, 13A-13H and 14, a system for using a sensor (e.g. sensor array, sensor matrix, etc.) configured to obtain an input signal in an interior of a vehicle comprising a vehicle system and providing a user interface configured for interaction with an occupant may comprise a processor configured to process an input signal from the sensor to facilitate an operation and to provide an output signal; the output signal may be sent to at least one of (a) the vehicle system and/or (b) the user interface. See also FIGS. 10A-10F and 11A-11O.

As indicated schematically according to an exemplary embodiment in FIGS. 2A-2D, 3A-3T, 4A-4B, 10A-10F, 11A-11O and 12, the input signal may comprise at least one of (a) proximity, (b) action, (c) motion, (d) sound; (c) condition, (f) characteristic, (g) presence/absence of occupant, (h) position of occupant, (i) interaction with occupant, (j) detected input from occupant, (k) directed input from occupant, (l) detected event, (m) detected condition, (n) vehicle interior control/activity, (o) smart cabin control/activity. See also TABLES A-1 and A-2 and FIGS. 5A-5B, 6A-6B, 7A-7B, 8A-8B, 9A-9B, 13A-13H and 14.

As indicated schematically according to an exemplary embodiment in FIGS. 2A-2D, 3A-3T, 4A-4B, 10A-10F, 11A-11O and 12, the operation may comprise at least one of (a) operation of vehicle system, (b) network communication, (c) instruction for vehicle system, (d) operation of vehicle systems, (e) interaction with external systems, (f) data storage, (g) data analytics/analysis, (h) comparison of data to threshold values, (i) monitoring; (j) providing a report based on the input signal, (k) vehicle interior control, (l) smart cabin control, (m) smart cabin activity. See also TABLES A-1 and A-2 and FIGS. 5A-5B, 6A-6B, 7A-7B, 8A-8B, 9A-9B, 13A-13H and 14.

As indicated schematically according to an exemplary embodiment in FIGS. 2A-2D, 3A-3T, 4A-4B, 10A-10F, 11A-11O and 12, the output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system, (j) data transmission, (k) data storage, (l) vehicle location, (m) vehicle status, (n) occupant status, (o) communication over a network, (p) report over a network. See also TABLES A-1 and A-2 and FIGS. 5A-5B, 6A-6B, 7A-7B, 8A-8B, 9A-9B, 13A-13H and 14.

As indicated schematically according to an exemplary embodiment in FIGS. 2A-2D, 3A-3T, 4A-4B, 5A-5B, 6A-6B, 7A-7B, 8A-8B and 9A-9B, the sensor may comprise a sensor array; the sensor may comprise a sensor matrix; the sensor may comprise at least one sensor; the sensor may comprise at least one of (a) a transducer; (b) a capacitive sensor; (c) an odor detector; (d) an accelerometer; (c) a microphone; (f) a camera; (g) a light detector; (h) an ultraviolet light detector; (i) a thermal detector; (j) an RFID detector; (k) a tag detector. The at least one sensor may comprise at least one of (a) a sensor array; (b) a sensor matrix; (c) a multi-function sensor; (d) a composite sensor; (e) an audio-visual sensor; (f) a video recorder; (g) an audio recorder; (h) a thermal sensor; (i) a bio-metric sensor. See also TABLES A-1 and A-2 and FIGS. 10A-10F, 11A-11O, 12, 13A-13H and 14.

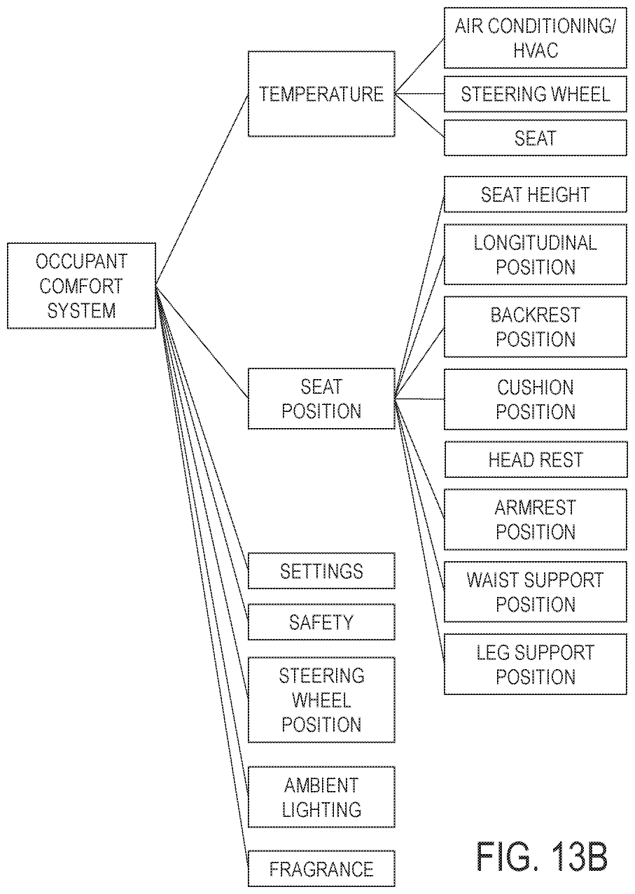

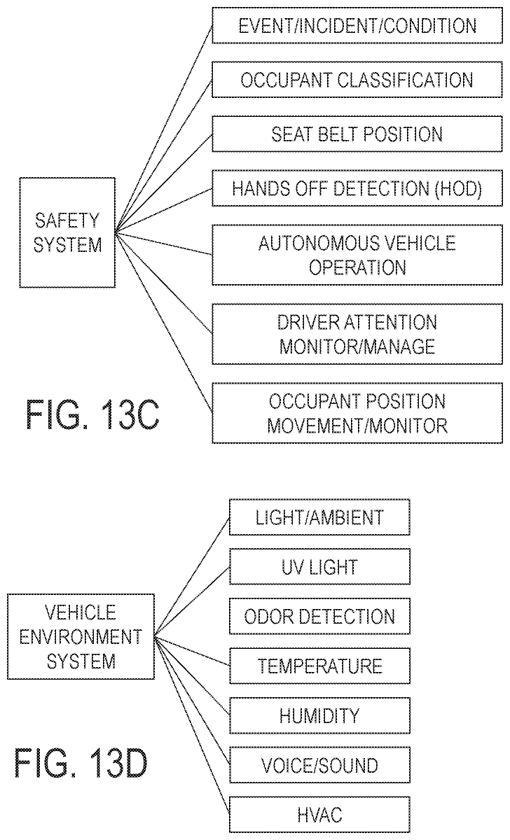

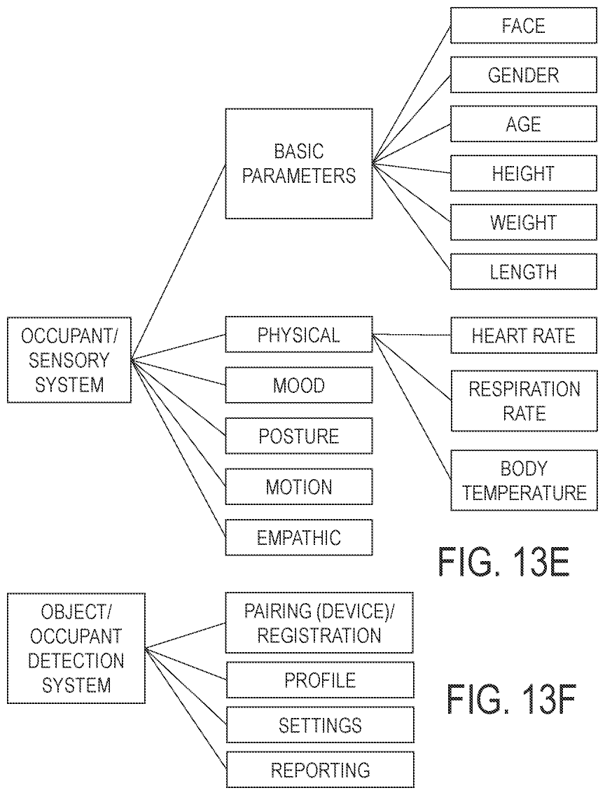

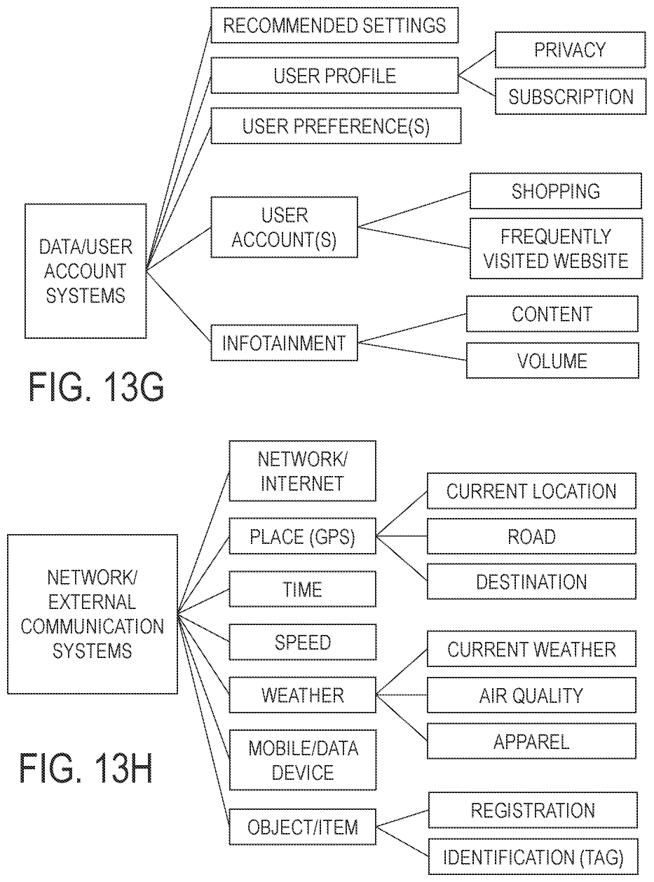

As indicated schematically according to an exemplary embodiment in FIGS. 2A-2D, 3A-3T, 4A-4B, 5A-5B, 6A-6B, 7A-7B, 8A-8B, 9A-9B and 14, the sensor may comprise a sensor matrix; the sensor matrix may comprise a field; the sensor matrix may comprise multiple sensors; the sensor matrix may comprise multiple fields; the sensor matrix may comprise a field and at least one sensor. The input signal from the sensor matrix may comprise a signal detected (a) by a sensor and/or (b) from within a field. The field may be provided in the interior of the vehicle. As indicated schematically according to an exemplary embodiment in FIGS. 2A-2D, 3A-3T, 4A-4B, 5A-5B, 6A-6B, 7A-7B, 8A-8B, 9A-9B and 14, the sensor matrix may be installed and/or operated with a vehicle interior component and configured to operate with vehicle systems. See also FIGS. 12 and 13A-13H.

As indicated schematically according to an exemplary embodiment in FIGS. 3A-3T and 14, the user interface may comprise an input device and an output device. The input device may comprise a control for the occupant. The input device may comprise a virtual switch; the virtual switch may be configured to be operated by at least one of (a) gesture detection and/or (b) movement by the occupant. The output device may comprise a display. The user interface may be configured to obtain the input signal. The user interface may be configured to present the output signal. The user interface may comprise at least one of (a) a display; (b) an audio system; (c) an audio-visual system; (d) an infotainment system. The user interface may comprise a haptic interface.

As indicated schematically according to an exemplary embodiment in FIGS. 1, 2A-2D and 14, the vehicle may comprise an autonomous vehicle; the vehicle may comprise a fleet vehicle; the vehicle may comprise a passenger vehicle; the vehicle may comprise a commercial vehicle; the vehicle may comprise a work vehicle. As indicated schematically according to an exemplary embodiment in FIGS. 2A-2D, 3A-3T, 4A-4B, 5A-5B, 6A-6B, 7A-7B, 8A-8B, 9A-9B and 14, the sensor may comprise a sensor matrix configured to obtain an input signal from within the vehicle interior. As indicated schematically according to an exemplary embodiment in FIGS. 2A-2D and 3A-3T, the vehicle may comprise a vehicle interior component; the component may comprise at least one of (a) a trim panel; (b) an instrument panel; (c) a door panel; (d) a console; (e) a floor console; (f) an overhead console: (g) an overhead system; (h) a seat; (i) a steering wheel; (j) a door pillar. As indicated schematically according to an exemplary embodiment in FIGS. 2A-2D, 3A-3T, 4A-4B, 12, 13A-13H and 14, the vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. See also TABLES A-1 and A-2.

According to an exemplary embodiment as shown schematically in FIGS. 2A-2D, 4A-4B, 10A-10F, 11A-11O, 12, 13E and 14, the input signal may comprise vital signs of the occupant; the operation may comprise operation of a vehicle system; the output signal may comprise a report; the operation may comprise operation of the vehicle and the output signal may comprise an alert signal; the alert signal may comprise an emergency communication; the operation may comprise taking autonomous control of the vehicle; the operation may comprise parking the vehicle; the emergency communication may comprise vital signs of the occupant; the report may comprise vehicle location; the input signal may comprise detection of an event in the vehicle; the operation may comprise determination of the event and the output signal may comprise a report; the event may comprise a potential medical concern for the occupant; the potential medical concern may be an illness of the occupant; the operation may comprise taking autonomous control of the vehicle; the operation may comprise taking autonomous control of the vehicle; the operation may comprise remediation of the event for the vehicle; remediation of the event for the vehicle may comprise sanitizing the vehicle; the report may comprise a communication of vehicle location. See also TABLES A-1 and A-2.

As indicated schematically according to an exemplary embodiment in FIGS. 2A-2D, 4A-4B, 10A-10F, 11A-11O, 12, 13C, 13E, 13F, and 14, the input signal may comprise incapacitation of the occupant; the operation may comprise determination of the condition and the output signal may comprise a report relating to the condition; the incapacitation may be of the operator of the vehicle; and the operation may comprise taking control of the vehicle; the report may comprise an emergency communication; the output signal may comprise activating an emergency signal for the vehicle; the report may comprise the location of the vehicle; the input signal may be based on a physical parameter of the occupant; the operation may comprise comparison of the physical parameter of the occupant based on a threshold value for the physical parameter. See also TABLES A-1 and A-2.

As indicated schematically according to an exemplary embodiment in FIGS. 2A-2D, 3Q-3R, 4A-4B, 10A-10F, 11A-11O, 12, 13H and 14, the input signal may comprise detection relating to a status of an item/object; the operation may comprise determination of the status of the item and the output signal may comprise a report based on the status of the item; the input signal may comprise the status of the item; the status of the item may comprise either (a) detected or (b) not detected. If the status of the item is not detected the operation may comprise monitoring for the item and the report may comprise an alert that the item is not detected; if the status of the item is detected the report may comprise a communication to a contact point; the contact point may be in communication over a network; the report may comprise an electronic message; the input signal may be based on a tag associated with the item; the tag may comprise an RFID tag (e.g. for registration, identification, etc.). See also TABLES A-1 and A-2.

As indicated schematically according to an exemplary embodiment in FIGS. 2A-2D, 4A-4B, 10A-10F, 11A-11O, 12, 13C and 14, the input signal may comprise detection of an incident and the operation may comprise determination of the incident and the output signal may comprise a report on the incident; the incident may comprise a vehicle collision; the operation may comprise monitoring of the status of the vehicle occupant; the report may comprise a communication with emergency responders; the input signal may comprise data relating to the incident; the operation may comprise analysis of the incident; the report may comprise data relating to the incident; the report may comprise analysis of the incident.

As indicated schematically according to an exemplary embodiment in FIGS. 2A-2D, 4A-4B, 10A-10F, 11A-11O, 12, 13C and 14, the input signal may comprise detection of tampering with the vehicle; the operation may comprise verification of tampering with the vehicle and the output signal may comprise a report relating to tampering with the vehicle; the report may be a communication to law enforcement agency; the input signal may comprise a video recording of the tampering; the report may comprise the video recording of the tampering; the operation may comprise determination of damage to the vehicle; the report may comprise determination of damage to the vehicle. See also TABLES A-1 and A-2.

As indicated schematically according to an exemplary embodiment in FIGS. 2A-2D, 4A-4B, 10A-10F, 11A-11O, 12, 13C and 14, the input signal may comprise detection of attention of an operator of the vehicle; the operation may comprise assessment of attention of the operator and the output signal may comprise a report based on attention of the operator. If the attention of the operator is below a threshold value the report may comprise an alert; the threshold value may comprise an awaken state; the threshold value may comprise a distracted state; the report may comprise a signal at the user interface as an alert to the operator; the operation may comprise haptic feedback for the operator; the output signal may comprise a sound at the user interface. See also TABLES A-1 and A-2.

As indicated schematically according to an exemplary embodiment in FIGS. 2A-2D, 4A-4B, 10A-10F, 11A-11O, 12, 13C and 14, the input signal may comprise detection of a potential hazard; the operation may comprise determination of the potential hazard and the output signal may comprise a report relating to the potential hazard. The operation may comprise determination of status of the occupant; the report may comprise status of the occupant. Determination of the potential hazard may comprise classification of the potential hazard. Determination of the potential hazard may comprise a traffic-related hazard and the report may comprise a warning. See also TABLES A-1 and A-2.

As indicated schematically according to an exemplary embodiment in FIGS. F2A-2D, 4A-4B, 10A-10F, 11A-11O, 12, 13C and 14, the input signal may comprise detection of a vehicle condition; the operation may comprise determination of the vehicle condition and the output signal may comprise a report relating to the vehicle condition; the vehicle condition may be reported to the occupant of the vehicle; the user interface may comprise a gesture-operated interface for the occupant; the vehicle condition may relate to status of a safety system of the vehicle reported to the occupant. See also TABLES A-1 and A-2.

As indicated schematically according to an exemplary embodiment in FIGS. 2A-2D, 4A-4B, 10A-10F, 11A-11O, 12, 13C and 14, the input signal may comprise detection of a vehicle condition; the operation may comprise determination of the vehicle condition and the output signal may comprise a report relating to the vehicle condition; the vehicle condition may comprise autonomous operation of the vehicle; the input signal may comprise detection of readiness of an occupant to operate the vehicle. Readiness may comprise status of the occupant. Status may comprise position of the occupant; the report may comprise an alert to the occupant; the alert may comprise a communication to take control of the vehicle. See also TABLES A-1 and A-2.

As indicated schematically according to an exemplary embodiment in FIGS. 2A-2D, 3A-3T, 4A-4B, 10A-10F, 11A-11O, 12, 13A-13H and 14, a method for using a sensor matrix in an interior of a vehicle comprising a vehicle system and providing a user interface configured for interaction with an occupant may comprise the steps of obtaining an input signal from the sensor matrix, processing the input signal into an output signal, and performing an operation relating to the input signal. The input signal may comprise at least one of (a) proximity, (b) action, (c) motion, (d) sound, (c) condition, (f) characteristic, (g) presence/absence of occupant, (h) position of occupant, (i) interaction with occupant, (j) detected input from occupant, (k) directed input from occupant, (l) detected event, (m) detected condition, (n) vehicle interior control/activity, (o) smart cabin control/activity. The operation may comprise at least one of (a) operation of vehicle system, (b) network communication, (c) instruction for vehicle system, (d) operation of vehicle systems, (c) interaction with external systems, (f) data storage, (g) data analytics/analysis, (h) comparison of data to threshold values, (i) monitoring, (j) providing a report based on the input signal, (k) vehicle interior control, (l) smart cabin control, (m) smart cabin activity. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system, (j) data transmission, (k) data storage, (l) vehicle location, (m) vehicle status, (n) occupant status, (o) communication over a network, (p) report over a network. See also FIGS. 12 and TABLES A-1 and A-2.

As indicated schematically according to an exemplary embodiment in FIGS. 2A-2D, 3A-3T, 4A-4B, 10A-10F, 11A-11O, 12, 13A-13H and 14, the method may comprise the step of performing an operation based on the output signal; the step of performing an operation relating to the input signal may comprise performing an operation based on the output signal; the step of processing the input signal into an output signal may comprise use of a database; the step of performing an operation may comprise providing a communication; the communication may comprise a report based on the input signal; the output signal may comprise the report. See also FIGS. 5A-5B, 6A-6B, 7A-7B, 8A-8B and 9A-9B.

As indicated schematically according to an exemplary embodiment in FIGS. 2A-2D, 3A-3T, 4A-4B, 10A-10F, 11A-11O, 12, 13A-13H and 14, the system comprising the sensor matrix may be provided in the interior of the vehicle. The method may comprise the step of activating a field for the sensor matrix. The method may comprise the step of actuating a field for the sensor matrix. The step of obtaining an input signal may comprise detecting the input signal. The input signal may comprise a signal representative of at least one of (a) motion by the occupant; (b) action by the occupant; (c) a condition in the interior; (d) a condition of the occupant; (c) a characteristic of the occupant. See also TABLES A-1 and A-2.

As indicated schematically according to an exemplary embodiment in FIGS. 10A-10F and 11A-11O, the method may comprise the step of conditioning the input signal. The step of conditioning the input signal may comprise filtering the input signal. Filtering the input signal may comprise at least one of (a) separating noise and/or (b) calibration. The step of processing the input signal may comprise calibration. The step of performing an operation may comprise performing an operation at the vehicle system. The method may comprise the step of providing an output at the user interface based on the output signal. The method may comprise the step of interaction at the user interface.

As indicated schematically according to an exemplary embodiment in FIGS. 2A-2D, 3A-3T, 4A-4B, 5A-5B, 6A-6B, 7A-7B, 8A-8B, 9A-9B, 12, 13A-13H and 14, the sensor matrix may comprise a sensor; the sensor matrix may comprise at least one sensor; the at least one sensor may comprise at least one of (a) a transducer; (b) a capacitive sensor; (c) an odor detector; (d) an accelerometer; (e) a microphone; (f) a camera; (g) a light detector; (h) an ultraviolet light detector; (i) a thermal detector; (j) RFID detector; (k) tag detector; the at least one sensor may comprise at least one of (a) a sensor array; (b) a sensor matrix; (c) a multi-function sensor; (d) a composite sensor; (e) an audio-visual sensor; (f) a video recorder; (g) an audio recorder; (h) a thermal sensor; (i) a bio-metric sensor; the sensor matrix may comprise a field; the sensor matrix may comprise multiple sensors; the sensor matrix may comprise multiple fields; the sensor matrix may comprise a field and at least one sensor; the input signal from the sensor matrix may comprise a signal detected (a) by a sensor and/or (b) from within a field. Obtaining the input signal from the sensor matrix may comprise detecting (a) by a sensor and/or (b) from within a field. The method may comprise the step of providing a field in the interior of the vehicle. The step of providing the field may be performed by the sensor matrix. See also FIGS. 3A-3T and 4A-4B.

As indicated schematically according to an exemplary embodiment in FIGS. 2A-2D, 3A-3T, 4A-4B, 5A-5B, 6A-6B, 7A-7B, 8A-8B and 9A-9B, the user interface may comprise at least one of (a) a display; (b) an audio system; (c) an audio-visual system; (d) an infotainment system.

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the step of processing the input signal may be performed on a processor. The processor may be operated by a control program. The step of processing the input signal may be performed by a control program. The step of processing the input signal may be performed on a controller. The vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system.

As indicated schematically according to an exemplary embodiment in FIGS. 4A-4B, 5A-5B, 6A-6B, 7A-7B, 8A-8B, 9A-9B, 10A-10F, 11A-11O, 12, 13A-13H and 14, the method may comprise the step of communication of an output based on the output signal to a network. The network may comprise a telecommunication network; the network may comprise access through a mobile device; the output may comprise a telecommunication signal; the telecommunication signal may comprise an emergency signal; the output may comprise a network communication. See also TABLES A-1 and A-2.

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the system and method may be configured to obtain and process an input signal (e.g. from the vehicle, occupant and/or environment) from a sensor/sensor matrix to perform an operation (e.g. with/for a vehicle system, vehicle operation, etc.) and to provide an output signal (e.g. for a vehicle system, network/communication, user interface, etc.). See also TABLES A-1 and A-2. The input signal may comprise incapacitation of the occupant. The operation may comprise determination of the condition and the output signal may comprise a report relating to the condition. The incapacitation may be of the operator of the vehicle and the operation may comprise taking control of the vehicle. The input signal may comprise detection relating to a status of an item. The operation may comprise determination of the status of the item and the output signal may comprise a report based on the status of the item. The input signal may comprise the status of the item; the status of the item may comprise either (a) detected or (b) not detected. If the status of the item is not detected the operation may comprise monitoring for the item and the report may comprise an alert that the item is not detected. The input signal may comprise detection of an incident. The operation may comprise determination of the incident and the output signal may comprise a report on the incident. The incident may comprise a vehicle collision. The input signal may comprise detection of tampering with the vehicle. The operation may comprise verification of tampering with the vehicle and the output signal may comprise a report relating to tampering with the vehicle. The operation may comprise determination of damage to the vehicle. The report may comprise determination of damage to the vehicle. The input signal may comprise detection of attention of an operator of the vehicle. The operation may comprise assessment of attention of the operator and the output signal may comprise a report based on attention of the operator. If the attention of the operator is below a threshold value the report may comprise an alert. The threshold value may comprise an awaken state. The threshold value may comprise a distracted state. The output signal may comprise a sound at the user interface. The input signal may comprise detection of a potential hazard. The operation may comprise determination of the potential hazard and the output signal may comprise a report relating to the potential hazard. The operation may comprise determination of status of the occupant; the report may comprise status of the occupant. The input signal may comprise detection of a vehicle condition. The operation may comprise determination of the vehicle condition and the output signal may comprise a report relating to the vehicle condition.

### Exemplary Embodiments—C

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H and 14, an improved system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant. See also TABLES A-1 and A-2. The system and method for use of a sensor matrix in a vehicle interior may be configured to provide for interactive connectivity to vehicle systems and/or networks in a wide variety of situations and/or use cases; the system and method for use of a sensor matrix in a vehicle interior may be configured to provide for interactive connectivity to vehicle systems and/or networks in a wide variety of situations and/or use cases to provide for needs of vehicle owners and/or occupants and/or passengers/riders. The system and method for use of a sensor matrix in a vehicle interior may be configured to provide for interactive connectivity to vehicle systems and/or a user interface (e.g. in-vehicle interface, mobile device, remote, other device, etc.) and/or networks/systems (e.g. communications, data, internet, databases/storage, cloud/remote storage, etc.); the system and method for use of a sensor matrix in a vehicle interior may be configured to provide for interactive connectivity to vehicle systems and/or a user interface/device and/or networks/systems in a wide variety of situations and/or use cases/applications for vehicles such as personal vehicles or commercial vehicles or autonomous vehicles.

According to an exemplary embodiment as shown schematically in FIGS. 2A-2D, 3A-3T, 4A-4B, 5A-5B, 6A-6B, 7A-7B, 8A-8B, 9A-9B, 12, 13A-13H and 14, a system for using a sensor matrix in an interior of a vehicle comprising a vehicle system and providing a user interface configured for interaction with an occupant may comprise (a) the sensor matrix configured to obtain an input signal from within the vehicle interior and (b) a processor configured to process the input signal and to provide an output signal. The output signal may be sent to at least one of (a) the vehicle system and/or (b) the user interface. The input signal may comprise at least one of (a) proximity, (b) action, (c) motion, (d) condition, (e) characteristic, (f) presence/absence of occupant, (g) position, (h) interaction with occupant, (i) detected input from occupant, (j) directed input from occupant, (k) vehicle interior control/activity, (l) smart cabin control/activity. The operation may comprise at least one of (a) operation of vehicle system, (b) network communication, (c) instruction for vehicle system, (d) operation of vehicle systems, (c) interaction with external systems, (f) data storage, (g) data analytics/analysis, (h) smart cabin control. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system, (j) data transmission, (k) data storage. The sensor matrix may comprise at least one sensor. The sensor may comprise at least one of (a) a transducer; (b) a capacitive sensor; (c) an odor detector; (d) an accelerometer; (c) a microphone; (f) a camera; (g) a light detector; (h) an ultraviolet light detector. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. The field may be provided in the interior of the vehicle. The sensor matrix may be installed and/or operated with a vehicle interior component. The vehicle interior component may comprise at least one of (a) a trim panel; (b) an instrument panel; (c) a door panel; (d) a console; (e) a floor console; (f) an overhead console; (g) an overhead system; (h) a seat; (i) a steering wheel. The user interface may comprise at least one of (a) a display; (b) an audio system; (c) an audio-visual system; (d) an infotainment system. The user interface may comprise a haptic interface. The processor may be operated by a control program. The control program may comprise a software program. The vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system; (w) a location/navigation system; (x) a system for mobile device interactivity/connectivity. See also TABLES A-1 and A-2 and FIGS. 12 and 14.

According to an exemplary embodiment as shown schematically in FIGS. 3A-3T, 4A-4B, 10A-10F, 11A-11O, 12 and 13A-13H, a method for using a sensor matrix in an interior of a vehicle comprising a vehicle system and providing a user interface configured for interaction with an occupant may comprise the steps of obtaining an input signal from the sensor matrix, processing the input signal into an output signal and performing an operation based on the output signal. See also TABLES A-1 and A-2. The input signal may comprise at least one of (a) proximity, (b) action, (c) motion, (d) condition, (e) characteristic, (f) presence/absence of occupant, (g) position, (h) interaction with occupant, (i) detected input from occupant, (j) directed input from occupant, (k) vehicle interior control/activity, (l) smart cabin control/activity, (m) location, (n) environmental conditions. The operation may comprise at least one of (a) operation of vehicle system, (b) network communication, (c) instruction for vehicle system, (d) operation of vehicle systems, (e) interaction with external systems, (f) data storage, (g) data analytics/analysis, (h) smart cabin control. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system; (j) data transmission, (k) data storage. A system comprising the sensor matrix may be provided in the interior of the vehicle. The method may comprise the step of actuating a field for the sensor matrix. The step of obtaining an input signal may comprise detecting the input signal. The input signal may comprise a signal representative of at least one of (a) motion by the occupant; (b) action by the occupant; (c) a condition in the interior; (d) a condition of the occupant; (c) a characteristic of the occupant; (f) location of the vehicle; (g) status of the vehicle. The method may comprise the step of conditioning the input signal. The step of conditioning the input signal may comprise filtering the input signal; filtering the input signal may comprise at least one of (a) separating noise and/or (b) calibration. The step of processing the input signal may comprise calibration. The step of performing an operation may comprise performing an operation at the vehicle system. The system and method may further comprise the step of providing an output at the user interface based on the output signal. The system and method may further comprise the step of interaction at the user interface. The sensor matrix may comprise at least one sensor. The sensor may comprise at least one of (a) a transducer; (b) a capacitive sensor; (c) an odor detector; (d) an accelerometer; (e) a microphone; (f) a camera; (g) a light detector; (h) an ultraviolet light detector; (i) a GPS system; (j) a mobile device/interactivity. The sensor matrix may comprise a field. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. Obtaining the input signal from the sensor matrix may comprise detecting (a) by a sensor and/or (b) from within a field. The method may comprise the step of providing a field in the interior of the vehicle. The step of providing the field may be performed by the sensor matrix. The user interface may comprise at least one of (a) a display; (b) an audio system; (c) an audio-visual system; (d) an infotainment system. The step of processing the input signal may be performed on a processor. The processor may be operated by a control program. The step of processing the input signal may be performed by a control program. The step of processing the input signal may be performed on a controller. The vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The method may comprise the step of communication of an output based on the output signal to a network. The network may comprise a telecommunication network. The network may comprise access through a mobile device. The output may comprise a telecommunication signal. The telecommunication signal may comprise an emergency signal.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the system and method may provide for an improved interaction with at least one vehicle occupant and/or with vehicle systems and/or with networks/communications. The system and method for use of a sensor matrix in a vehicle interior may be configured to provide for interactive connectivity to vehicle systems and/or a user interface (e.g. in-vehicle interface, mobile device, remote, other device, etc.) and/or networks/systems (e.g. communications, data, internet, databases/storage, cloud/remote storage, etc.); the system and method for use of a sensor matrix in a vehicle interior may be configured to provide for interactive connectivity to vehicle systems and/or a user interface/device and/or networks/systems in a wide variety of situations and/or use cases/applications for vehicles such as personal vehicles or commercial vehicles or autonomous vehicles.

According to an exemplary embodiment as shown schematically in FIGS. 2A-2D, 3A-3T, 4A-4B, 10A-10F, 11A-11O, 12, 13A-13H and 14, the system and method may provide for an improved interaction with at least one vehicle occupant and/or with devices/objects and/or with vehicle systems and/or with networks/communications. The system and method may provide a “smart cabin” environment with interactive connectivity to vehicle systems and/or devices/objects and/or networks for a vehicle occupant; a user interface may be provided in the vehicle interior and/or by a device or over a network. The system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant. The system and method for use of a sensor matrix in a vehicle interior may be configured to provide for interactive connectivity to vehicle systems and/or networks in a wide variety of situations and/or use cases; the system and method for use of a sensor matrix in a vehicle interior may be configured to provide for interactive connectivity to vehicle systems and/or networks in a wide variety of situations and/or use cases to provide for needs of vehicle owners and/or occupants and/or passengers/riders. The system and method for use of a sensor matrix in a vehicle interior may be configured to provide for interactive connectivity to vehicle systems and/or networks and/or devices in a wide variety of situations and/or use cases/applications for vehicles such as personal vehicles or commercial vehicles or autonomous vehicles. The system and method for use of a sensor matrix in a vehicle interior may be configured to provide for interactive connectivity to vehicle systems and/or a user interface (e.g. in-vehicle interface, mobile device, remote, other device, etc.) and/or networks/systems (e.g. communications, data, internet, databases/storage, cloud/remote storage, etc.); the system and method for use of a sensor matrix in a vehicle interior may be configured to provide for interactive connectivity to vehicle systems and/or a user interface/device and/or networks/systems in a wide variety of situations and/or use cases/applications for vehicles such as personal vehicles or commercial vehicles or autonomous vehicles.

### Exemplary Embodiments—D (Use Cases)

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the system and method may be configured to provide use of a sensor matrix in a vehicle interior. See also TABLES A-1 and A-2.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the system and method comprising use of a sensor in a vehicle interior configured for interaction with at least one vehicle occupant and/or vehicle system may comprise a user interface and a processor configured to process an input signal from the sensor to facilitate an operation and to provide an output signal. The system may provide interactive connectivity for a vehicle occupant to vehicle systems and/or networks in a wide variety of situations such as events, incidents, conditions, etc. The input signal may comprise a detected event, incident, condition, object, occupant, etc. The operation may comprise operation of vehicle system and/or network communication and/or data analytics/analysis. The output signal may comprise an output at a user interface such as a report/alert and/or to a vehicle system and/or a network communication. The sensor may comprise a sensor array and/or a sensor matrix. The sensor matrix may provide a sensor field for detection. The system with sensor/matrix may be configured for use/operation as a component for an interior of vehicles such as personal vehicles or commercial vehicles or autonomous vehicles.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H and 14, the system and method may comprise use of a sensor matrix in a vehicle interior with interaction with at least one vehicle occupant. The system and method may comprise use of a sensor matrix in a vehicle interior to create a “smart cabin” environment with interactive connectivity to vehicle systems and/or networks for a vehicle occupant. The system and method may comprise use of a sensor matrix in a vehicle interior to provide for interactive connectivity to vehicle systems and/or networks in a wide variety of situations and/or use cases. The system and method may comprise use of a sensor matrix in a vehicle interior to provide for interactive connectivity to vehicle systems and/or networks in a wide variety of situations and/or use cases to provide for needs of vehicle owners and/or occupants and/or passengers/riders. The system and method may comprise use of a sensor matrix in a vehicle interior to provide for interactive connectivity to vehicle systems and/or networks in a wide variety of situations and/or use cases for vehicles such as personal vehicles or commercial vehicles or autonomous vehicles. See also TABLES A-1 and A-2 and FIGS. 12, 13A-13H and 14.

According to an exemplary embodiment as shown schematically in FIGS. 3A-3T, 4A-4B, 10A-10F, 11A-11O, 12, 13A-13H and 14, the system and method in implementation/use and operation may comprise input-operation-output configured by control program based on vehicle system/database and/or user setting/preference and/or network/storage/data to/through vehicle system and/or user interface and/or communication/network. See also TABLES A-1 and A-2.

### Occupant Monitoring—A

Input/signal (sensor matrix)—Signal from ongoing monitoring/detection by sensor matrix of occupant health/vital signs (e.g. heart rate/rhythm, respiration rate, oxygenation, blood pressure, etc.); sensor matrix may obtain additional information; information (such as also from vehicle systems) may include GPS/location information as well as routing.

Operation (vehicle systems/network)—Comparison of signal with threshold values (individual, personalized for occupant, aggregated, etc.); inquiry with occupant if abnormal/dangerous level indicated; interact with occupant and/or provide command to vehicle systems (e.g. actuate autonomous operation of vehicle, direct vehicle to safe location/side of road, assume braking/steering, etc.); provide alert output signal.

Output/signal (network/user interface)—Signal providing report of vital signs; report of status of vehicle systems; vehicle route and/or location; identification of occupant/vehicle; signal communicating alert to contacts/family members and to emergency responders, police, dispatchers, third-party services, etc. according to protocol.

### Occupant Monitoring—B

Input/signal (sensor matrix)—Signal from vehicle interior indicating abnormal/unusual condition or event such as physical illness (e.g. vomiting, incontinence, etc.). Detection by sensor matrix (individual or aggregate sensor/signal) such as odor, visual/camera, sound, moisture, etc.) (e.g. detecting/observing physical effect and/or bio-effect such as detecting/smelling the vomit chemistry/smell).

Operation (vehicle systems/network)—Comparison of signal with threshold values; inquiry with occupant if abnormal/dangerous level indicated; interact with occupant and/or provide command to vehicle systems (e.g. actuate autonomous operation of vehicle, direct vehicle to safe location/side of road, assume braking/steering, etc.); provide alert output signal; if an autonomous/taxi vehicle, remove from service for cleaning/sanitizing (e.g. at service center/location). Allocation of cost for service/cleaning to occupant/responsible party.

Output/signal (network/user interface)—Signal providing report of vital signs; report of status of vehicle systems; vehicle route and/or location; signal communicating alert to contacts/family members and to emergency responders, police, dispatchers, third-party services, etc. according to protocol.

### Occupant Monitoring—C

Input/signal (sensor matrix)—Signal from vehicle interior indicating child or pet within vehicle and/or person in distress/incapacitated (e.g. by health, medication, intoxication, other condition, etc.) in vehicle (abnormal condition). Detection by sensor matrix (individual or aggregate sensor/signal) such as visual/camera, sound, moisture, odor, etc.) (e.g. detecting/observing physical effect and/or bio-effect).

Operation (vehicle systems/network)—Comparison of signal with threshold values; inquiry with occupant if abnormal/dangerous condition indicated; interact with occupant and/or provide command to vehicle systems (e.g. actuate autonomous operation of vehicle, direct vehicle to safe location, control ventilation/temperature for occupants, including fresh air and thermal management). Coordination with time of day/day of week and/or schedule information for calibration and screening of situation for reporting and commands to vehicle systems.

Output/signal (network/user interface)—Signal providing report of vital signs; report of status of vehicle systems; vehicle route and/or location; signal communicating alert to contacts/family members and to emergency responders, police, dispatchers, third-party services, etc. according to protocol; specific output signal to report detail of situation (child, pet, incapacitated person, etc.). Report if child or pet/dog left behind (monitoring of system, seating, interior, etc.), including contact person/authority (e.g. by telephone/call, text, e-mail, messaging, etc.). Driver may be notified and if no response then emergency services are notified. Alarm/alert from vehicle such as light-flash and audible/horn on exterior of vehicle after alert to operator/owner.

### Object/Item Detection

Input/signal (sensor matrix)—Signal from vehicle interior indicating item left in vehicle. Detection of item/object by sensor matrix (including potential interaction with item and/or mobile device, RFID tag, other sensor/tag on item, etc.); object/item may be registered/paired with system for identification by sensor matrix.

Operation (vehicle systems/network)—Vehicle system may provide an alert to driver/occupant at moment of exiting vehicle (audible signal, etc.); ongoing monitoring of vehicle interior to provide information (e.g. watching valuables, wallet, purse, electronic device, phone, etc.). Passenger alert for item/valuable left behind in an autonomous vehicle/taxi; vehicle may remain at location (with notification or indication/signal such as flashing lights, etc.) until alert is cleared by passenger/rider.

Output/signal (network/user interface)—Operator or passenger/rider and/or authority/contact informed of condition through call/messaging (e.g.by phone, text and e-mail, etc.); vehicle route and/or location.

### Incident/Accident Detection

Input/signal (sensor matrix)—Incident/accident detected by sensor matrix (e.g. including accelerometer, camera, microphone, other vehicle systems such as airbag deployment, etc.) For example, incident where airbag deploys; sensor senses number of airbags that deployed and the location of the deploying airbag in the vehicle.

Operation (vehicle systems/network)—Detection that vehicle has been in accident is communicated with vehicle systems and network. Alters and call for assistance in initiated (after attempt/inquiry with vehicle occupant) with information content (such as number of airbags that deployed and the location within the vehicle and if the occupant is out of position/occupant seat classification, movement/activity or exit from vehicle/ejected) to enhance preparedness of emergency rescue (allowing to act more effectively/quickly on arrival at scene as well as to coordinate response such as fire/police and particular nature of emergency response needed).

Output/signal (network/user interface)—Vehicle/occupant status reported (including state of health/vital signs); signal may be routed to authorities/others (e.g. video, audio, communications, etc.); vehicle route and/or location. Communications with authorities/emergency rescue/dispatch with information content (identification of occupants) to assist preparation; contact by messaging (phone/text etc.) to family/others.

### Incident/Hazard Detection

Input/signal (sensor matrix)—Potential hazard (e.g. bio-hazard, toxic condition, potentially harmful substance, etc.) detected or sensed in vehicle interior (e.g. within cabin/air) by sensor matrix.

Operation (vehicle systems/network)—Detection of potential danger/dangerous chemical (as compared to threshold) communicated as alert; inquiry for operator/driver or occupant; vehicle systems commanded to take appropriate measures to ensure occupant safety such as lowering windows or keeping windows up or turning on/off ventilation system.

Output/signal (network/user interface)—Vehicle/occupant status reported (including state of health/vital signs, level of danger/hazard, etc.); alert communicated to/through vehicle systems and user interface; signal may be routed to authorities/others (e.g. video, audio, communications, etc.); vehicle route and/or location; messaging to/from contacts/persons for vehicle.

### Vehicle Monitoring/Status

Input/signal (sensor matrix)—Vehicle system status monitored including with connectivity to vehicle systems and/or with sensor matrix.

Operation (vehicle systems/network)—Operator/driver and/or occupant is provided an alert for state of health of vehicle and/or vehicle system (e.g., low tire pressure, low oil, battery state of charge, engine/motor issues, etc.).

Output/signal (network/user interface)—Vehicle status reported; alert communicated to/through vehicle systems and user interface; signal may be routed to authorities/others (e.g. video, audio, communications, etc.); vehicle route and/or location; messaging to/from contacts/persons.

### Vehicle Monitoring/Tampering

Input/signal (sensor matrix)—Sensor matrix detects possible tampering/theft attempt from vehicle (including by interaction with other vehicle systems such as door locks, exterior sensors/cameras, etc.).

Operation (vehicle systems/network)—Enhanced/improved tampering and theft protection by interaction of sensor matrix with a more comprehensive detection system throughout the vehicle interior. Alarm alerts to inform vehicle owner and/or authorities of potential break-in and of status detected (e.g. broken window or other) and/or presence of intruder (e.g. identity detection and/or verification with data base or by owner); audio/camera image may be transmitted to owner/authorities (e.g. police/security); interaction with other alert systems). Theft of vehicle may be monitored and reported.

Output/signal (network/user interface)—Vehicle/occupant status reported; signal may be routed to authorities/others (e.g. video, audio, communications, etc.); vehicle route and/or location. Communications with authorities/emergency rescue/dispatch with information content (identification of violator) to assist preparation; contact by messaging (phone/text etc.) to family/others.

### Driver/Operator Attention Monitoring—A

Input/signal (sensor matrix)—Driver status and/or attention monitoring and management by sensor matrix (e.g. detection of signals such as audio, video, touch, position, movement, vital signs, etc.); possible loss of acuity/attention by driver may be indicated/predicted and reported.

Operation (vehicle systems/network)—Alert to potential driver attention loss and/or drowsiness and distraction prediction; command to vehicle systems responsive to drowsiness (e.g. control/systems for keeping driver awake and not-distracted); alert (e.g. audible/audiovisual); operation may include interaction at steering wheel and/or seating or other components (e.g. alert, haptic feedback, etc.).

Output/signal (network/user interface)—Vehicle/occupant status reported (including state of health/vital signs, attentiveness, drowsiness, etc.); alert communicated to/through vehicle systems and user interface; signal may be routed to authorities/others (e.g. video, audio, communications, etc.); report as to vehicle route and/or location (and or remaining distance of travel); messaging to/from contacts/persons.

### Driver/Operator Attention Monitoring—B

Input/signal (sensor matrix)—Sensor matrix signals (from one sensor or multiple sensors, including vital signal monitoring, posture/position, operation of vehicle systems/responsiveness, etc.).

Operation (vehicle systems/network)—Driver Monitoring Systems (DMS) conforming to legal rules/compliance including privacy (e.g. no sensitive data is to be stored but instead deleted immediately after processing). Driver Drowsiness and Attention Warning (system that assesses the driver alertness through sensors including potential input from vehicle systems and performs analysis to alert/warn the driver if needed). Advanced Driver Distraction Warning (system intended to enhance driver attention and sustained attention such as in high-traffic situation with alerts/warning when distraction/inattention is detected).

Output/signal (network/user interface)—Alerts and reports and other communications to enhance driver/operator performance and safety; monitor and provide recommendations and other alerts/communications and messaging.

### Vehicle Monitoring/Autonomous Vehicle

Input/signal (sensor matrix)—Sensor matrix detection and input signals (from one sensor or multiple sensors, including vital signal monitoring, posture/position, operation of vehicle systems/responsiveness, etc.).

Operation (vehicle systems/network)—System for semi-automated vehicles and/or autonomous vehicles (that may also be operated by driver) to be equipped with a Driver Availability Monitoring System (system to assess whether the driver is in a position to take over the driving function from an automated vehicle in particular situations, where appropriate).

Output/signal (network/user interface)—Alerts and reports as to availability or lack of availability; other communications to enhance vehicle and/or driver/operator performance and safety; monitor and provide recommendations for vehicle operation/use and other alerts/communications and messaging (e.g. report for vehicle/fleet manager).

### Virtual Switch

Input/signal (sensor matrix)—Sensor matrix configured as to provide a virtual switch for operator/occupant; may be operated at user interface and/or on panel and/or device.

Operation (vehicle systems/network)—Sensor matrix input functions as a switch (e.g. based on detecting the presence of the human gesture by hand, finger); switch function may be used for any application in vehicle or for operation of selected vehicle systems.

Output/signal (network/user interface)—Feedback may be provided by sensor matrix/user interface; execution of switch function indicated for operation (e.g. successful gesture recognition by sensor matrix).

### Occupant Monitoring/Empathic—A

Input/signal (sensor matrix)—Sensor matrix configured to provide input signal for empathetic/empathic system to measure human state/emotion for occupants in vehicle interior; multi-sensor integration for sensor matrix (may be calibrated for optimization of input signal/detection of state).

Operation (vehicle systems/network)—System to monitor and optimize experience of vehicle operator/occupants for safety, protection, enhanced user experience (e.g. monitor potential bias, prevent safety violations such as abuse and exploitation, etc.); use multiple data streams (multi-mode input from sensor matrix); include location and position/posture of occupant, sound/vibrations, biometrics (body temperature, vital signals, etc.), chemical reactions (such as spills), bio-effects (such as particulates, pollutants, chemicals, etc. in the air); capabilities that can be integrated with data from sensor matrix (e.g., with sensor technology including such as radar on chip, resistive, capacitive, MEMS, optical), cameras, thermal imaging, audio, sensor for acceleration and deceleration of the vehicle) and any other data stream available in the vehicle. Computation may employ algorithm/control program and/or embedded libraries (update to build and evolve/refine human models for state detection/monitoring empathic condition). System may integrate “smart cabin” processing in real-time all/multiple data streams from sensor matrix to enhance accuracy of empathic system, including camera-based sensors/systems (e.g. using and identifiable faces/expressions) and detection of voice/tone of voice (expressions and word usage, etc.); system may be configured to process signals/data in real time to identify/anticipate occupant behaviors and sense when something is different or wrong (e.g. odor imaging sensor to smell alcohol on breath combined with a camera and image processing as well as thermal imaging of body temperature, etc.); by machine learning, system may build dataset of occupant behaviors for enhancement of experience in vehicle, including user preference implementation and development (as well as environment/interior conditions/settings to anticipate occupant needs/wants and to facilitate useful actions/behaviors including to enhance positive emotion/empathic monitoring of emotion/mood changes). Composite data collection from sensor matrix and other data sources; system may update database/threshold value development for detection and classification of conditions, events, etc.

Output/signal (network/user interface)—Report on empathic state for vehicle operator and occupants (in real time); integrate with vehicle systems in response to empathic state as detected; provide report to communication system/network outside of vehicle (including if assistance is appropriate, with sensor data such as audio-visual output).

### Occupant Monitoring/Empathic—B

Input/signal (sensor matrix)—Empathic “Smart Cabin” system to obtain and process multiple data streams in real-time to identify condition/emotional state of vehicle occupants; sensor matrix comprising multiple sensors (e.g. multi-modal input) to provide data for real-time/synchronized analysis.

Operation (vehicle systems/network)—System is configured to obtain and condition/process signals from sensor matrix and to use database/data sets (e.g. libraries, artificial intelligence, networks) and computation to ascertain human emotional state/mood for vehicle occupant (e.g. selecting specific data streams/inputs to identify more accurate/useful); intent to identify emotional state (e.g. positive satisfaction/happiness and/or neutral focused and/or negative such as unhappy, in need of protection from bias, abuse and exploitation, etc.) of occupants using input/sensor data and database and/or computation (including over network/cloud or in vehicle).

Output/signal (network/user interface)—Report on status and/or identification of emotional state/mood/affect (e.g. positive satisfaction/happiness and/or neutral focused and/or negative such as unhappy, in need of protection from bias, abuse and exploitation, etc.) for occupants in vehicle; data and output can be privacy-managed (e.g. only select non-sensitive data transferred to network/cloud).

### Occupant Classification—A

Input/signal (sensor matrix)—Vehicle occupant seat/status classification to be detected using signal from sensor matrix (enhanced multi-sensor integration or single-sensor).

Operation (vehicle systems/network)—System may be configured to determine status of seating/protection such as seat restraint/belt for occupants in vehicle; alert provided and/or integration with other vehicle systems (in addition to existing alarm/alert for vehicle seat).

Output/signal (network/user interface)—Report/alert as to seating status such as seat belt status may be set/selected and/or differentiated according to vehicle operator and/or occupant preferences; may connect to other vehicle systems to enhance efficacy of alert (disable privileges, etc.).

### Occupant Classification—B

Input/signal (sensor matrix)—Sensor matrix configuration to provide enhanced precision Occupant Classification System (OCS) for vehicle seat (e.g. enhancement with current standards such as a transducer/mat); sensor matrix can combine multi-sensor inputs, including standard sensors with cameras and enhanced digital processing/signal integration.

Operation (vehicle systems/network)—Occupant Classification System (OCS) can be enhanced and/or integrated with other systems for Child Presence Detection (CPD) and Low Risk Deployment (LRD) (of airbag system). Occupant classification can use signal from sensor matrix to classify occupant: rear-facing infant seat, child, adult, and empty seat. System would implement automatic airbag deactivation for child seats (e.g. distinguishing occupant presence such as between a one-year old, a three to six year old and the five percent female size); monitor vehicle passenger seat for occupancy and classification of occupant (if any); if child in a child seat or unoccupied, system may disable the airbag/provide alert; for adult occupant ensure airbag is deployed in the event of an accident (e.g. deployment adjustment for position of occupant). Sensor system/matrix input signal can determine seat belt status and provide alert/reminder function; detection can determine the child seat, child age/size, child position and child seat belt status. System can use data/database for determination of proper values for occupants.

Output/signal (network/user interface)—Output signal can report classification status to operator (allow user/operator override if required); data available for other vehicle systems including for communication to network/for messaging if collision event or other reportable incident.

### Data/Data Sources/Data Streams (Sensor Matrix)

Vehicle Data—Obtain vehicle data including from network and other interface (e.g. diagnostic port/connector, such as engine status, gear changes, braking, acceleration, temperature, tire pressure, etc.).

Audio/Sound Data—Microphone/audio input (e.g. detect vehicle interior condition, state of being of occupants, operator monitoring, including states/moods such as excitement, fear, happy, sad, stress, and occupant characteristics such as age, gender, etc.).

Biometric Sensor Data—State of health/status of operator and occupants (e.g. such as from vital sensing, monitoring skin temperature, heart rate, breathing/respiratory rate, ECG, galvanic skin response, etc.).

Facial Data—Identification operator/occupant and state/status (e.g. identity, status, age, gender, mood (i.e. angry, happy, sad, surprised, etc.), etc.).

Camera Data Stream—Facial Analysis, Full Body Analysis, Full Cabin/Occupant Analysis, Object Analysis with vision processing (correlate image to features to be identified) and machine learning, image identification and annotation (e.g. using camera/software enhancements, etc.)

Sensor Field (Creation/detection)—Contactless sensors using field technology/calibration.

Sensor Devices—Configuration for use of any of a variety of types of available/future sensor devices including resistance sensors, basic capacitive touch sensors, localized ultrasound touch sensing, force detection (e.g. transducer, MEMS strain sensor, piezoelectric, etc.), audio (microphone or vibration sensor by piezoelectric device), integrated/single-chip sensors, etc.), accelerometers (measure the acceleration and deceleration of the vehicle), collision warning systems, active sensors (data from lidar, radar or sonar), odor detection/imaging sensor (e.g. capturing odor information, which human may or may not perceive, convert odor to visual pattern, mimicking olfactory system, detecting bio-hazards, etc.), silicon photodiodes (e.g. detectors, photo IC used in light/radiation detection of solar radiation to adjust the airflow or cooling of automatic climate control), other known/convention sensor technology, multi-mode/multi-sensor integration for sensor matrix effect/configuration.

Privacy Management—System data signals (including input and output) to be privacy-managed (e.g. only select non-sensitive data transferred to network/cloud for storage/access).

Data Interface/Sources—Sensor matrix configuration to optimize sensors and data connectivity/streams in a particular use case/application in context and integrated into the vehicle, vehicle interior and with vehicle systems; data storage/use to be managed in legal compliance/ethical standards (e.g. privacy, personal/sensitive information protection). Multi-sensor/multi-modal system may include hardware and software with different types of data streams (e.g. from sensor matrix) from multiple sources (e.g. transducers, cameras, contactless human radar, biometrics, chemical reactions (spills), bio-effects microphones, sensed vibration, accelerometers, thermal imaging/measurement, collision warning sensors, etc.) using machines and interfaces configured to operate processing multiple data streams in real time with on-board diagnostics.

TABLE A-1
USE CASES (INPUT-OPERATION-OUTPUT BY CONTROL PROGRAM BASED
ON VEHICLE SYSTEM/DATABASE AND/OR USER SETTING/PREFERENCE
AND/OR NETWORK/STORAGE/DATA TO/THROUGH VEHICLE SYSTEM AND/OR
USER INTERFACE AND/OR COMMUNICATION/NETWORK)

| | | OPERATION | OUTPUT/SIGNAL |
|---|---|---|---|
| | INPUT/SIGNAL | (VEHICLE | (NETWORK/ |
| # | (SENSOR MATRIX) | SYSTEMS/NETWORK) | USER INTERFACE) |
| A | OCCUPANT VITAL | MONITOR OCCUPANT AND | THRESHOLD VALUES |
| | SIGNS | REPORT AND PROVIDE | (FOR INDIVIDUAL OR |
| | (PULSE, BREATHING, | COMMAND TO VEHICLE | FROM GENERAL |
| | ETC.) | SYSTEMS WITH ALERT IF | DATABASE) AND |
| | | OUT OF THRESHOLD VALUE | ALERT/MESSAGE |
| | | | COMMUNICATION |
| | | | WITH VEHICLE |
| | | | IDENTIFICATION AND |
| | | | LOCATION |
| B | ABNORMAL | MONITOR CONDITION | THRESHOLD VALUE |
| | OCCUPANT | REPORT AND PROVIDE | AND ALERT/MESSAGE |
| | CONDITION | COMMAND TO VEHICLE | WITH VEHICLE |
| | (ILLNESS) | SYSTEMS WITH ALERT IF | IDENTIFICATION AND |
| | | OUT OF THRESHOLD VALUE | LOCATION |
| C | CHILD OR PET OR | MONITOR AND PROVIDE | VEHICLE LOCATION |
| | INCAPACITATED | COMMAND TO VEHICLE | AND STATUS WITH |
| | PERSON IN VEHICLE | SYSTEMS (SAFETY/ | RECIPIENT FOR |
| | | PROTECTION) WITH ALERT | ALERT/MESSAGING |
| | | | COMMUNICATIONS |
| D | OBJECT/ITEM IN | MONITOR AND PROVIDE | ALERT/MESSAGING |
| | VEHICLE | ALERT WITH VEHICLE | COMMUNICATION |
| | | SYSTEM COMMAND (E.G. | |
| | | LOCK VEHICLE) | |
| E | VEHICLE INCIDENT | MONITOR AND REPORT AND | ALERT/MESSAGING |
| | (ACCIDENT OR | PROVIDE ALERT (MANAGE | COMMUNICATION |
| | EVENT) | VEHICLE SYSTEMS FOR | (STATUS AND |
| | | SAFETY) | VEHICLE LOCATION |
| | | | AND OCCUPANTS) |
| F | VEHICLE | MONITOR AND REPORT | ALERT/MESSAGING |
| | THEFT/TAMPERING | WITH ALERT (TO OWNER | COMMUNICATION |
| | (VEHICLE OR ITEMS) | AND AUTHORITIES/POLICE) | (STATUS REPORT AND |
| | | | LOCATION) |
| G | DRIVER STATUS | MONITOR AND REPORT | ALERT/MESSAGING |
| | AND/OR ATTENTION | WITH ALERT TO DRIVER | COMMUNICATION |
| | MANAGEMENT | AND/OR AUTHORITIES | (STATUS AND |
| | | | LOCATION) |
| H | POTENTIAL UNSAFE | MONITOR AND REPORT AND | ALERT/MESSAGING |
| | CONDITION IN | OPERATE VEHICLE | COMMUNICATION |
| | VEHICLE INTERIOR/ | SYSTEMS TO REMEDIATE | |
| | ENVIRONMENT | | |
| I | VEHICLE STATUS | MONITOR AND REPORT TO | ALERT/MESSAGING |
| | (STATE OF HEALTH) | DRIVER/OWNER | COMMUNICATION |
| | | | AND VEHICLE |
| | | | SYSTEM BASELINE |
| | | | STATE/STATUS |
| J | VEHICLE OCCUPANT | MONITOR AND MANAGE | BASELINE |
| | STATUS | VEHICLE ENVIRONMENT | STATUS/STATE AND |
| | (EMPATHETIC/ | AND VEHICLE SYSTEMS | USER PREFERENCES |
| | EMPATHIC) | | FOR OCCUPANT WITH |
| | | | MANAGEMENT |
| | | | OPTIONS/SELECTIONS |
| K | VEHICLE OCCUPANT | MONITOR AND MANAGE | IDENTIFICATION FOR |
| | CLASSIFICATION | VEHICLE SYSTEMS FOR | EACH OCCUPANT/ |
| | | OCCUPANT (EACH | CLASSIFICATION AND |
| | | OCCUPANT) AND VEHICLE | ACCOMPANYING |
| | | SYSTEM SETTINGS/ACTIONS | ACTIONS/OPERATION |
| | | | OF VEHICLE SYSTEMS |
| L | VEHICLE OCCUPANT | MONITOR OCCUPANT AND | IDENTIFICATION OF |
| | EXPERIENCE | PROVIDE VEHICLE SYSTEM | OCCUPANT AND |
| | ENHANCEMENT | SETTINGS/USER INTERFACE | |
| | | TO ENHANCE OCCUPANT | CORRESPONDING |
| | | EXPERIENCE | USER PREFERENCES/ |
| | | | SETTINGS |
| | | | (INDIVIDUAL AND/OR |
| | | | BY CATEGORY) |
| M | MOBILE DEVICE | MONITOR AND DETECT | IDENTIFICATION OF |
| | INTERACTION | MOBILE DEVICE AND | MOBILE DEVICE |
| | | INTERACT WITH VEHICLE | AND/OR OWNER- |
| | | SYSTEMS | OCCUPANT AND |
| | | | ASSOCIATE WITH |
| | | | USER PREFERENCES/ |
| | | | SETTINGS |
| N | PRIVACY | MONITOR AND MANAGE | LEGAL COMPLIANCE |
| | MANAGEMENT FOR | INFORMATION/DATA FROM | RULES/REGULATIONS |
| | OCCUPANT | SENSOR MATRIX AND | AND USER |
| | (PERSONAL DATA | CATEGORIZE AND | PREFERENCE FOR |
| | AND OTHER | STORE/DELETE ACCORDING | PRIVACY (SETTING) |
| | INFORMATION) | TO PREFERENCES AND | WITH DATA |
| | | LEGAL COMPLIANCE | CATEGORIZATION |

TABLE A-2
SIGNALS/INPUTS

| SENSING | | |
|---|---|---|
| | VITAL | |
| OCCUPANCY | SIGNS/MONITORING | |
| SENSING/ | AND HEALTH/ | USER INTERFACE |
| CATEGORY | CONDITION | SWITCHES |
| Gender | Blood pressure | Force |
| Weight/size | Heartbeat | Capacitive |
| Child | Movements | Three-dimensional/3D gestures |
| Animal/pet presence | Attention level | Proximity/approach |
| Out of position/posture | Distraction | illumination |
| Driver identification | Breathing | shared touchscreen |
| Passenger identification | Coughing | LIDAR, radar, ultrasonic, etc. |
| | | detection interface |
| Anti-pinch detection/comfort | Sneezing | |
| Hand on/off steering wheel | Vomiting | |
| Intelligent blinker/monitor | Child/baby crying | |
| Shared touch screen | Pet sound/dog barking | |
| Shared buttons | Voice recognition | |
| Auto dim buttons | Identification based on | |
| | signs/database | |
| UV sanitizing | Virus detection (e.g. | |
| | COVID scan) | |
| Sensing side panels | Substance use/abuse | |
| | detection (e.g. alcohol, drug, | |
| | etc.) | |
| Speaker detection | Exposure to or presence of | |
| for voice commands | biohazard | |
| Remote control computing | | |
| and/or | | |
| smart device connection | | |
| GPS interface | | |
| Integrate with airbag | | |
| deployment system | | |
| Vehicle interior environment | EMPATHIC SYSTEM | USER |
| status (temperature | INPUT | INTERFACE/CONTROL |
| conditions safe/unsafe) | (MULTI-SENSOR/ | |
| integrating with vehicle | SENSOR MATRIX) | |
| systems/communication for | | |
| correction | | |
| | | Switches/buttons (real or |
| | | virtual) |
| | | Force measurement/transducers |
| | | or other mechanical detection |
| | | Capacitive sensing |
| | | 3D gestures/calibration |
| | | proximity/approach |
| | | SIGNAL PROCESSING AND |
| | | CONDITIONING (E.G. WITH |
| | | FILTER) AND WITH |
| | | CONTROL PROGRAM |
| | | AND/OR DATABASE |
| | | AND/OR COMPUTATION |
| | | WITH ALGORITHM |
| | | DATA/SIGNAL |
| | | PROCESSING WITH |
| | | MACHINE LEARNING/ |
| | | ARTIFICIAL |
| | | INTELLIGENCE (AI) |
| | | (ENHANCEMENT) |
| | | DATA/SIGNAL |
| | | PROCESSING WITH |
| | | AUGMENTED REALITY |
| | | (AR) (AUGMENTATION) |

### Exemplary Embodiments—E

Referring to FIGS. 1, 2A-2D and 15A-15E, a vehicle V with an interior I is shown according to an exemplary embodiment with a system and method for use of a sensor/sensor matrix SN/SF configured to obtain input/input signals and to provide output/output signals relating to interaction with an occupant and/or vehicle systems and/or a network. See also FIGS. 16A-16H, 17A-17B, 18A-18B, 19A-19B, 22A-22C, 23A-23B and 24.

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, an improved system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant and to use data to provide an output signal comprising an enhancement of the input signal and/or an augmentation of the input signal. The output signal may comprise a signal based on application of artificial intelligence; the output signal may comprise a signal based on application of augmented reality. The sensor arrangement may comprise a distributed sensor matrix configured to obtain data from within the vehicle; at least one data source may comprise the sensor matrix and/or a vehicle system and/or data storage and/or a network. See also TABLES A-1 and A-2.

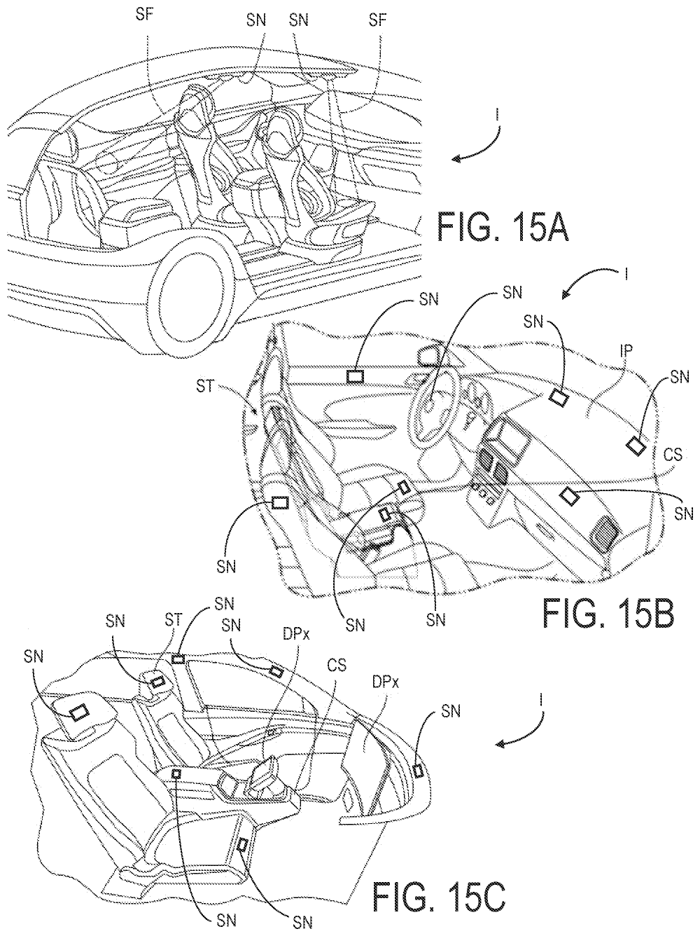

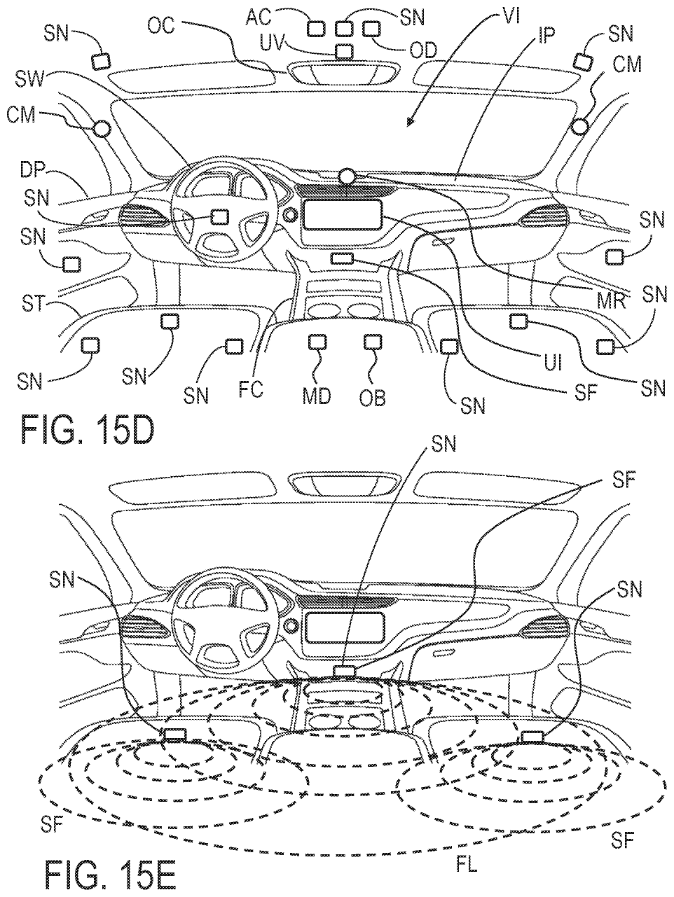

According to an exemplary embodiment as shown schematically in FIGS. 15A-15E, 22A-22C and 23A-23B, the system and method may be configured for integration of a sensor matrix comprising sensors SN/SF within the vehicle interior with components such as a panel such as an instrument panel IP and/or door panel DP, a console such as overhead console OC and/or floor console FC/SC, a structure such as pillar PL, a seat ST, a steering wheel SW; as indicated schematically the system may be configured with a user interface UI (e.g. comprising an input device such as a control/microphone and/or an output device such as a display/speaker shown as display panel DPx) for interaction with an occupant of the vehicle and/or with vehicle systems and/or with a network (such as a vehicle network, communications network, telecommunications network, internet, etc.) using a computing system/device. See also FIGS. 16A-16H, 17A-17B, 18A-18B, 19A-19B and 24.

As indicated schematically in FIGS. 15A-15E, 16A-16H, 17A-17B, 18A-18B, 19A-19B and 24, the system may be configured to provide a sensor matrix comprising connectivity and an array of sensors such as sensors SN/SF, camera CM (e.g. for video/audio recording), accelerometer AC, odor/scent detector OD, microphone MR, ultraviolet sensor UV, location monitoring system/GPS, detection for objects/items OB, detection/connection with devices such as mobile device MD, connection with vehicle systems/instrumentation and data/sensors (e.g. with seating, HVAC, occupant monitoring, etc.), etc.; as indicated, the system may be configured for use with any of a wide range of sensors configured to provide input/input signals (such as data, etc.) from detection and monitoring of a wide range of parameters as indicated, including events/incidents and conditions (e.g. including ambient conditions temperature, date/time, location/GPS data, occupant data, etc.). See also TABLES A-1 and A-2.

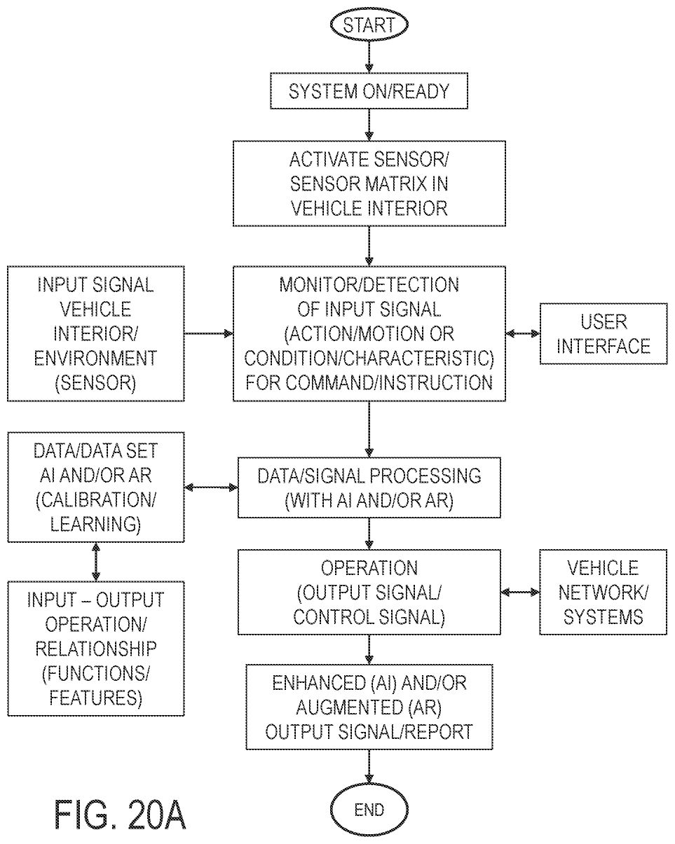

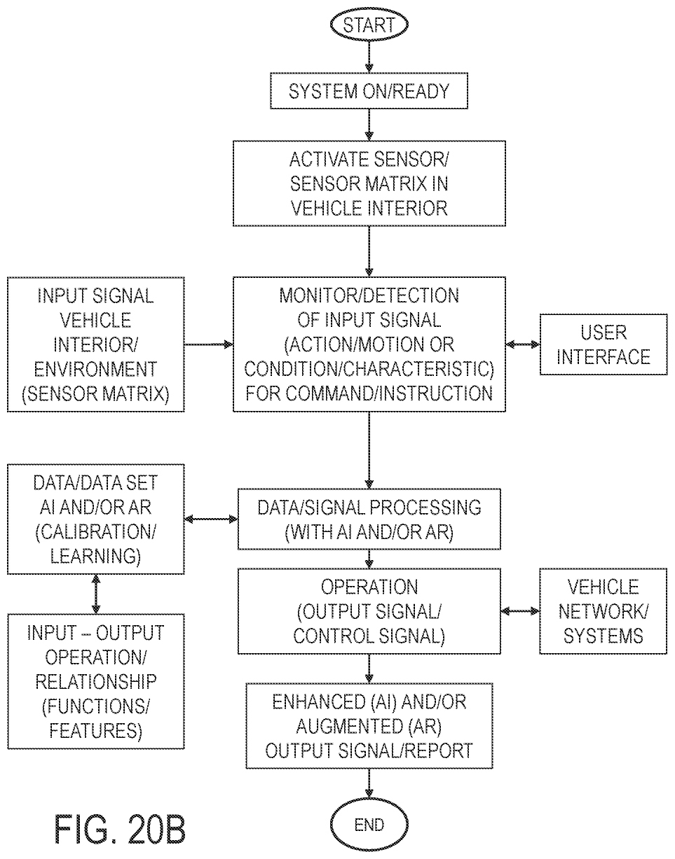

According to an exemplary embodiment as shown schematically in FIGS. 15A-15E, 16A-16H, 17A-17B, 18A-18B, 19A-19B and 22A-22C, the sensor matrix may comprise sensors SN and a sensor/system SF configured to generate a field FL that can be used to obtain an input/input signal that can be used/calibrated to detect conditions within the interior of the vehicle (e.g. by variations in field/input signal calibrated to variations in conditions). See also FIGS. 20A-20B, 21A-21B, 23A-23B and 24. As shown schematically in FIGS. 15A-15E, 16A-16H, 17A-17B, 18A-18B, 19A-19B and 24, the system may be configured to use a sensor matrix comprising sensors and/or sensor/field to obtain input/input signals relating to the use and operation of the vehicle, vehicle systems, occupants of the vehicle, objects and devices in the vehicle, etc.; the system may be configured to use input/input signals from the sensor matrix for interaction through instructions/operations and output/output signals with the vehicle/vehicle systems and/or vehicle occupants and/or objects and devices and/or over a network. See also FIGS. 20A-20B, 21A-21B, 22A-22C and 23A-23B.

As indicated schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, the system and method for use of a sensor matrix in a vehicle interior may be configured to provide for interactive connectivity to vehicle systems and/or networks in a wide variety of situations and/or use cases; the system and method for use of a sensor matrix in a vehicle interior may be configured to provide for interactive connectivity to vehicle systems and/or networks in a wide variety of situations and/or use cases to provide for needs of vehicle owners and/or occupants and/or passengers/riders. The system and method for use of a sensor matrix in a vehicle interior may be configured to provide for interactive connectivity to vehicle systems and/or a user interface (e.g. in-vehicle interface, mobile device, remote, other device, etc.) and/or networks/systems (e.g. communications, data, internet, databases/storage, cloud/remote storage, etc.); the system and method for use of a sensor matrix in a vehicle interior may be configured to provide for interactive connectivity to vehicle systems and/or a user interface/device and/or networks/systems in a wide variety of situations and/or use cases/applications for vehicles such as personal vehicles or commercial vehicles or autonomous vehicles. See also TABLES A-1 and A-2.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a system for using a sensor matrix in an interior of a vehicle comprising a vehicle system and providing a user interface configured for interaction with an occupant may use data to provide an output signal comprising an enhancement of the input signal and/or an augmentation of the input signal. The output signal may comprise a signal based on application of artificial intelligence; the output signal may comprise a signal based on application of augmented reality. The sensor arrangement may comprise a distributed sensor matrix configured to obtain data from within the vehicle; at least one data source may comprise the sensor matrix and/or a vehicle system and/or data storage and/or a network.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a system for using a sensor matrix in an interior of a vehicle comprising a vehicle system and providing a user interface configured for interaction with an occupant may comprise (a) the sensor matrix configured to obtain an input signal from within the vehicle interior and (b) a processor configured to process the input signal and to provide an output signal. See also TABLES A-1 and A-2. The output signal may be sent to at least one of (a) the vehicle system and/or (b) the user interface. The input signal may comprise at least one of (a) proximity, (b) action, (c) motion, (d) condition, (e) characteristic, (f) presence/absence of occupant, (g) position, (h) interaction with occupant, (i) detected input from occupant, (j) directed input from occupant, (k) vehicle interior control/activity, (l) smart cabin control/activity. See also TABLES A-1 and A-2.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, operation may comprise at least one of (a) operation of vehicle system, (b) network communication, (c) instruction for vehicle system, (d) operation of vehicle systems, (e) interaction with external systems, (f) data storage, (g) data analytics/analysis, (h) smart cabin control. The output signal may comprise at least one of (a) audio-visual signal, (b) visual signal, (c) visual display, (d) audible signal, (c) haptic signal, (f) notice/alert, (g) communication to network, (h) communication to device, (i) communication to vehicle system, (j) data transmission, (k) data storage. See also TABLES A-1 and A-2.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, the sensor matrix may comprise at least one sensor. The sensor may comprise at least one of (a) a transducer; (b) a capacitive sensor; (c) an odor detector; (d) an accelerometer; (c) a microphone; (f) a camera; (g) a light detector; (h) an ultraviolet light detector. The sensor matrix may comprise a field. See also TABLES A-1 and A-2. The sensor matrix may comprise multiple sensors. The sensor matrix may comprise multiple fields. The sensor matrix may comprise a field and at least one sensor. The input signal from the sensor matrix may comprise a signal detected (a) by a sensor and/or (b) from within a field. The field may be provided in the interior of the vehicle. The sensor matrix may be installed and/or operated with a vehicle interior component.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a component in the vehicle interior with the system and method may comprise at least one of (a) a trim panel; (b) an instrument panel; (c) a door panel; (d) a console; (c) a floor console; (f) an overhead console; (g) an overhead system; (h) a seat; (i) a steering wheel. The user interface may comprise at least one of (a) a display; (b) an audio system; (c) an audio-visual system; (d) an infotainment system. The user interface may comprise a haptic interface. The processor may be operated by a control program. The control program may comprise a software program.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a vehicle system may comprise at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system; (w) a location/navigation system; (x) a system for mobile device interactivity/connectivity. See also TABLES A-1 and A-2 and FIGS. 12, 14, 22A-22C and 24.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a system and method using a sensor arrangement/matrix in a vehicle interior for interaction with at least one vehicle occupant and/or vehicle system may comprise a user interface (providing input device and/or output device) and a computing system (comprising a processor/control program) configured to process and/or analyze/aggregate data such as an input/signal with data from data sources such as data storage/network and other systems for occupants of the vehicle and vehicle systems and to facilitate other operations and to provide output/signal with interactive connectivity with vehicle occupants, vehicle systems and/or networks relating to operation, status, situations, events, incidents, conditions, etc. The system may facilitate operation of vehicle system and/or network communication and/or data analytics/analysis using data and input/signal from the sensor matrix/field in the vehicle. The output/signal may comprise information provided at a user interface (such as an information display, audio output, etc.) and/or to vehicle systems (such control, monitoring, etc.) and/or a network communication (including to devices, mobile devices, networks including the internet, etc.). The system may use data from data sources including input/signal from the sensor matrix to provide an output/signal comprising an enhancement of the input/signal and/or an augmentation of the input/signal; the output/signal may comprise a signal based on application of machine learning/artificial intelligence (enhancement/AI) and/or a signal based on application of augmented reality (augmentation/AR). The system may comprise a distributed sensor matrix configured to obtain data from a sensor field within the vehicle; a data source may comprise the sensor matrix and/or the user interface and/or a vehicle system and/or data storage and/or a network. The system with sensor/matrix may be configured for use/operation as a component for an interior of vehicles such as personal vehicles or commercial vehicles or autonomous vehicles.

According to an exemplary embodiment as shown schematically in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a system/method using a sensor arrangement in a vehicle interior with an occupant and vehicle systems may comprise a user interface and computing system to process input/signal and data from data sources to facilitate operation and to provide output/signal with connectivity with occupants, vehicle systems, networks, etc. relating to operation, events, conditions, etc. Output may comprise information/interaction at a user interface, to vehicle systems, network communications, etc. The system may use data to provide output comprising enhancement and/or augmentation of input; output may comprise a signal based on data analytics/processing including application of artificial intelligence models and/or augmented reality models. The system may comprise a distributed sensor matrix to obtain data/input from a sensor field within the vehicle; data sources may comprise the sensor matrix, vehicle systems, data storage and/or networks. The sensor/matrix may be for use with an interior component in personal vehicles, commercial/industrial vehicles, autonomous vehicles, etc.

According to an exemplary embodiment as indicated schematically in the FIGURES/TABLES, the improved system and method may be configured to be implemented using known/conventional components/systems and technology and other future-developed components/systems and technology including but not limited to sensor/detector technology, computing technology, computing systems/devices (including processors/microprocessors, systems, computers, controllers, control programs, programming, etc.), software development/technology, machine learning technology, artificial intelligence technology, language/data models, augmentation technology, augmented reality technology, data sources, data analytics, data storage, data acquisition/aggregation, network technology, etc.

As indicated schematically in FIGS. 15A-15E, 16A-16H, 17A-17B, 18A-18B, 19A-19B, 20A-20B, 21A-21B, 22A-22C, 23A-23B and 24, the system and method in operation may be configured/programmed to use data from data sources including the sensor matrix (e.g. aggregated/combined with other data) to implement machine learning/artificial intelligence enhancement and/or augmented reality augmentation to facilitate optimization of operation of the system and method.

### Exemplary Embodiments—F

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, an improved system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant and to use data to provide an output signal comprising an enhancement of the input signal and/or an augmentation of the input signal. The output signal may comprise a signal based on application of artificial intelligence; the output signal may comprise a signal based on application of augmented reality. The sensor arrangement may comprise a distributed sensor matrix configured to obtain data from within the vehicle (e.g. within components, devices, networks, embedded/installed locations, etc.); at least one data source may comprise the sensor matrix and/or a vehicle system and/or data storage and/or a network. See also TABLES A-1 and A-2.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a system for an interior of a vehicle comprising a vehicle system configured to use data from at least one data source and to provide a user interface configured for interaction with an occupant comprising a sensor arrangement comprising at least one sensor configured to obtain an input signal; and a computing system configured to process the input signal from the sensor to facilitate an operation and to provide an output signal. The output signal may be sent to at least one of (a) the vehicle system and/or (b) the user interface. The computing system may be configured to use data to provide an output signal comprising an enhancement of the input signal and/or an augmentation of the input signal. The output signal may comprise a signal based on application of artificial intelligence. The output signal may comprise a signal based on application of augmented reality. The sensor arrangement may comprise a distributed sensor matrix configured to obtain data from within the vehicle. Data may comprise the input signal. At least one data source may comprise the sensor matrix and/or a vehicle system and/or data storage and/or a network.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a system may comprise a component configured to present the user interface. The component may comprise a user interface system configured to present the user interface. The user interface system may comprise an input device and/or an output device. The user interface system may comprise an input device and an output device. The user interface system may comprise an input device configured to obtain an input signal and an output device configured to present an output signal. The user interface system may comprise at least one sensor; the user interface system may comprise an input device; the input device may comprise at least one sensor. The user interface system may comprise an output device; the output device may comprise an information display.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a sensor arrangement may comprise a set of sensors; the set of sensors may be configured to provide a sensor field. The sensor arrangement may comprise a sensor matrix; the sensor matrix may comprise a sensor field. The sensor matrix may comprise a distributed sensor matrix within the interior of the vehicle.

As indicated schematically according to an exemplary embodiment in 16A-16H, 17A-17B, 18A-18B, 19A-19B, 20A-20B, 21A-21B, 22A-22C, 23A-23B and 24, a computing system may comprise a computing device with a processor. The processor may be configured to use data to provide an output signal comprising an enhancement of the input signal. The processor may be configured to operate with a data enhancement module configured for machine learning to use data to provide an output signal comprising an enhancement of the input signal. The processor may be configured to operate with a data enhancement module configured with artificial intelligence to use data to provide an output signal comprising an enhancement of the input signal. The processor may be configured to operate with a data enhancement module configured to with generative artificial intelligence to use data to provide an output signal comprising an enhancement of the input signal; the input signal may comprise a prompt and the output signal comprise information generated by the data enhancement module from the prompt. The output signal may comprise information provided at a display. The processor may be configured to use data to provide an output signal comprising an augmentation of the input signal. The processor may be configured to use data to operate with a data augmentation module configured for augmented reality to provide an output signal comprising an augmentation of the input signal. The processor may be configured to use data to operate with a data augmentation module configured for augmented reality to provide an output signal comprising an augmentation of the input signal; augmentation may comprise application of data from a data source. The processor may be configured to use data to operate with a data augmentation module configured for augmented reality to provide an output signal comprising an augmentation of the input signal; augmentation may comprise at least one of augmented audio and/or augmented video. The output signal may comprise information provided at a display.

As indicated schematically according to an exemplary embodiment in FIGS. 3A-3T, 15A-15E, 16A-16H, 17A-17B, 18A-18B, 19A-19B, 20A-20B, 21A-21B, 22A-22C, 23A-23B and 24, a data source may comprise at least one of data storage and/or a network; the network may comprise the internet. The data source may comprise a language model for data enhancement comprising machine learning for artificial intelligence. The data source may comprise an augmented reality model for data augmentation. The input device may be configured to obtain data based on reality and the output device may be configured to present data based on augmented reality. The output signal may comprise a signal based on augmented reality.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity. See also TABLES A-1 and A-2. The operation may comprise at least one of (a) operation of vehicle system; (b) network communication; (c) instruction for vehicle system; (d) operation of vehicle systems; (c) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The operation may comprise at least one of (a) application of artificial intelligence and/or (b) application of augmented reality. Sec also TABLES A-1 and A-2.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the at least one sensor may comprise at least one of (a) a transducer; (b) a capacitive sensor; (c) an odor detector; (d) an accelerometer; (e) a microphone; (f) a camera; (g) a light detector; (h) an ultraviolet light detector; (i) a thermal detector; (j) RFID detector; (k) tag detector. The at least one sensor may comprise at least one of (a) a sensor array; (b) a sensor matrix; (c) a multi-function sensor; (d) a composite sensor; (e) an audio-visual sensor; (f) a video recorder; (g) an audio recorder; (h) a thermal sensor; (i) a bio-metric sensor. See also TABLES A-1 and A-2. The sensor may comprise a sensor matrix; the sensor matrix may comprise at least one of (a) a field; (b) multiple sensors; (c) multiple fields; (d) a field and at least one sensor; the input signal from the sensor may comprise a signal detected (a) by a sensor and/or (b) from within a field; the field may be provided in the interior of the vehicle. The input device may comprise a control for the occupant.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the user interface may comprise at least one of (a) a display; (b) an audio system; (c) an audio-visual system; (d) an infotainment system; (c) a haptic interface. The processor may be operated by at least one of (a) a control program; (b) a software program. The vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The operation may comprise operation of the vehicle and the output signal may comprise at least one of (a) an alert signal; (b) an emergency communication; (c) vital signs of the occupant.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. Processing the input signal into an output signal may comprise using data to provide the output signal comprising an enhancement of the input signal and/or an augmentation of the input signal. The input signal may comprise at least one of (a) proximity; (b) action; (c) motion; (d) sound; (e) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. See also TABLES A-1 and A-2. The operation may comprise at least one of (a) operation of vehicle system; (b) network communication; (c) instruction for vehicle system; (d) operation of vehicle systems; (e) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2. At least one data source may comprise the sensor matrix and/or a vehicle system and/or data storage and/or a network.

As indicated schematically according to an exemplary embodiment in 2A-2D, 3A-3T, 15A-15E, 16A-16H, 17A-17B, 18A-18B, 19A-19B, 20A-20B, 21A-21B, 22A-22C, 23A-23B and 24, a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. The input signal may comprise at least one of (a) proximity; (b) action; (c) motion; (d) sound; (e) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. See also TABLES A-1 and A-2. The operation may comprise at least one of (a) operation of vehicle system; (b) network communication; (c) instruction for vehicle system; (d) operation of vehicle systems; (e) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The output signal may comprise at least one of (a) audio-visual signal; (b) visual signal; (c) visual display; (d) audible signal; (e) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2. The step of processing the input signal into an output signal may comprise use of data to provide the output signal comprising an enhancement of the input signal and/or an augmentation of the input signal. See also TABLES A-1 and A-2. At least one data source may comprise the sensor matrix and/or a vehicle system and/or data storage and/or a network.

### Exemplary Embodiments—G

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, an improved system and method for use of a sensor matrix in a vehicle interior may be provided for interaction with at least one vehicle occupant; the system and method for use with a sensor matrix (e.g. one or a set/series of sensors, detectors, etc.) in a vehicle interior may be configured to create a “smart cabin” environment with interactive connectivity to vehicle systems and/or networks for a vehicle occupant and to use data to provide an output signal comprising an enhancement of the input signal and/or an augmentation of the input signal. The output signal may comprise a signal based on application of artificial intelligence; the output signal may comprise a signal based on application of augmented reality. The sensor arrangement may comprise a distributed sensor matrix configured to obtain data from within the vehicle; at least one data source may comprise the sensor matrix and/or a vehicle system and/or data storage and/or a network. See also TABLES A-1 and A-2.

As indicated schematically according to an exemplary embodiment in FIGS. 2A-2D, 3A-3T, 4A-4B, 5A-5B, 6A-6B, 7A-7B, 8A-8B, 9A-9B, 10A-10F, 11A-11O, 12, 13A-13H, 14, 15A-15E, 16A-16H, 17A-17B, 18A-18B, 19A-19B, 20A-20B, 21A-21B, 22A-22C, 23A-23B and 24, a system for an interior of a vehicle comprising a vehicle system configured to use data from at least one data source and to provide a user interface configured for interaction with an occupant comprising a sensor arrangement comprising at least one sensor configured to obtain an input signal; and a computing system configured to process the input signal from the sensor to facilitate an operation and to provide an output signal. The output signal may be sent to at least one of (a) the vehicle system and/or (b) the user interface. The computing system may be configured to use data to provide an output signal comprising an enhancement of the input signal and/or an augmentation of the input signal. The output signal may comprise a signal based on application of artificial intelligence. The output signal may comprise a signal based on application of augmented reality.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the sensor arrangement may comprise a distributed sensor matrix configured to obtain data from within the vehicle. Data may comprise the input signal. At least one data source may comprise the sensor matrix and/or a vehicle system and/or data storage and/or a network.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the system may comprise a component configured to present the user interface. The component may comprise a user interface system configured to present the user interface. The user interface system may be configured to present the output signal at the user interface. The user interface system may comprise an input device and/or an output device. The user interface system may comprise an input device and an output device. The user interface system may comprise an input device configured to obtain an input signal and an output device configured to present an output signal. The system may comprise a user interface system comprising the user interface. The user interface system may comprise at least one sensor. The user interface system may comprise an input device. The input device may comprise at least one sensor. The user interface system may comprise an output device. The output device may comprise a display. The output device may comprise an information display. The output device may comprise a display panel. The user interface system may comprise an input device and an output device.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the sensor arrangement may be configured to provide a sensor field. The sensor arrangement may comprise a set of sensors; the set of sensors may be configured to provide a sensor field. The sensor arrangement may comprise a sensor matrix. The sensor matrix may comprise a sensor field. The sensor matrix may comprise multiple sensors configured to obtain data. The sensor matrix may comprise a distributed sensor matrix for the vehicle. The sensor matrix may comprise a distributed sensor matrix within the vehicle. The sensor matrix may comprise a distributed sensor matrix within the interior of the vehicle.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the computing system may comprise a processing system. The computing system may comprise a data processing system. The computing system may comprise a computing device. The computing system may comprise a computing device with a processor. The computing system may comprise a controller. The computing system may comprise a controller and/or a processor. The computing system may comprise a processor. The processor may be configured to use data to provide an output signal comprising an enhancement of the input signal. The processor may be configured to operate with a data enhancement module to use data to provide an output signal comprising an enhancement of the input signal. The processor may be configured to operate with a data enhancement module configured for machine learning to use data to provide an output signal comprising an enhancement of the input signal. The processor may be configured to operate with a data enhancement module configured with artificial intelligence to use data to provide an output signal comprising an enhancement of the input signal. The processor may be configured to operate with a data enhancement module configured with generative artificial intelligence to use data to provide an output signal comprising an enhancement of the input signal. The processor may be configured to operate with a data enhancement module configured to with generative artificial intelligence to use data to provide an output signal comprising an enhancement of the input signal; enhancement may comprise application of data from a data source. The processor may be configured to use data to operate with a data enhancement/machine learning/artificial intelligence module to provide an output signal comprising an enhancement of the input signal. The processor may be configured to operate with a data enhancement module configured to with generative artificial intelligence to use data to provide an output signal comprising an enhancement of the input signal; the input signal may comprise a prompt and the output signal comprise information generated by the data enhancement module from the prompt. The output signal may comprise information provided at a display. The processor may be configured to use data to provide an output signal comprising an augmentation of the input signal. The processor may be configured to use data to operate with a data augmentation module to provide an output signal comprising an augmentation of the input signal. The processor may be configured to use data to operate with a data augmentation module configured for augmented reality to provide an output signal comprising an augmentation of the input signal. The processor may be configured to use data to operate with a data augmentation module configured for augmented reality to provide an output signal comprising an augmentation of the input signal; augmentation may comprise application of data from a data source. The processor may be configured to use data to operate with a data augmentation module configured for augmented reality to provide an output signal comprising an augmentation of the input signal; augmentation may comprise addition of data from a data source. The processor may be configured to use data to operate with a data augmentation module configured for augmented reality to provide an output signal comprising an augmentation of the input signal; augmentation may comprise at least one of augmented audio and/or augmented video. The output signal may comprise information provided at a display. The data source may comprise at least one of data storage and/or a network. The network may comprise the internet. The data source may comprise a language model. The data source may comprise a language model for data enhancement. The data source may comprise a language model for data enhancement comprising machine learning. The data source may be configured for machine learning. The data source may update data with machine learning. The data source may be configured for data enhancement by machine learning. The data source may be configured with a language model for data enhancement comprising machine learning. The data source may comprise a language model for data enhancement comprising machine learning for artificial intelligence. The input device may be configured to obtain data and the output device may be configured to present data based on data enhancement. The input device may be configured to obtain data and the output device may be configured to present data based on data enhancement comprising artificial intelligence. The data source may comprise an augmented reality model for data augmentation. The data source may comprise an augmented reality model for data augmentation comprising augmented reality. The input device may be configured to obtain data based on reality and the output device may be configured to present data based on augmented reality. The output signal may comprise a signal based on augmented reality.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. See also TABLES A-1 and A-2. The operation may comprise at least one of (a) operation of vehicle system; (b) network communication; (c) instruction for vehicle system; (d) operation of vehicle systems; (c) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The operation may comprise at least one of (a) application of artificial intelligence and/or (b) application of augmented reality. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the sensor may comprise a sensor array. The sensor array may comprise at least one sensor. The at least one sensor may comprise at least one of (a) a transducer; (b) a capacitive sensor; (c) an odor detector; (d) an accelerometer; (e) a microphone; (f) a camera; (g) a light detector; (h) an ultraviolet light detector; (i) a thermal detector; (j) RFID detector; (k) tag detector. The at least one sensor may comprise at least one of (a) a sensor array; (b) a sensor matrix; (c) a multi-function sensor; (d) a composite sensor; (e) an audio-visual sensor; (f) a video recorder; (g) an audio recorder; (h) a thermal sensor; (i) a bio-metric sensor. See also TABLES A-1 and A-2. The sensor may comprise a sensor matrix. The sensor matrix may comprise at least one of (a) a field; (b) multiple sensors; (c) multiple fields; (d) a field and at least one sensor. The input signal from the sensor may comprise a signal detected (a) by a sensor and/or (b) from within a field.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the sensor matrix/field may be provided in the interior of the vehicle; the sensor matrix may be installed and/or operated with a vehicle interior component; the vehicle interior component may be configured to provide a user interface/system.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the vehicle interior component configured to provide a user interface may comprise at least one of (a) a trim panel; (b) an instrument panel; (c) a door panel; (d) a console; (c) a floor console; (f) an overhead console; (g) an overhead system; (h) a seat; (i) a steering wheel; (j) a door pillar.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the user interface may comprise an input device and an output device. The input device may comprise a control for the occupant. The input device may comprise a virtual switch; the virtual switch may be configured to be operated by at least one of (a) gesture detection and/or (b) movement by the occupant. The output device may comprise a display. The user interface may be configured to obtain the input signal. The user interface may be configured to present the output signal. The user interface may comprise at least one of (a) a display; (b) an audio system; (c) an audio-visual system; (d) an infotainment system; (c) a haptic interface. The processor may be operated by at least one of (a) a control program; (b) a software program. The processor may comprise a computing system.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the vehicle system may comprise at least one of (a) a climate control system; (b) a navigation system; (c) a network; (d) a vehicle network; (c) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system. The vehicle may comprise an autonomous vehicle.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, the sensor may comprise a sensor matrix configured to obtain the input signal from within the vehicle interior. See also TABLES A-1 and A-2. The input signal may comprise vital signs of the occupant and the operation may comprise operation of a vehicle system and the output signal may comprise a report. The operation may comprise operation of the vehicle and the output signal may comprise at least one of (a) an alert signal; (b) an emergency communication; (c) vital signs of the occupant. The operation may comprise at least one of (a) taking autonomous control of the vehicle; (b) parking the vehicle. The report may comprise vehicle location. The input signal may comprise detection of an event in the vehicle and the operation may comprise determination of the event and the output signal may comprise a report. The event may comprise at least one of (a) a potential medical concern for the occupant; (b) an illness of the occupant. The operation may comprise at least one of (a) taking autonomous control of the vehicle; (b) remediation of the event for the vehicle; (c) sanitizing the vehicle. The report may comprise a communication of vehicle location. The input signal may comprise incapacitation of the occupant and the operation may comprise determination of the condition and the output signal may comprise a report relating to the condition. The incapacitation may be of the operator of the vehicle and the operation may comprise taking control of the vehicle. The report may comprise at least one of (a) an emergency communication; (b) location of the vehicle. The output signal may comprise activating an emergency signal for the vehicle. The input signal may be based on a physical parameter of the occupant. The operation may comprise comparison of the physical parameter of the occupant based on a threshold value for the physical parameter. The input signal may comprise detection relating to a status of an item and the operation may comprise determination of the status of the item and the output signal may comprise a report based on the status of the item. The input signal may comprise the status of the item; the status of the item may comprise either (a) detected or (b) not detected. If the status of the item is not detected the operation may comprise monitoring for the item and the report may comprise an alert that the item is not detected. If the status of the item is detected the report may comprise a communication to a contact point; the contact point is in communication over a network. The input signal may be based on at least one of (a) a tag associated with the item; (b) an RFID tag. The input signal may comprise detection of an incident and the operation may comprise determination of the incident and the output signal may comprise a report on the incident. The incident may comprise a vehicle collision. The operation may comprise at least one of (a) monitoring of the status of the vehicle occupant; (b) analysis of the incident. The input signal may comprise data relating to the incident. The report may comprise at least one of (a) a communication with emergency responders; (b) data relating to the incident; (c) analysis of the incident. The input signal may comprise detection of tampering with the vehicle and the operation may comprise verification of tampering with the vehicle and the output signal may comprise a report relating to tampering with the vehicle. The report may comprise a communication to a law enforcement agency. The input signal may comprise a video recording of the tampering. The report may comprise the video recording of the tampering. The operation may comprise determination of damage to the vehicle. The report may comprise determination of damage to the vehicle. The input signal may comprise detection of attention of an operator of the vehicle and the operation may comprise assessment of attention of the operator and the output signal may comprise a report based on attention of the operator. If the attention of the operator is below a threshold value the report may comprise an alert. The threshold value may comprise at least one of (a) an awaken state; (b) a distracted state. The report may comprise a signal at the user interface as an alert to the operator. The operation may comprise haptic feedback for the operator. The output signal may comprise a sound at the user interface. The input signal may comprise detection of a potential hazard and the operation may comprise determination of the potential hazard and the output signal may comprise a report relating to the potential hazard. The operation may comprise determination of status of the occupant; the report may comprise status of the occupant. Determination of the potential hazard may comprise at least one of (a) classification of the potential hazard; (b) a traffic-related hazard; the report may comprise a warning. The input signal may comprise detection of a vehicle condition and the operation may comprise determination of the vehicle condition and the output signal may comprise a report relating to the vehicle condition. The vehicle condition may be reported to the occupant of the vehicle. The user interface may comprise a gesture-operated interface for the occupant. The vehicle condition relates to status of a safety system of the vehicle reported to the occupant. The input signal may comprise detection of a vehicle condition and the operation may comprise determination of the vehicle condition and the output signal may comprise a report relating to the vehicle condition. The vehicle condition may comprise autonomous operation of the vehicle. The input signal may comprise detection of readiness of an occupant to operate the vehicle. Readiness may comprise at least one of (a) status of the occupant; (b) position of the occupant. The report may comprise at least one of (a) an alert to the occupant; (b) a communication to take control of the vehicle.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a system for an interior of a vehicle comprising a vehicle system configured to use data from at least one data source and to provide a user interface configured for interaction with an occupant comprising a sensor arrangement comprising at least one sensor configured to obtain an input signal; and a computing system configured to process the input signal from the sensor to facilitate an operation and to provide an output signal. See also TABLES A-1 and A-2. The output signal may be sent to at least one of (a) the vehicle system and/or (b) the user interface. The sensor arrangement may comprise a distributed sensor matrix configured to obtain data from within the interior of vehicle. Data may comprise the input signal. The computing system may be configured to use data to provide an output signal comprising an enhancement of the input signal and/or an augmentation of the input signal. The output signal may comprise a signal based on application of artificial intelligence. The output signal may comprise a signal based on application of augmented reality. At least one data source may comprise the sensor matrix and/or a vehicle system and/or data storage and/or a network.

As indicated schematically according to an exemplary embodiment in 2A-2D, 3A-3T, 15A-15E, 16A-16H, 17A-17B, 18A-18B, 19A-19B, 20A-20B, 21A-21B, 22A-22C, 23A-23B and 24, a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. See also TABLES A-1 and A-2. Processing the input signal into an output signal may comprise using data to provide the output signal comprising an enhancement of the input signal and/or an augmentation of the input signal. See FIGS. 16A-16H, 17A-17B, 18A-18B, 19A-19B, 20A-20B, 21A-21B, 22A-22C and 24. The input signal may comprise at least one of (a) proximity; (b) action; (c) motion; (d) sound; (e) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. See also TABLES A-1 and A-2. The operation may comprise at least one of (a) operation of vehicle system; (b) network communication; (c) instruction for vehicle system; (d) operation of vehicle systems; (c) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2. At least one data source may comprise the sensor matrix and/or a vehicle system and/or data storage and/or a network.

As indicated schematically according to an exemplary embodiment in FIGS. 2A-2D, 3A-3T, 15A-15E, 16A-16H, 17A-17B, 18A-18B, 19A-19B, 20A-20B, 21A-21B, 22A-22C, 23A-23B and 24, a method for using a sensor matrix in an interior of a vehicle comprising a vehicle system using data from at least one data source and providing a user interface configured for interaction with an occupant comprising the steps of obtaining an input signal from the sensor matrix; processing the input signal into an output signal; and performing an operation relating to the input signal. See also TABLES A-1 and A-2. The input signal may comprise at least one of (a) proximity; (b) action; (c) motion; (d) sound; (c) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data. See also TABLES A-1 and A-2. The operation may comprise at least one of (a) operation of vehicle system; (b) network communication; (c) instruction for vehicle system; (d) operation of vehicle systems; (c) interaction with external systems; (f) data storage; (g) data analytics/analysis; (h) comparison of data to threshold values; (i) monitoring; (j) providing a report based on the input signal; (k) vehicle interior control; (l) smart cabin control; (m) smart cabin activity. See also TABLES A-1 and A-2. The output signal may comprise at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information. See also TABLES A-1 and A-2. The step of processing the input signal into an output signal may comprise use of data to provide the output signal comprising an enhancement of the input signal and/or an augmentation of the input signal. At least one data source may comprise the sensor matrix and/or a vehicle system and/or data storage and/or a network. The method may comprise the step of performing an operation based on the output signal. The step of performing an operation relating to the input signal may comprise performing an operation based on the output signal. The step of processing the input signal into an output signal may comprise use of a database. The step of performing an operation may comprise providing communication. The communication may comprise a report based on the input signal. The output signal may comprise the report. The method may comprise the step of activating and/or actuating a field for the sensor matrix. The step of obtaining an input signal may comprise detecting the input signal. The input signal may comprise a signal representative of at least one of (a) motion by the occupant; (b) action by the occupant; (c) a condition in the interior; (d) a condition of the occupant; (c) a characteristic of the occupant. The method may comprise the step of conditioning the input signal; the step of conditioning the input signal may comprise at least one of (a) filtering the input signal; (b) separating noise and/or (c) calibration. See also TABLES A-1 and A-2. The method may comprise the step of providing an output at the user interface based on the output signal. The method may comprise the step of communicating an output based on the output signal to a network. The network may comprise at least one of (a) a telecommunication network; (b) access through a mobile device. The output may comprise at least one of (a) a telecommunication signal; (b) an emergency signal; (c) a network communication. The input signal may comprise incapacitation of the occupant and the operation may comprise determination of the condition and the output signal may comprise a report relating to the condition. The input signal may comprise detection relating to a status of an item and the operation may comprise determination of the status of the item and the output signal may comprise a report based on the status of the item. The input signal may comprise detection of an incident and the operation may comprise determination of the incident and the output signal may comprise a report on the incident. The input signal may comprise detection of tampering with the vehicle and the operation may comprise verification of tampering with the vehicle and the output signal may comprise a report relating to tampering with the vehicle. The input signal may comprise detection of attention of an operator of the vehicle and the operation may comprise assessment of attention of the operator and the output signal may comprise a report based on attention of the operator. The input signal may comprise detection of a potential hazard and the operation may comprise determination of the potential hazard and the output signal may comprise a report relating to the potential hazard. The input signal may comprise detection of a vehicle condition and the operation may comprise determination of the vehicle condition and the output signal may comprise a report relating to the vehicle condition.

TABLE B
REFERENCE SYMBOL LIST

| | REFERENCE |
|---|---|
| ELEMENT, PART OR COMPONENT | SYMBOL |
| Vehicle | V |
| (e.g. conventional vehicle, passenger vehicle, | |
| commercial vehicle, industrial vehicle, | |
| autonomous vehicle, fleet vehicle, etc.) | |
| Vehicle interior (e.g. cabin, etc.) | I/VI |
| User interface | UI |
| (e.g. with input device/control and/or | |
| output device/display/speaker and/or | |
| haptic feedback and/or audio-visual | |
| input/output, etc.) | |
| Instrument panel | IP |
| Door panel | DP |
| Floor console | FC |
| Overhead console | OC |
| Pillar | PL |
| Steering wheel | SW |
| Seat | ST |
| Sensor matrix/field (e.g. any | SM |
| combination of one or more sensors, | |
| detectors and/or cameras and/or | |
| field/calibrated devices) | |
| Sensor | SN |
| (representative of sensor matrix, e.g. audio | |
| recorder, audio detector/microphone, camera/video | |
| recorder, transducer, audio-visual detector, motion | |
| detector, infrared detector, UV detector, scent detector, | |
| temperature detector, proximity detector, light sensor, | |
| GPS device, transmitter, accelerometer, meter, gauge, | |
| detection instrument, monitor, sensor, etc.) | |
| Sensor field/system to generate field (and/or | SF |
| to operate with sensor matrix) | |
| Field (sensor field | FL |
| representation/lines) (for sensor matrix) | |
| Camera/video-recorder | CM |
| Microphone/sound detector | MR |
| Odor/scent detector | OD |
| Accelerometer | AC |
| UV sensor | UV |
| Location/GPS unit | GPS |
| Device (e.g. mobile device, electronic | MD |
| device, data device, telephone, computing | |
| device, network device, instrument/instrumentation) | |
| Object/item | OB |
| Vehicle systems | VEHICLE |
| | SYSTEMS |
| Network (vehicle, mobile, local, internet, | NETWORK |
| personal, commercial, etc.) | |
| Output device (e.g. display/audio, information | DPx |
| display, display panel, etc.) | |
| Console/seat console/assembly | CS |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A system for an interior of a vehicle comprising a vehicle system configured to use data from at least one data source and to provide a user interface configured for interaction with an occupant comprising:
a sensor arrangement comprising at least one sensor configured to obtain an input signal;
a computing system configured to process the input signal from the sensor to facilitate an operation and to provide an output signal;
wherein the output signal is sent to at least one of (a) the vehicle system and/or (b) the user interface;
wherein the computing system is configured to use data to provide an output signal comprising an enhancement of the input signal and/or an augmentation of the input signal.

2. The system of claim 1 wherein the output signal comprises a signal based on application of artificial intelligence.

3. The system of claim 1 wherein the output signal comprises a signal based on application of augmented reality.

4. The system of claim 1 wherein the sensor arrangement comprises a distributed sensor matrix configured to obtain data from within the vehicle; wherein data comprises the input signal.

5. The system of claim 1 wherein at least one data source comprises the sensor matrix and/or a vehicle system and/or data storage and/or a network.

6. The system of claim 1 further comprising a component configured to present the user interface; wherein the component comprises a user interface system configured to present the user interface; wherein the user interface system comprises an input device configured to obtain an input signal and an output device configured to present an output signal.

7. The system of claim 6 wherein the user interface system comprises an input device; wherein the input device comprises at least one sensor.

8. The system of claim 6 wherein the user interface system comprises an output device; wherein the output device comprises an information display.

9. The system of claim 1 wherein the sensor arrangement comprises a set of sensors; wherein the set of sensors is configured to provide a sensor matrix; wherein the sensor matrix is configured to comprise a sensor field.

10. The system of claim 9 wherein the sensor matrix comprises a distributed sensor matrix within the interior of the vehicle.

11. The system of claim 1 wherein the computing system comprises a computing device with a processor.

12. The system of claim 11 wherein the processor is configured to use data to provide an output signal comprising an enhancement of the input signal.

13. The system of claim 11 wherein the processor is configured to operate with a data enhancement module configured with artificial intelligence to use data to provide an output signal comprising an enhancement of the input signal; wherein the output signal comprises information provided at a display.

14. The system of claim 11 wherein the processor is configured to use data to operate with a data augmentation module configured for augmented reality to provide an output signal comprising an augmentation of the input signal; wherein augmentation comprises at least one of augmented audio and/or augmented video.

15. The system of claim 1 wherein the at least one data source comprises a language model for data enhancement comprising machine learning for artificial intelligence.

16. The system of claim 1 wherein the at least one data source comprises an augmented reality model for data augmentation; wherein the input device is configured to obtain data based on reality and the output device is configured to present data based on augmented reality; wherein the output signal comprises a signal based on augmented reality.

17. The system of claim 1 wherein the input signal comprises at least one of (a) proximity; (b) action; (c) motion; (d) sound; (e) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data;
wherein the operation comprises at least one of (a) application of artificial intelligence; (b) application of augmented reality; (c) operation of vehicle system; (d) network communication; (c) instruction for vehicle system; (f) operation of vehicle systems; (g) interaction with external systems; (h) data storage; (i) data analytics/analysis; (j) comparison of data to threshold values; (k) monitoring; (l) providing a report based on the input signal; (m) vehicle interior control; (n) smart cabin control; (o) smart cabin activity;
wherein the output signal comprises at least one of (a) audio-visual signal; (b) visual signal; (c) visual display; (d) audible signal; (c) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information.

18. The system of claim 1 wherein the sensor arrangement comprises at least one of (a) a transducer; (b) a capacitive sensor; (c) an odor detector; (d) an accelerometer; (e) a microphone; (f) a camera; (g) a light detector; (h) an ultraviolet light detector; (i) a thermal detector; (j) RFID detector; (k) tag detector; (l) a sensor array; (m) a sensor matrix; (n) a multi-function sensor; (o) a composite sensor; (p) an audio-visual sensor; (q) a video recorder; (r) an audio recorder; (s) a thermal sensor; (t) a bio-metric sensor;
wherein the sensor arrangement comprises a sensor matrix; wherein the sensor matrix comprises at least one of (a) a field; (b) multiple sensors; (c) multiple fields; (d) a field and at least one sensor; wherein the input signal from the sensor comprises a signal detected (a) by a sensor and/or (b) from within a sensor field provided in the interior of the vehicle.

19. The system of claim 1 wherein the user interface comprises at least one of (a) a control configured to be operated by the occupant; (b) a display; (c) an audio system; (d) an audio-visual system; (c) an infotainment system; (f) a haptic interface; wherein the vehicle system comprises at least one of (a) a climate control system; (b) a navigation system; (c) a network; (d) a vehicle network; (e) a seating system; (f) a window control system; (g) a lighting system; (h) a communication system; (i) an autonomous vehicle operation system; (j) a steering system; (k) a drive system; (l) a powertrain system; (m) a starter system; (n) an audio system; (o) a display system; (p) an HVAC system; (q) an emergency warning system; (r) a safety system; (s) an occupant comfort system; (t) an occupant/sensory system; (u) a vehicle environment system; (v) a network/external communication system.

20. A method for using a sensor matrix in an interior of a vehicle comprising a vehicle system using data from at least one data source and providing a user interface configured for interaction with an occupant comprising the steps of:
obtaining an input signal from the sensor matrix;
processing the input signal into an output signal at a processor;
performing an operation relating to the input signal;
wherein the input signal comprises at least one of (a) proximity; (b) action; (c) motion; (d) sound; (e) condition; (f) characteristic; (g) presence/absence of occupant; (h) position of occupant; (i) interaction with occupant; (j) detected input from occupant; (k) directed input from occupant; (l) detected event; (m) detected condition; (n) vehicle interior control/activity; (o) smart cabin control/activity; (p) data;
wherein the operation comprises at least one of (a) application of artificial intelligence and/or (b) application of augmented reality; (c) operation of vehicle system; (d) network communication; (e) instruction for vehicle system; (f) operation of vehicle systems; (g) interaction with external systems; (h) data storage; (i) data analytics/analysis; (j) comparison of data to threshold values; (k) monitoring; (l) providing a report based on the input signal; (m) vehicle interior control; (n) smart cabin control; (o) smart cabin activity;
wherein the output signal comprises at least one of (a) audio-visual signal; (b) visual signal; (c) visual display; (d) audible signal; (e) haptic signal; (f) notice/alert; (g) communication to network; (h) communication to a device; (i) communication to a vehicle system; (j) data transmission; (k) data storage; (l) vehicle location; (m) vehicle status; (n) occupant status; (o) communication over a network; (p) report over a network; (q) information;
wherein the processor is operated by at least one of (a) a control program or (b) a software program;
wherein at least one data source comprises the sensor matrix and/or a vehicle system and/or data storage and/or a network.
